(19) United States
(12) Patent Application Publication
(10) Pub. No.: US 2016/0042651 A1
(43) Pub. Date: Feb. 11, 2016

(54) APPARATUS AND METHOD FOR REMOTELY PROVIDING INSTRUCTIONAL AND/OR EDUCATIONAL INFORMATION AND/OR SERVICES IN A NETWORK ENVIRONMENT

(71) Applicant: RAYMOND ANTHONY JOAO, YONKERS, NY (US)

(72) Inventor: RAYMOND ANTHONY JOAO, YONKERS, NY (US)

(21) Appl. No.: 14/714,365

(22) Filed: May 18, 2015

Related U.S. Application Data
(60) Provisional application No. 62/035,387, filed on Aug. 9, 2014.

(51) Int. Cl. G09B 5/06; H04N 7/15; G09B 19/00

(52) U.S. Cl. CPC G09B 5/06; G09B 19/0038; G09B 19/00; H04N 7/15

(57) ABSTRACT

A computer-implemented method, including processing, with a processor or computer, information for establishing or providing a video conference between a user and a fellow student or work-out partner, processing information for providing a video transmission of a class, lesson, or seminar, to a first communication device used by the user and a second communication device used by the fellow student or work-out partner, transmitting, from a transmitter or the computer, the class, lesson, or seminar, to the first communication device and the second communication device, wherein the class, lesson, or seminar, is transmitted to the first communication device and the second communication device during the video conference, and storing, in a memory device or database, information regarding the user's viewing, attending, or participation in, the class, lesson, or seminar, in an instructional record or educational record of the user.

### RELATED APPLICATIONS

This application claims the benefit of the priority of U.S. Provisional Patent Application Ser. No. 62/035,387, filed Aug. 9, 2014, and entitled “APPARATUS AND METHOD FOR REMOTELY PROVIDING INSTRUCTIONAL AND/OR EDUCATIONAL INFORMATION AND/OR SERVICES IN A NETWORK ENVIRONMENT”, the subject matter and teachings of which are hereby incorporated by reference herein in their entirety.

### FIELD OF THE INVENTION

The present invention pertains to an apparatus and method for remotely providing instructional and/or educational information or services in a network environment and, in particular, the present invention pertains to an apparatus and method for remotely providing instructional and/or educational information and/or services in the fields of exercise of any type or kind, fitness of any type or kind, physical activities of any type or kind, training of any type or kind, cross training of any type or kind, athletic training and/or conditioning of any type or kind, martial arts instruction and/or training of any type or kind for any type or kind of martial arts, instructional and/or educational information and/or training regarding fitness, wellness, nutrition, dietary information, and/or healthcare information, and/or instructional and/or educational information regarding academic courses, programs, diploma programs, degree programs, certificate programs, or any other instructional and/or educational programs or offerings of a formal, informal, and/or other nature.

### BACKGROUND OF THE INVENTION

Many individuals enjoy and recognize the many benefits associated with taking, attending, or participating in, classes, lessons, or seminars, of various types or kinds, as a pathway to expand their horizons, as a pathway for self improvement, and as a pathway for leading a better life. Classes, lessons, or seminars, which can be directed towards education or academics, continuing education, exercise or fitness, or martial arts instruction, or any other field of interest, can serve to provide a formalized, a structured, and/or a beneficial, avenue and environment for allowing individuals to become better educated, to learn new things, to receive proper training in a particular area or field, and/or to otherwise attain their goals and/or objectives more quickly and efficiently.

There is no doubt that many individuals have come to appreciate the many benefits and roles that classes, lessons, and seminars, can provide and have come to play in formalized education settings and/or environments and in continuing education settings and/or environments. There is also no doubt that many individuals have come to appreciate the many benefits and roles that classes, lessons, and seminars, can provide and have come to play in exercise and/or fitness training settings and/or environments, in martial arts training settings and/or environments, and in the settings and/or environments of or associated with many other fields of training or fields of interest. While classes, lessons, or seminars, provide an excellent vehicle by which to disseminate information, to provide education and/or training, and to disseminate information in a variety of ways, to achieve positive results, the scheduling of these classes, lessons, or seminars, are not always convenient for individuals. As a result, many individuals can be precluded from taking, attending, or participating in these various classes, lessons, or seminars.

Recordings of classed, lessons, or seminars, whether they be provided as video recordings, audio recordings, or as a combination of both, and/or whether they are provided or made available via CDs, DVDs. or online, can be limited in their offerings and do not always allow or facilitate social interaction with others. For example, once an individual has exercised along with an exercise video of, say for example, an aerobics class or a fitness class recorded on a DVD, he or she can only repeat the same class if they use that DVD again in the future. Further, if the individual uses the DVD by himself or herself, he or she might find such a workout to be lonely and boring without being able interact with others.

Even in situations when an individual is enrolled in or at a school, or a member of a school or a club, he or she might find that the classes, lessons, or seminars, offered or provided by that school or club can be limited and lack variety.

There is no question that there is certainly a need, and a market, for offering and/or or providing classes, lessons, or seminars, which can both overcome the shortcomings of the prior art and which can also be very beneficial to many individuals.

### SUMMARY OF THE INVENTION

The present invention pertains to an apparatus and method for remotely providing instructional and/or educational information or services, and/or training information or services, in a network environment and, in particular, the present invention pertains to an apparatus and method for remotely providing instructional and/or educational information and/or services, and/or training information or services, in the fields of exercise of any type or kind, fitness of any type or kind, physical activities of any type or kind, training of any type or kind, cross training of any type or kind, athletic training and/or conditioning of any type or kind, martial arts instruction and/or training of any type or kind for any type or kind of martial arts, instructional and/or educational information and/or training regarding fitness, wellness, nutrition, dietary information, and/or healthcare information, and/or instructional and/or educational information regarding academic courses, programs, diploma programs, degree programs, certificate programs, or any other instructional and/or educational programs or offerings of a formal, informal, and/or other nature, which overcomes the shortfalls of the prior art.

The apparatus of the present invention can include a central processing computer or central processing computer system which can be any computer or computer system or can be a network or a server computer. The central processing computer can provide control over the apparatus and can perform any of the various processing services and/or functions described herein. The central processing computer may be a single computer or system of computers and/or may include a plurality of computers or computer systems which are utilized in conjunction with one another. The central processing computer can provide services for any of the other computers and/or computer systems described herein as being associated with any of the individuals, users, students, instructional facilities, educational facilities, training facilities, gyms, health clubs, country clubs, fitness centers, wellness centers, athletic training centers or facilities, physical education schools, centers, or programs, martial arts schools, exercise schools or centers, schools, colleges, universities, trade schools, tutors, instructors, healthcare records services providers, healthcare records entities, healthcare records organizations, healthcare records services, instructional and/or educational records entities, instructional and/or educational records service providers, instructional or educational records organizations, instructional and/or educational records organizations, instructional and/or educational records services, instructional and/or educational records service providers, media service providers, media organizations, media sources, media services, information providers, information services providers, information organizations, information sources, information services, social networks, social networking companies, and/or social networking websites, described herein, who or which utilize the apparatus and method of the present invention, who or which can be utilized in connection with the apparatus and method of the present invention, and/or who or which can access the apparatus and method of the present invention, and/or who or which can be accessed via the apparatus and method of the present invention.

The apparatus can also include a user communication device or computer which is associated with, or which be used by, any one or more of any of the herein-described individuals, users, students, instructional facilities, educational facilities, training facilities, gyms, health clubs, country clubs, fitness centers, wellness centers, athletic training centers or facilities, physical education schools, centers, or programs, martial arts schools, exercise schools or centers, schools, colleges, universities, trade schools, tutors, instructors, healthcare records services providers, healthcare records entities, healthcare records organizations, healthcare records services, instructional and/or educational records entities, instructional and/or educational records service providers, instructional or educational records organizations, instructional and/or educational records organizations, instructional and/or educational records services, instructional and/or educational records service providers, media service providers, media organizations, media sources, media services, information providers, information services providers, information organizations, information sources, information services, social networks, social networking companies, and/or social networking websites, described herein, who or which utilize the apparatus and method of the present invention, who or which can be utilized in connection with the apparatus and method of the present invention, and/or who or which can access the apparatus and method of the present invention, and/or who or which can be accessed via the apparatus and method of the present invention.

Any number or amount of user computers can be utilized by or in conjunction with any user or any individual, student, instructional facility, educational facility, training facility, gym, health club, country club, fitness center, wellness center, athletic training center or facility, physical education school, center, or program, martial arts school, exercise school or center, school, college, university, trade school, tutor, instructor, healthcare records services provider, healthcare records entity, healthcare records organization, healthcare records service, instructional and/or educational records entity, instructional and/or educational records service provider, instructional or educational records organization, instructional and/or educational records organization, instructional and/or educational records service, instructional and/or educational records service provider, media service provider, media organization, media source, media service, information provider, information services provider, information organization, information source, information service, social network, social networking company, and/or social networking website, or any group of same or combination of same, described herein, who or which utilize the apparatus and method of the present invention, who or which can be utilized in connection with the apparatus and method of the present invention, and/or who or which can access the apparatus and method of the present invention, and/or who or which can be accessed via the apparatus and method of the present invention.

The user communication device can be any communication device, computer, personal computer, laptop computer, notebook computer, Smart phone or smartphone, smart telephone, cellular telephone, personal digital assistant, tablet, tablet computer, watch, smart watch, or wearable device or computer, or any combination of same, or any equivalent of same, which can be utilized by any person, individual, or entity, who or which utilizes the apparatus and method of the present invention. The user communication device can also be a server computer, a mainframe computer, a mini-computer, a microcomputer, or any other computer or device for suiting the needs of the particular user. A user communication device can also be any device or computer, or a kiosk, that can be located at public places or locations or which can also be publicly available.

The communication device(s) can communicate with, and/or can operate in conjunction with, the central processing computer and/or any of the other communication devices, computers, and/or computer systems, associated with or used by any of the individuals and/or entities who or which utilize and/or operate in conjunction with the apparatus and method of the present invention.

The apparatus can also include an instructional/educational facility communication device or computer which can be associated with, or which be used by, any one or more of any of the herein-described individuals, instructional facilities, educational facilities, training facilities, gyms, health clubs, country clubs, fitness centers, wellness centers, athletic training centers or facilities, physical education schools, centers, or programs, martial arts schools, exercise schools or centers, schools, colleges, universities, trade schools, tutors, and/or instructors, who or which provide instruction, classes, courses, or training, of any type or kind, who or which utilize the apparatus and method of the present invention, who or which can be utilized in connection with the apparatus and method of the present invention, and/or who or which can access the apparatus and method of the present invention, and/or who or which can be accessed via the apparatus and method of the present invention.

Any number or amount of instructional facility communication devices can be utilized by or in conjunction with any individual, instructional facility, educational facility, training facility, gym, health club, country club, fitness center, wellness center, athletic training center or facility, physical education school, center, or program, martial arts school, exercise school or center, school, college, university, trade school, tutor, and/or instructor, or any group of same or combination of same, described herein, who or which utilize the apparatus and method of the present invention, who or which can be utilized in connection with the apparatus and method of the present invention, and/or who or which can access the apparatus and method of the present invention, and/or who or which can be accessed via the apparatus and method of the present invention.

The instructional facility communication device can be a server computer, a personal computer, a mainframe computer, a mini-computer, a microcomputer, or any other computer or device for suiting the needs of the particular instructional facility or educational facility. The instructional facility communication devices can also be any communication device, computer, personal computer, laptop computer, notebook computer, Smart phone or smartphone, smart telephone, cellular telephone, personal digital assistant, tablet, tablet computer, watch, smart watch, or wearable device or computer, or any combination of same, or any equivalent of same, which can be utilized by any person, individual, or entity, who or which provides the services of an instructional facility or an educational facility and/or who or which utilizes the apparatus and method of the present invention.

The instructional facility communication device(s) can communicate with, and/or can operate in conjunction with, the central processing computer and/or any of the other communication devices, computers, and/or computer systems, associated with or used by any of the individuals and/or entities who or which utilize and/or operate in conjunction with the apparatus and method of the present invention.

The apparatus can also include a healthcare records computer or communication device which can store an electronic healthcare record or electronic healthcare records for any of the herein-described users or individuals who or which utilize the apparatus and method of the present invention. The healthcare records computer can also store healthcare records of any members, subscribers, or students, of any of the herein-described, instructional facilities, educational facilities, training facilities, gyms, health clubs, country clubs, fitness centers, wellness centers, athletic training centers or facilities, physical education schools, centers, or programs, martial arts schools, exercise schools or centers, schools, colleges, universities, trade schools, tutors, and/or instructors, who or which provide instruction, classes, courses, or training, of any type or kind, who or which utilize the apparatus and method of the present invention, who or which can be utilized in connection with the apparatus and method of the present invention, and/or who or which can access the apparatus and method of the present invention, and/or who or which can be accessed via the apparatus and method of the present invention.

The healthcare records computer or computers can serve to store and house an electronic healthcare record or any number of electronic healthcare records. The healthcare records computer can also be utilized to facilitate cloud storage of any electronic healthcare record(s).

Any number or amount of healthcare records computers can be utilized by or in conjunction with any individual, instructional facility, educational facility, training facility, gym, health club, country club, fitness center, wellness center, athletic training center or facility, physical education school, center, or program, martial arts school, exercise school or center, school, college, university, trade school, tutor, and/or instructor, or any group of same or combination of same, described herein, who or which utilize the apparatus and method of the present invention, who or which can be utilized in connection with the apparatus and method of the present invention, and/or who or which can access the apparatus and method of the present invention, and/or who or which can be accessed via the apparatus and method of the present invention.

The healthcare records computer can be a server computer, a personal computer, a mainframe computer, a mini-computer, a microcomputer, or any other computer or device for suiting the needs of the particular healthcare records storage entity. The healthcare records computer can also be any communication device, computer, personal computer, laptop computer, notebook computer, Smart phone or smartphone, smart telephone, cellular telephone, personal digital assistant, tablet, tablet computer, watch, smart watch, or wearable device or computer, or any combination of same, or any equivalent of same, which can be utilized by any person, individual, or entity, who or which provides the services of a healthcare records maintenance and/or storage entity and/or who or which utilizes the apparatus and method of the present invention.

The of healthcare records computer(s) can communicate with, and/or can operate in conjunction with, the central processing computer and/or any of the other communication devices, computers, and/or computer systems, associated with or used by any of the individuals and/or entities who or which utilize and/or operate in conjunction with the apparatus of the present invention.

The apparatus can also include an instructional/educational records computer or communication device which stores an electronic instructional and/or educational record or electronic instructional and/or educational records for any of the herein-described users or individuals who or which utilize the apparatus and method of the present invention. The electronic instructional and/or educational record can also store electronic instructional and/or educational record of any members, subscribers, or students, of and/or for any of the herein-described, instructional facilities, educational facilities, training facilities, gyms, health clubs, country clubs, fitness centers, wellness centers, athletic training centers or facilities, physical education schools, centers, or programs, martial arts schools, exercise schools or centers, schools, colleges, universities, trade schools, tutors, and/or instructors, who or which provide instruction, classes, courses, or training, of any type or kind, who or which utilize the apparatus and method of the present invention, who or which can be utilized in connection with the apparatus and method of the present invention, and/or who or which can access the apparatus and method of the present invention, and/or who or which can be accessed via the apparatus and method of the present invention.

Any of the instructional records and/or educational records described herein as being utilized in connection with the apparatus and method of the present invention can contain an instructional, educational, and/or academic, component as well as can contain a fitness, exercise, martial arts, sports, or athletics or any other physical, activities, component. In this regard, each instructional record or educational record described herein can contain an instructional, educational, and/or academic, record and/or can contain a fitness, an exercise, a martial arts, a sports, or an athletics, or any other record(s).

The instructional/educational records computer or computers can serve to store and house an instructional/educational record or any number of instructional/educational records. The instructional/educational records computer can also be utilized to facilitate cloud storage of any instructional/educational record(s).

Any number or amount of instructional/educational records computer can be utilized by or in conjunction with any individual, instructional facility, educational facility, training facility, gym, health club, country club, fitness center, wellness center, athletic training center or facility, physical education school, center, or program, martial arts school, exercise school or center, school, college, university, trade school, tutor, and/or instructor, or any group of same or combination of same, described herein, who or which utilize the apparatus and method of the present invention, who or which can be utilized in connection with the apparatus and method of the present invention, and/or who or which can access the apparatus and method of the present invention, and/or who or which can be accessed via the apparatus and method of the present invention.

The instructional/educational records computer can be a server computer, a personal computer, a mainframe computer, a mini-computer, a microcomputer, or any other computer or device for suiting the needs of the particular instructional/educational records storage entity. The instructional/educational records computer can also be any communication device, computer, personal computer, laptop computer, notebook computer, Smart phone or smartphone, smart telephone, cellular telephone, personal digital assistant, tablet, tablet computer, watch, smart watch, or wearable device or computer, or any combination of same, or any equivalent of same, which can be utilized by any person, individual, or entity, who or which provides the services of an instructional/educational records maintenance and/or storage entity and/or who or which utilizes the apparatus and method of the present invention.

The instructional/educational records computer(s) can communicate with, and/or can operate in conjunction with, the central processing computer and/or any of the other communication devices, computers, and/or computer systems, associated with or used by any of the individuals and/or entities who or which utilize and/or operate in conjunction with the apparatus of the present invention.

The apparatus can also include a media computer which can provide, and can be a source of information, news information, current events information, healthcare information, healthcare or healthcare-related news, fitness information, wellness information, nutrition information, workout or training information, exercise information, martial arts information, academic information, course information, class information, current events, advertisements, and/or marketing information or materials, and/or any other information which can be provided with any of the herein-described features or services which can be provided by, with, or via, the apparatus of the present invention and/or which can be disseminated via the apparatus of the present invention, Any number of media computers, with each being dedicated to providing any number, types, or kinds of, of information, news information, current events information, healthcare information, healthcare or healthcare-related news, fitness information, wellness information, nutrition information, workout or training information, exercise information, martial arts information, academic information, course information, class information, current events, advertisements, and/or marketing information or materials, and/or any other information or materials, can be utilized in connection with the apparatus.

The media computer or computers can serve to store and house any media and/or any information. The media computer can also be utilized to facilitate cloud storage of any media and/or information. Any number or amount of media computers can be utilized by or in conjunction with any media provider or information source who or which utilizes the apparatus of the present invention who or which utilize the apparatus and method of the present invention, who or which can be utilized in connection with the apparatus and method of the present invention, and/or who or which can access the apparatus and method of the present invention, and/or who or which can be accessed via the apparatus and method of the present invention.

The media computer can be a server computer, a personal computer, a mainframe computer, a mini-computer, a microcomputer, or any other computer or device for suiting the needs of the particular media provider or information source. The media computer can also be any communication device, computer, personal computer, laptop computer, notebook computer, Smart phone or smartphone, smart telephone, cellular telephone, personal digital assistant, tablet, tablet computer, watch, smart watch, or wearable device or computer, or any combination of same, or any equivalent of same, which can be utilized by any person, individual, or entity, who or which provides the services of a media provider or information source and/or who or which utilizes the apparatus and method of the present invention.

The media computer(s) can communicate with, and/or can operate in conjunction with, the central processing computer and/or any of the other communication devices, computers, and/or computer systems, associated with or used by any of the individuals and/or entities who or which utilize and/or operate in conjunction with the apparatus of the present invention.

The apparatus can also include a social networking computer. The social networking computer can be linked with, and utilized in connection with, the apparatus so as to allow and/or facilitate integrating the apparatus of the present invention with social networks, social networking, and social media. The social networking computer can be associated with a social networking company, a social networking website, or social networking entity, website, group, organization, or association. The social networking computer can be associated with any one or any number of social networking companies, social networking websites, or social networking entities, websites, groups, organizations, or associations. The social networking computer can also provide links to any computers associated with any one or any number of social networking companies, social networking websites, or social networking entities, websites, groups, organizations, or associations. The social networking computer can perform any and all of the functions performed by any social networking company, a social networking website, or social networking entity, website, group, organization, or association. Any number of social networking computers can be utilized in connection with the apparatus of the present invention.

Any number or amount of social networking computers can be utilized by or in conjunction with any social network or social networking provider who or which utilizes the apparatus of the present invention who or which utilize the apparatus and method of the present invention, who or which can be utilized in connection with the apparatus and method of the present invention, and/or who or which can access the apparatus and method of the present invention, and/or who or which can be accessed via the apparatus and method of the present invention.

The social networking computer can be a server computer, a personal computer, a mainframe computer, a mini-computer, a microcomputer, or any other computer or device for suiting the needs of the particular social network or social networking provider. The social networking computer can also be any communication device, computer, personal computer, laptop computer, notebook computer, Smart phone or smartphone, smart telephone, cellular telephone, personal digital assistant, tablet, tablet computer, watch, smart watch, or wearable device or computer, or any combination of same, or any equivalent of same, which can be utilized by social network or social networking provider and/or who or which utilizes the apparatus and method of the present invention.

The social networking computer(s) can communicate with, and/or can operate in conjunction with, the central processing computer and/or any of the other communication devices, computers, and/or computer systems, associated with or used by any of the individuals and/or entities who or which utilize and/or operate in conjunction with the apparatus of the present invention.

Any of the central processing computer(s), the user communication device(s), the instructional facility communication device (s), the healthcare records computer(s), the instructional/educational records computer(s), the media computer(s), and/or the social networking computer(s), can be any computer or communication device, including, but not limited to, a personal computer, a home computer, a server computer, a network computer or any computer capable of being utilized in a network, a hand-held computer, a palmtop computer, a laptop computer, a personal communication device, a cellular telephone, a wireless telephone, a mobile telephone, a digital television, an interactive television, a digital television, a personal digital assistant, a telephone, a digital telephone, a television, an interactive television, a beeper, a pager, and/or a watch or a Smart watch, and/or any wearable device, computer or communication device.

Each of the central processing computer(s), the user communication device(s), the instructional facility communication device (s), the healthcare records computer(s), the instructional/educational records computer(s), the media computer(s), and/or the social networking computer(s), can transmit information to, as well as receive information from, any of the computers or communication devices described herein. In this regard, each of the computers or communication devices can communicate with, process information from, and/or share data and/or information with, each other and/or any other computer(s) or communication device(s) described herein and/or utilized in conjunction with the apparatus of the present invention. In this manner, data and/or information transfer between any of the computer(s) or communication device(s) can communicate with any other computer(s) or communication device(s) in a bi-directional manner.

The present invention is utilized on, and/or over, the Internet and/or the World Wide Web. The present invention can also utilize wireless Internet and/or World Wide Web services, equipment and/or devices. The central processing computer(s) can have a web site or web sites associated therewith. Each of the other computers or communication devices described herein can also have a web site or web sites associated with same.

Although the Internet and/or the World Wide Web is a preferred communication system and/or medium utilized, the present invention can also be utilized with any appropriate communication network or system including, but not limited to, a communication network or system, a telecommunication network or system, a telephone communication network or system, a cellular communication network or system, a wireless communication network or system, a line or wired communication network or system, a wireless Internet network or system, a wireless World Wide Web network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, a cable television network or system, and/or any other communication network or system, and/or any combination of the above communication networks or systems.

Any of the central processing computer(s), the user communication device(s), the instructional facility communication device (s), the healthcare records computer(s), the instructional/educational records computer(s), the media computer(s), and/or the social networking computer(s), can communicate with one another, and/or be linked to one another, over or via any communication network, telecommunication network, telephone network, a line-connected network, and/or a wireless communication network, and/or the Internet and/or the World Wide Web. Each of the computers or communication devices can be linked with any other computer or computers directly or indirectly with one another so as to facilitate a direct or indirect bi-directional communication between said respective computers or communication devices. Communications between each of the computers or communication devices can also involve an e-mail server or e-mail servers in those instances when e-mails are described as being used to transmit or to send any of the information, signals, messages, reports, notification messages, or any other communications, described herein, by or between any of the computers or communication devices, or when any of the information, signals, messages, reports, notification messages, or any other computers or communications, described herein, are transmitted by and/or between any of the parties described herein and/or by or between any of the computers or communication devices, or any other computers or communication devices, computer systems, communication network equipment, server computers, etc., or any other devices used or needed, in order to facilitate communications or the transmission of any of the herein-described information, signals, messages, reports, notification messages, or any other communications.

Each of the central processing computer(s), the user communication device(s), the instructional facility communication device (s), the healthcare records computer(s), the instructional/educational records computer(s), the media computer(s), and/or the social networking computer(s), can communication in a bi-directional manner with, and/or can send and/or receive signals, messages, reports, notification messages, alerts, or any other communications or electronic communication transmissions, to, from and/or between, any other, or any number of, other central processing computer(s), user communication device(s), instructional facility communication device (s), healthcare records computer(s), instructional/educational records computer(s), media computer(s), and/or social networking computer(s).

Each of the central processing computer(s), the user communication device(s), the instructional facility communication device (s), the healthcare records computer(s), the instructional/educational records computer(s), the media computer(s), and/or the social networking computer(s), can be linked to or with any other the central processing computer(s), the user communication device(s), the instructional facility communication device (s), the healthcare records computer(s), the instructional/educational records computer(s), the media computer(s), and/or the social networking computer(s), via a wired link or line or a wireless link.

Each of the user communication device(s), the instructional facility communication device (s), the healthcare records computer(s), the instructional/educational records computer(s), the media computer(s), and/or the social networking computer(s), can be connected with or linked with the central processing computer(s).

Any and/or all of the signals, messages, reports, notification messages, or any other communications, described herein as being transmitted from one device, computer, or communication device, to another, can be, or can be included in, or be attached to, an e-mail message, an instant messaging message, an electronic transmission, or an electronic data transmission or electronic data interchange, or can be transmitted via any other data or information transmission, and/or can be transmitted via or using any appropriate or necessary computer(s) or device(s).

Each of the central processing computer(s), the user communication device(s), the instructional facility communication device (s), the healthcare records computer(s), the instructional/educational records computer(s), the media computer(s), and/or the social networking computer(s), can transmit data and/or information using TCP/IP, as well as any other Internet and/or World Wide Web, and/or communication, protocols.

The apparatus of the present invention can also utilize electronic commerce technologies and security methods, techniques and technologies, including any encryption or security technologies and/or techniques, in any and/or all of the instances of data and/or information processing, and/or data and/or information transmission described herein.

Each of the central processing computer(s), the user communication device(s), the instructional facility communication device (s), the healthcare records computer(s), the instructional/educational records computer(s), the media computer(s), and/or the social networking computer(s), can include, or can be equipped with, a central processing unit or CPU, a random access memory device(s) (RAM), a read only memory device(s) (ROM), a user input device, for entering data and/or commands into same and which can include any one or more of a keyboard, a scanner, a user pointing device, such as, for example, a mouse, a touch pad, and/or an audio input device and/or a video input device, a microphone or audio recording device, a camera or a video recording device, and/or any device, electronic and/or otherwise which can be utilized for inputting and/or entering data and/or information, as well as instructions and/or commands, into same.

Each of the central processing computer(s), the user communication device(s), the instructional facility communication device (s), the healthcare records computer(s), the instructional/educational records computer(s), the media computer(s), and/or the social networking computer(s), can include, or can be equipped with, a display device for displaying data and/or information to a user or operator, a transmitter(s) for transmitting signals and/or data and/or information to any one or more of the other computers or communication devices utilized in or with the apparatus of the present invention, a receiver for receiving signals and/or data and/or information from to any one or more of the other computers or communication devices utilized in or with the apparatus of the present invention, a database for storing any data and/or information needed or desired to allowing each respective computer or communication device to perform its respective functions or functionality as described herein.

Each of the central processing computer(s), the user communication device(s), the instructional facility communication device (s), the healthcare records computer(s), the instructional/educational records computer(s), the media computer(s), and/or the social networking computer(s), can include, or can be equipped with, an output device for outputting any of the data, information, and/or reports, described herein as being generated by or via same and which can be a printer, a display, a transmitter, a modem, and/or any other device which can be used to output data or information of any kind or type, and a video and/or audio recording device(s) which can include a camera and/or a video recording device for recording pictures or video and/or video clips and/or a microphone or an audio recording device for recording audio or audio clips which can be recorded by, and/or transmitted live, by or from same, or which can be recorded by, and stored at or in, same for transmission by or from the same at a later time. The video and/or audio recording device(s) can also be utilized to facilitate one-way broadcasts, video conferencing, video chatting, and/or audio conferencing, and/or video and audio conferencing, between any users of the respective computers or communication devices.

The apparatus and method of the present invention can be utilized in order to allow a user or individual who is a respective student or member of any instructional facility, educational facility, training facility, gym, health club, country club, fitness center, wellness center, athletic training center or facility, physical education school or center, martial arts school, or exercise school or center, or school, college, university, trade school, tutor, and/or instructor, described herein or otherwise, to view, attend, or participate in, classes offered by same remotely and/or via the Internet and/or the World Wide Web, or via any other communication network.

The apparatus and method of the present invention can be utilized in order to allow a user or individual, who is a student or member of any given instructional facility, educational facility, training facility, gym, health club, country club, fitness center, wellness center, athletic training center or facility, physical education school or center, martial arts school, or exercise school or center, or school, college, university, trade school, tutor, and/or instructor, to view, attend, or participate in, classes or other activities offered by same remotely and/or via the Internet and/or the World Wide Web, or via any other communication network, or to view, attend, or participate in, classes or other activities offered by any other instructional facility, educational facility, training facility, gym, health club, country club, fitness center, wellness center, athletic training center or facility, physical education school or center, martial arts school, or exercise school or center, or school, college, university, trade school, tutor, and/or instructor, who or which utilizes the apparatus and method of the present invention, remotely and/or via the Internet and/or the World Wide Web, or via any other communication network.

A user or individual can be a registered or subscribing student or member of a given instructional facility, educational facility, training facility, gym, health club, country club, fitness center, wellness center, athletic training center or facility, physical education school or center, martial arts school, or exercise school or center, or school, college, university, trade school, tutor, and/or instructor, and/or can be a registered or subscribing student or member of any program, class, course, or seminar, offered or provided by same. The user or the individual can be a registered or subscribing student or member of any one or more instructional facilities, educational facilities, training facilities, gyms, health clubs, country clubs, fitness centers, wellness centers, athletic training centers or facilities, physical education schools or centers, martial arts schools, or exercise schools or centers, or schools, colleges, universities, trade schools, tutors, and/or instructors, and/or can be a registered or subscribing student or member of any one or more programs, classes, courses, or seminars, offered or provided by same. The user or the individual can actually attend the respective instructional facility, educational facility, training facility, gym, health club, country club, fitness center, wellness center, athletic training center or facility, physical education school or center, martial arts school, or exercise school or center, or school, college, university, trade school, or meet with the tutor and/or the instructor, and/or the user or individual can also view, attend, or participate in, classes or other activities offered by same remotely and/or via the Internet and/or the World Wide Web, or via any other communication network, and/or to view, attend, or participate in, classes or other activities offered by any other instructional facility, educational facility, training facility, gym, health club, country club, fitness center, wellness center, athletic training center or facility, physical education school or center, martial arts school, or exercise school or center, or school, college, university, trade school, tutor, and/or instructor, who or which utilizes the apparatus and method of the present invention, remotely and/or via the Internet and/or the World Wide Web, or via any other communication network.

The operation of the apparatus and method of the present invention can be described herein as being utilized by a user or individual who is enrolled or registered with a martial arts school in order to study Krav Maga both at the actual martial arts school as well as remotely at that martial arts school as well as any other martial arts school that teaches Krav Maga or offers Krav Maga training and which also offers same via, and/or which utilizes, the apparatus of the present invention. Although described herein as being utilized in connection with Krav Maga martial arts instruction, it is important to note that the present invention can be utilized in a same, a similar, and/or an analogous, manner in connection with, and/or in conjunction with, any types or kinds of exercise activities, fitness activities, work-out activities, strength and conditioning activities, any type or kinds or sports or athletic activities, aerobics activities, weight training activities, cross training activities, callisthenic activities, Pilates activities, Yoga activities, meditation activities, Tai Chi activities, boxing, wrestling, kickboxing, cheerleading, martial arts activities, including, but not limited to, Krav Maga (Israeli martial arts), Karate, Kung Fu, Judo, Jujitsu, Kick Boxing, Mixed Martial Arts, Muy Tai, Brazilian Jujitsu, Savate, and any other type or kind of martial arts, as well as any other type or kind of physical activities, exercise activities, fitness activities, or wellness activities, and/or in connection with and/or in conjunction with the providing or offering of any types or kinds of instructional services and/or educational services in and for any types of kinds of academic subjects, classes, courses, diploma programs, degree programs, certificate programs, or continuing education programs, and/or any other informational, instructional, or educational, programs or activities, provided by or offered by any instructional and/or educational school, institution, facility, college, university, professional school continuing education institution, or any other learning institution or facility.

As and for an example, the user or individual can be a member of, a student of, or be enrolled in a Krav Maga school or center where he or she can physically go to take or attend Krav Maga classes. The user or individual can also have an instructional record or education record which reflects his or her being a member or, a student of, or being enrolled in or with, the Krav Maga school or center. Any information regarding the user's or the individual's attendance at classes, advancement through the program, belt or rank level, any other Krav Maga schools or centers where the user or individual studies Krav Maga either in-person or remotely, and/or any other data and/or information regarding the user or individual can be stored in the user's or individual's instructional record or education record stored in the database and in the database of the instructional facility communication device of or associated with the any of the Krav Maga schools or centers in which the user or individual has viewed, attended, or participated in, any classes, lessons, or seminars.

The user or individual can also supplement his or her Krav Maga training by viewing, attending, or participating in, classes offered or provided by his or her school or schools by viewing, attending, or participating in, same remotely, via the apparatus of the present invention, and/or by viewing, attending, or participating in, classes offered or provided by other Krav Maga schools or centers which make their classes available remotely via the apparatus of the present invention. In this regard, the present invention can be utilized to allow the user or individual to supplement his or her Krav Maga training by viewing, attending, or participating in, a Krav Maga class, lesson, or seminar with his or her Krav Maga school or center or with any other Krav Maga school or center remotely via the apparatus of the present invention.

In a case where the user communication device is linked to or with the an instructional facility communication device during the session, the instructional facility communication device can also record and store, in the user's or individual's instructional record or education record in the database of same, any data and/or information, described herein as being recorded and stored by the central processing computer regarding the user or individual, the time of the remote learning session, the duration of the remote learning session, and/or the class(es) or lesson(s) viewed, attended, or participated in, by the user or individual.

The apparatus and method of the present invention can be utilized in order to provide exclusively online instructional services and/or exclusively online educational services. The user or individual can enroll or register as a student or as a member with one instructional facility, educational facility, training facility, gym, health club, country club, fitness center, wellness center, athletic training center or facility, physical education school or center, martial arts school, or exercise school or center, or school, college, university, trade school, tutor, and/or instructor, in order to study or train, or engage in, any type of kind of exercise activities, fitness activities, work-out activities, strength and conditioning activities, any type or kinds or sports or athletic activities, aerobics activities, weight training activities, cross training activities, callisthenic activities, Pilates activities, Yoga activities, meditation activities, Tai Chi activities, boxing, wrestling, kickboxing, cheerleading, martial arts activities, including, but not limited to, Krav Maga (Israeli martial arts), Karate, Kung Fu, Judo, Jujitsu, Kick Boxing, Mixed Martial Arts, Muy Tai, Brazilian Jujitsu, Savate, and any other type or kind of martial arts, as well as any other type or kind of physical activities, exercise activities, fitness activities, or wellness activities, or in order to enroll in and/or engage in instructional services and/or educational services in and for any type of kind of academic subjects, classes, courses, diploma programs, degree programs, certificate programs, or continuing education programs, and/or any other informational, instructional, or educational programs or activities, in an exclusively on-line environment.

The user or individual can enroll in or register with, or become a student or a member of an instructional facility, educational facility, training facility, gym, health club, country club, fitness center, wellness center, athletic training center or facility, physical education school or center, martial arts school, or exercise school or center, or school, college, university, trade school, tutor, and/or instructor (hereinafter the “primary instruction provider”), and can view, attend, or participate in, classes, courses, lessons, or seminars, with that an instructional facility, educational facility, training facility, gym, health club, country club, fitness center, wellness center, athletic training center or facility, physical education school or center, martial arts school, or exercise school or center, or school, college, university, trade school, tutor, and/or instructor, as well any other instructional facility or facilities, educational facility or facilities, training facility or facilities, gym or gyms, health club(s), country club(s), fitness center(s), wellness center(s), athletic training center(s) or facility or facilities, physical education school(s) or center(s), martial arts school(s), or exercise school(s) or center(s), or school(s), college(s), university or universities, trade school(s), tutor(s), and/or instructor(s) (hereinafter the “secondary instruction provider”).

In a case where the user communication device is linked to or with any instructional facility communication device during the session, the instructional facility communication device can also record and store, in the user's or individual's instructional record or education record in the database of same, any data and/or information, described herein as being recorded and stored by the central processing computer, regarding the user or individual, the time of the remote learning session, the duration of the remote learning session, and/or the class(es) or lesson(s) viewed, attended, or participated in, by the user or individual.

The apparatus and method of the present invention can be utilized in order to allow a user or individual to view, attend, or participate in, a class, lesson, or seminar, with any number of friends, fellow students, or workout partners. Each of the user or individual and any and/or all of his or her friends, fellow students, or workout partners can each utilize a user communication device and the video and/or audio recording device(s) which can include a camera and/or a video recording device, and a microphone or an audio recording device, of same, and any appropriate video conferencing software and/or hardware, in order to engage in a video conference with each other during the class, lesson, or seminar. The video and/or audio information which is recorded and provided by each user communication device can be provided, along with the video and/or audio of the class, the lesson, or the seminar, in a split screen format or in a multiple screen format on the display device of each user communication device used by the user or individual and each friend, fellow student, or workout partner so that the user or individual, and each friend, fellow student, or workout partner can view, hear, and speak with, each other during the class, the lesson, or the seminar, in a split screen format or a multiple screen format while viewing, attending, or participating in, the class, lesson, or seminar. In this regard, the user or individual, and any number of friends, fellow students, or workout partners, can video conference with each other while viewing, attending, or participating in, a class, a lesson, or a seminar.

In a case where any or each user communication device is linked to or with the an instructional facility communication device during the video conferencing session, the instructional facility communication device can also record and store, in the user's or individual's instructional record or education record or in the instructional record or the educational record of each friend, fellow student, or workout partner, who participated in the video conference session, any data and/or information described herein as being recorded and stored by the central processing computer. Thereafter, the respective instructional facility communication device can automatically transmit or upload any data and/or information recorded and stored by same to the central processing computer for storage in the user's or individual's instructional record or education record stored in the database, or for storage in the instructional record or the educational record of each friend, fellow student, or workout partner, stored in the database.

The apparatus of the present invention can also be utilized to allow the user or individual to participate in a remote personal training session with an instructor. The instructor can utilize his or her own instructional facility communication device, and its associated video and/or audio recording device(s) in order to engage in video conference in which the instructor can provide the user or the individual with a remotely provided private or personal Krav Maga class, lesson, or seminar. the instructor can utilize his or her, or the Krav Maga school's or center's, own instructional facility communication device in order to provide video and audio instructional information to the user's or individual's user communication device and can be provided with video conferencing information recorded by and provided from the user's or individual's user communication device.

During the remotely provided private or personal Krav Maga class, lesson, or training session, the instructor can demonstrate any techniques and/or movements to the user or individual, so as to provide instruction in and for same, and the instructor can watch and review the user's or individual's performance of same and/or performance of same and/or review the user's or individual's performance during the remotely provided private or personal Krav Maga class, lesson, or training session. During the remotely provided private or personal Krav Maga class, lesson, or training session, the instructor and the user or individual can also speak with each other and see each other via the video conference. In this regard, the present invention can be utilized to provide remote one-on-one personal training in Krav Maga. In this regard, the present invention can be utilized to allow the user or individual to utilize the apparatus of the present invention in order to engage in private Krav Maga lessons or personal training sessions in Krav Maga.

The present invention can also be utilized to allow the user or individual, and any friend, fellow students, or workout partners, to participate in a remote personal group training session with an instructor. The instructor can utilize his or her own instructional facility communication device, and its associated the video and/or audio recording device(s) in order to engage in video conference in which the instructor can provide the user or the individual, and any friends, fellow students, or workout partners, with a remotely provided private group Krav Maga class, lesson, or seminar. The instructor can utilize his or her, or the Krav Maga school's or center's, own instructional facility communication device in order to provide video and audio instructional information to the user's or individual's user communication device and to each user communication device of or used by each friend, fellow student, or workout partner, participating in the private group training session, and can be provided with video conferencing information recorded by and provided from the user's or individual's user communication device as well as each user communication device used by each friend, fellow student, or workout partner. During the remotely provided private group Krav Maga class, lesson, or training session, the instructor can demonstrate any techniques and/or movements to the user or individual, and to the friends, fellow students, or workout partners, so as to provide instruction in and for same, and the instructor can watch and review the user's or individual's, and/or each friend's, fellow student's, or workout partner's, performance of same and/or performance of same and/or review the user's or individual's, and/or each friend's, fellow student's, or workout partner's, performance during the remotely provided private group Krav Maga class, lesson, or training session. During the remotely provided private group Krav Maga class, lesson, or training session, the instructor and the user or individual, and/or each friend, fellow student, or workout partner, can also speak with each other and see each other via the video conference. In this regard, the present invention can be utilized to provide remote private group training in Krav Maga. The present invention can also be utilized to allow the user or individual, and any friend(s), fellow student(s), or workout partner(s), to engage in private group Krav Maga lessons or private group training sessions in Krav Maga.

The present invention can be utilized in order to allow an instructor of the Krav Maga school of center, from which the class, lesson, or seminar is being provided, to monitor any number of users or individuals who might be viewing, attending, or participating in, the class, lesson, or seminar, and who have chosen to provide video of himself or herself participating remotely in the class, lesson, or seminar.

The user or individual can record a video clip or a video recording of himself or herself performing any activity, technique, or movement, which can contain video information and audio information, with or using the video and/or audio recording device(s) of a user communication device. Thereafter, the user of individual can transmit, or upload, the video clip or the video recording to the central processing computer and/or to the instructional facility communication device of or associated with the instructional facility or educational facility in which the user or individual is enrolled as a student or a member. Thereafter, any instructor of or with the instructional facility or educational facility can review the video clip or video recording and can provide any comments or notes regarding same to the user or individual.

The present invention can be utilized in order to allow the user or individual to provide video recordings of himself or herself performing any Krav Maga techniques or movements, performing in or during a class or lesson or in or during any portion of same, or performing a test for a belt level or a ranking level in Krav Maga.

The apparatus of the present invention can also be utilized in order to allow a user or individual to search for classes, lessons, seminars, or courses, from among those offered or provided by the various individuals, gyms, health clubs, country clubs, exercise facilities, fitness facilities, or fitness centers, or martial arts schools, or martial arts centers or academies, schools, colleges, universities, trade schools, training institutes or academies, continuing education facilities, or learning centers, who or which can utilize the apparatus of the present invention in order to provide their respective instructional services and educational services to students or members.

It is envisioned that each individual, gym, health club, country club, exercise facility, fitness facility, or fitness center, or martial arts school, or martial arts center or academy, school, college, university, trade school, training institute or academy, continuing education facility, or learning center, who or which utilizes the apparatus of the present invention, can post information regarding his, her, or its, respective instructional offerings, educational offerings, or academic offerings, class offerings, lesson offerings, seminar offerings, lecture offerings, activity offerings, course offerings, diploma program offerings, degree program offerings, certificate program offerings, or continuing education offerings, any description of same, information regarding any materials or subject matter to be covered by same, any agenda for same, any syllabus for same, any scheduling information for same, including but not limited to, the day, dates, and times of same, and/or any instructors or trainers of or for same, with the database of the central processing computer. Each individual, gym, health club, country club, exercise facility, fitness facility, or fitness center, or martial arts school, or martial arts center or academy, school, college, university, trade school, training institute or academy, continuing education facility, or learning center, can also store, in the database of his, her, or its, respective instructional offerings, educational offerings, or academic offerings, class offerings, lesson offerings, seminar offerings, lecture offerings, activity offerings, course offerings, diploma program offerings, degree program offerings, certificate program offerings, or continuing education offerings, any description of same, information regarding any materials or subject matter to be covered by same, any agenda for same, any syllabus for same, any scheduling information for same, including but not limited to, the day, dates, and times of same, and/or any instructors or trainers of or for same.

It is also envisioned that the present invention can be utilized in a global setting such that the various individuals, gyms, health clubs, country clubs, exercise facilities, fitness facilities, or fitness centers, or martial arts schools, or martial arts centers or academies, schools, colleges, universities, trade schools, training institutes or academies, continuing education facilities, or learning centers, who or which can utilize the apparatus of the present invention, can be located anywhere in the World.

The instructional facility communication device of or associated with the respective individual, gym, health club, country club, exercise facility, fitness facility, or fitness center, or martial arts school, or martial arts center or academy, school, college, university, trade school, training institute or academy, continuing education facility, or learning center, can be programmed to automatically transmit any and/or all of the herein-described information regarding the respective instructional offerings, educational offerings, or academic offerings, class offerings, lesson offerings, seminar offerings, lecture offerings, activity offerings, course offerings, diploma program offerings, degree program offerings, certificate program offerings, or continuing education offerings, of same, to the central processing computer for storage in the database.

A user or individual can also utilize the present invention in order to search for and identify and/or locate classes, lessons, seminars, or courses which he or she can view or attend, or in which he or she can participate. The user or individual can be an enrolled student in, or can be a member of, a Krav Maga school or center and might be interested in finding or identifying a class or lesson offered or provided by his or her Krav Maga school or center or any other Krav Maga school or center. The user or individual might also be away from home, or may be traveling in a different time zone and simply may want to remotely view, attend, or participate in, a soon to be provided or offered class or lesson.

Each instructional facility communication device can be programmed to automatically transmit and/or upload any instructional records, or educational records of any users or individuals, or any changes or updates to same, which are stored in the database of same, to the central processing computer for storage in the database of same. The central processing computer can also be programmed to automatically transmit and/or upload any instructional records, or educational records of any users or individuals, or any changes or updates to same, which are stored in the database of same, to each instructional facility communication device associated with each individual, gym, health club, country club, exercise facility, fitness facility, or fitness center, or martial arts school, or martial arts center or academy, school, college, university, trade school, training institute or academy, continuing education facility, or learning center, of or with whom or of or with which the user or individual is a student, enrolled with, or a member. In this regard, any instructional record(s) or education record(s) of any user or individual can be automatically updated in the central processing computer and in every instructional facility communication device every time a change or update is made to any user's or individual's instructional record(s) or education record(s) by the central processing computer or by any instructional facility communication device.

The instructional facility communication device of or associated with the respective individual, gym, health club, country club, exercise facility, fitness facility, or fitness center, or martial arts school, or martial arts center or academy, school, college, university, trade school, training institute or academy, continuing education facility, or learning center, can be programmed to automatically transmit any and/or all of the herein-described information regarding the respective instructional offerings, educational offerings, or academic offerings, class offerings, lesson offerings, seminar offerings, lecture offerings, activity offerings, course offerings, diploma program offerings, degree program offerings, certificate program offerings, or continuing education offerings, and/or any and/or all of the herein-described information regarding any classes, lessons, seminars, or courses, offered or provided by same, to the central processing computer for storage in the database.

The present invention can also be utilized to generate and transmits alerts, alert messages, notifications, or notification messages, containing information regarding an availability, an offering, or a providing, or any class(es), lesson(s), seminar(s), or course(s), for which the user or individual has requested to be notified. A user or individual can utilize the present invention in order to request to be provided with an alert, an alert message, a notification, or a notification message, regarding an availability, an offering, or a providing, or any class(es), lesson(s), seminar(s), or course(s). For example, the user or individual can request to be provided with an alert, an alert message, a notification, or a notification message, regarding a Krav Maga class which might be taught in a particular city or country, which might have a recognized expertise for teaching certain techniques, which may be taught by a certain instructor or instructors, or a class, lesson, seminar, or course, which might simply be offered at a particular time, or which might be offered or provided at a specific time.

The user or individual can be an enrolled student in, or can be a member of, a Krav Maga school or center and might be interested in finding or identifying a class or lesson offered or provided by his or her Krav Maga school or center or any other Krav Maga school or center. The user or individual might also be away from home, or traveling in a different time zone and simply may want to be notified regarding a soon to be provided or offered class, lesson, seminar, or course, which might be available or which may become available for him or her to remotely view or attend, or in which the user or individual can participate.

Each instructional facility communication device can be programmed to automatically transmit and/or upload any instructional records, or educational records of any users or individuals, or any changes or updates to same, which are stored in the database of same, to the central processing computer for storage in the database of same. The central processing computer can also be programmed to automatically transmit and/or upload any instructional records, or educational records of any users or individuals, or any changes or updates to same, which are stored in the database of same, to each instructional facility communication device associated with each individual, gym, health club, country club, exercise facility, fitness facility, or fitness center, or martial arts school, or martial arts center or academy, school, college, university, trade school, training institute or academy, continuing education facility, or learning center, of or with whom or of or with which the user or individual is a student, enrolled with, or a member. In this regard, any instructional record(s) or education record(s) of any user or individual can be automatically updated in the central processing computer and in every instructional facility communication device every time a change or update is made to any user's or individual's instructional record(s) or education record(s) by the central processing computer or by any instructional facility communication device.

The instructional facility communication device of or associated with the respective individual, gym, health club, country club, exercise facility, fitness facility, or fitness center, or martial arts school, or martial arts center or academy, school, college, university, trade school, training institute or academy, continuing education facility, or learning center, can be programmed to automatically transmit any and/or all of the herein-described information regarding the respective instructional offerings, educational offerings, or academic offerings, class offerings, lesson offerings, seminar offerings, lecture offerings, activity offerings, course offerings, diploma program offerings, degree program offerings, certificate program offerings, or continuing education offerings, and/or any and/or all of the herein-described information regarding any classes, lessons, seminars, or courses, offered or provided by same, to the central processing computer for storage in the database.

The apparatus and method of the present invention can be utilized in order to establish and maintain a comprehensive instructional and educational record (hereinafter “instructional/educational record”) for users or individuals. The instructional/educational record can include any and/or all data and/or information regarding any and/or all of the a user's or individual's instructional and/or educational and/or academic activities and/or history, including, but not limited to, a user's or individual's education, pre-school education and instruction, grammar school and/or grade school education and/or instruction, middle school education or instruction, high school education and/or instruction, trade school education and/or instruction, college or university education and/or instruction, graduate school education and/or instruction, professional school education and/or instruction, continuing education and/or instruction, and/or any other educational and/or instructional institution or school, in, at, or with, which, the user or individual has taken, had, or completed, and/or any classes or courses taken, had, and/or completed, at, in, during, with, and/or regarding same, as well as any and/or all transcripts of any and/or all instructional activities or education activities at these schools or institutions, as well as any and/or all records regarding an individual's or a user's exercise and/or fitness activities, and/or any exercise or fitness classes taken or participated in, gym or fitness club or facility membership(s), any and/or all records regarding an individual's or a user's training in any martial arts, sports, or athletics, and/or any school, training center, or training academy, membership(s), and/or any other information regarding the individual's or the user's instructional, educational, fitness, exercise, martial arts, sports, or athletics or any other physical, activities.

The instructional/education records, and any instructional records accounts and/or educational records accounts associated therewith can also be utilized to maintain records of a user's or individual's instructional, educational, fitness, exercise, martial arts, sports, or athletics or any other physical, activities throughout the individual's or the user's lifetime or for any period or periods during the individual's or the user's lifetime. In this regard, the instructional/educational records, and any instructional records accounts and/or educational records accounts associated therewith, can contain an instructional, educational, and/or academic, component as well as can contain a fitness, exercise, martial arts, sports, or athletics or any other physical, activities, component. Once created or established, the instructional/education record is maintained centrally, such as in and/or on the central processing computer, and/or can also be maintained on the “Cloud” or in any other Internet and/or World Wide Web based storage platform.

The instructional/educational record can also contain, as a component thereof, any and/or all transcripts containing information regarding the user's or individual's instructional, educational, fitness, exercise, martial arts, sports, or athletics or any other physical, activities, including data and/or information regarding any and/or all schools, colleges, universities, trade schools, training institutes or academies, continuing education facilities, or learning centers, attended, as well any individuals, gyms, health clubs, country clubs, exercise facilities, fitness facilities, or fitness centers, or martial arts schools, or martial arts centers or academies, or any other institutions or facilities which the user individual has been a student or member.

The transcript can contain or include, for each school, college, university, trade school, training institute or academy, continuing education facility, or learning center, attended, as well any individual, gym, health club, country club, exercise facility, fitness facility, or fitness center, or martial arts school, or martial arts center or academy, or any other institution or facility, the user or individual has been a student, has been enrolled, or has been a member, information regarding dates or attendance or membership, courses taken, classes, lessons, or seminars taken or attended, grades earned, diplomas earned, degrees earning, continuing education credits earned, advancement or progression through a program, and/or any other information regarding the user's or individual's enrollment, attendance, and/or involvement, with the respective school, college, university, trade school, training institute or academy, continuing education facility, or learning center, attended, as well any individual, gym, health club, country club, exercise facility, fitness facility, or fitness center, or martial arts school, or martial arts center or academy, or any other institution or facility. Any transcript can also include information regarding any standardized tests or examinations taken by the user or individual and any results or grades regarding same of same as well as any licensing tests or examinations taken by the user or individual and any results or grades regarding same of same, as well any licenses held by the user or individual and the status of same.

The transcript or transcripts contained in the instructional/educational record can be a multimedia transcript which can contain text information, photographs, video clips, video recordings, video information, audio clips, audio recordings, and/or audio information, of, for, or regarding, the user or individual. In this regard, any transcript can contain and/or can include a photograph or photographs or a video clip or a video recording of the user or individual during his or her lifetime, throughout his or her educational career, during or throughout the user's or individual's involvement or participation in any activities, including, but not limited to, fitness, exercise, martial arts, sports, or athletics, or any other physical, activities, of any testing, accomplishments, performances, or any other events, activities, or happenings, during or throughout the user's or individual's instructional or educational career which are deemed to be important or noteworthy enough to be recorded and stored along with any instructional records or educational records of and for the user or individual.

The apparatus and method of the present invention can be utilized to simply any application process to or with any school, college, university, trade school, training institute or academy, continuing education facility, or learning center, to which the user or individual is applying or has applied which requires that transcripts for the user or individual be submitted from each prior or current school, college, university, trade school, training institute or academy, continuing education facility, or learning center, which user or individual has attended or is currently attending. By utilizing the apparatus of the present invention, the user or individual, or a person handling the application process for the user or individual, need only supply the school, college, university, trade school, training institute or academy, continuing education facility, or learning center, with the user's or individual's instructional/educational record identification number.

Thereafter, the school, college, university, trade school, training institute or academy, continuing education facility, or learning center, can access the central processing computer, access the user's or individual's instructional/educational record, or any portion of same to which its access may be limited, and obtain any needed instructional, educational, or academic, transcripts, of or regarding the user or individual, and/or obtain any other relevant or pertinent information regarding any information contained in the user's or individual's instructional/educational record or any information regarding any record of activities with or pertaining to any school, college, university, trade school, training institute or academy, continuing education facility, or learning center, or any individual, gym, health club, country club, exercise facility, fitness facility, or fitness center, or martial arts school, or martial arts center or academy, or any other institution or facility, in or at which the user or individual has been a student, has been enrolled as a student, has been a member, is currently a student, is currently enrolled as a student, or is currently a member, which information might be pertinent or relevant to the user's or individual's application.

The user or individual, a parent of the user or individual, or any authorized person, can, at any time, and for any reason, place limitations or restrictions on the ability of any person, individual, or entity, to access his or her instructional/educational record or any portions of same, so as to safeguard same.

The central processing computer can generate an alert, an alert message, a notification, or a notification message, each time any person or entity, or any school, college, university, trade school, training institute or academy, continuing education facility, or learning center, or any individual, gym, health club, country club, exercise facility, fitness facility, or fitness center, or martial arts school, or martial arts center or academy, or any other institution or facility, attempts to access or accesses his or her instructional/educational record.

The central processing computer can automatically generate an alert, an alert message, a notification, or a notification message, containing information regarding the name of the person or entity, or of the school, college, university, trade school, training institute or academy, continuing education facility, or learning center, or any individual, gym, health club, country club, exercise facility, fitness facility, or fitness center, or martial arts school, or martial arts center or academy, or any other institution or facility, which has attempted to access, or which has accessed, the user's or individual's instructional/educational record, the date ad/or time of same, and any information regarding any reason or purpose for same. Thereafter, the central processing computer can transmit the alert, the alert message, the notification, or the notification message, to the user or individual, to the user communication device, or to any other user communication device of, associated with, or used by, the user or individual, the parent of the user or individual, or any authorized person, as or in an e-mail message, a text message, an SMS message, an MMS message, a pre-recorded telephone message, or as or in any electronic transmission. In this manner, the user or individual, any parent of the user or individual, or any authorized person, can be notified and kept informed regarding any access or attempted access to the user's or individual's instructional/educational record.

The apparatus of the present invention can also be utilized to provide an electronic healthcare record for a user or individual which can contain or include, or which can be linked to or with the user's or individual's instructional/educational record or the user's or the individual's comprehensive instructional/educational record. In this regard, any pertinent or relevant data and/or information contained or included in the user's or individual's instructional/educational record or the user's or the individual's comprehensive instructional/educational record can be accessed, obtained, and/or utilized, by an authorized healthcare provider in providing healthcare services for the user or individual, in making or arriving at a diagnosis for the user or individual, in prescribing treatments for the user or individual, in prescribing or monitoring rehabilitation or therapies for the user or individual, in prescribing a drug, a medication, a therapy, a test, or a procedure, in prescribing or monitoring treatments or treatment plans for the user or individual, in monitoring exercise or fitness programs for the user or individual, and/or in pre-authorizing or clearing the user or individual to engage in certain physical activities, exercise and/or fitness programs, or any other activities, and/or in performing or engaging in any other activity or activities pursuant to providing healthcare or healthcare-related services for the user or individual.

The user's or individual's electronic healthcare record, file, or history, with is stored in the database of the healthcare records computer, can be linked to or with, or can contain, in a portion or same, a copy of the user's or individual's instructional/educational record, or any portion of same to which access is allowed to a healthcare provider, and which can be stored in the database of the central processing computer and/or in the database of the instructional/educational records computer.

The user's or individual's instructional/educational record, or any portion of same, to which access rights or privileges have or may be granted to an authorized healthcare provider of the user or individual, can be accessed via the user's or individual's healthcare record. Thereafter, any information contained in the individual's instructional/educational record, or any portion of same, can be utilized by an authorized healthcare provided in providing a service or services to or for the user or individual.

The apparatus of the present invention can be utilized to allow a user or individual, who is enrolled in a course at a school, college, university, trade school, training institute or academy, continuing education facility, or learning center, to fulfill course attendance requirements or any other course requirements, by remotely viewing, attending, or participating in one or more classes, lectures, or seminars, offered or provided by another school, college, university, trade school, training institute or academy, continuing education facility, or learning center, or any number of other schools, colleges, universities, trade schools, training institutes or academies, continuing education facilities, or learning centers.

It is envisioned that a school, college, university, trade school, training institute or academy, continuing education facility, or learning center, can post information regarding a course on or via its instructional facility communication device, which can also be, or which can serve as, or be linked with its server computer, its host computer, or any computer associated with its website. The information regarding the course can include a course syllabus and/or agenda, and a list of classes, lectures, or seminars, which comprise the course syllabus, agenda, or teaching plan.

For each class, lecture, or seminar, which can be attended either in-person and/or in a classroom, or remotely via the Internet and/or the World Wide Web or any other communication network, or any combination of same, the school, college, university, trade school, training institute or academy, continuing education facility, or learning center, can provide the scheduled date(s) and/or time(s) of, the instructor of or for, the subject matter or material to be covered by or in, and/or any other information regarding the class, lecture, or seminar, and/or any information regarding any class or classes, lecture or lectures, or seminar or seminars, offered by any other school or schools, college or colleges, university or universities, trade school or trade schools, training institute or academy or training institutes or academies, continuing education facility or facilities, or learning center or learning centers, which is or are recognized by the school, college, university, trade school, training institute or academy, continuing education facility, or learning center, as being or having the subject matter or other equivalent of any class, lecture, or seminar, of or associated with its course in which the user or individual is, or will be, enrolled.

It is envisioned that, by allowing its students to view, attend, or participate in, classes, lectures, or seminars, offered by other schools, colleges, universities, trade schools, training institutes or academies, continuing education facilities, or learning centers, instead of, or in addition to the classes, lectures, or seminars, provided by it, the school, college, university, trade school, training institute or academy, continuing education facility, or learning center, can provide its students with a more diversified learning experience. In this manner, an user or individual can remotely view, attend, or participate in, classes, lectures, or seminars, from any other, or from any number of schools, colleges, universities, trade schools, training institutes or academies, continuing education facilities, or learning centers, instead of, or in addition to, attending any classes, lectures, or seminars, of a course offered or provided by his or her respective school, college, university, trade school, training institute or academy, continuing education facility, or learning center.

The central processing computer and, in particular, the database of same, can, for each course offered by any of the schools, colleges, universities, trade schools, training institutes or academies, continuing education facilities, or learning centers, which utilize the apparatus of the present invention, store and/or contain or include data and/or information regarding a listing of all classes, lectures, or seminars, for that course, as well as a listing or listings of any and/or all classes, lectures, or seminars, offered by other schools, colleges, universities, trade schools, training institutes or academies, continuing education facilities, or learning centers, which offer or provide the same or equivalent subject matter, or which cover the same or equivalent materials, as any class or classes, any lecture or lectures, or any seminar or seminars, of the courses offered by the schools, colleges, universities, trade schools, training institutes or academies, continuing education facilities, or learning centers.

The instructional facility communication device and, in particular, the database of same, for each course offered by the school, college, university, trade school, training institute or academy, continuing education facility, or learning center, which utilizes the apparatus of the present invention, can store and/or contain or include data and/or information regarding a listing of all classes, lectures, or seminars, for that course, as well as a listing or listings of any and/or all classes, lectures, or seminars, offered by other schools, colleges, universities, trade schools, training institutes or academies, continuing education facilities, or learning centers, which offer or provide the same or equivalent subject matter, or which cover the same or equivalent materials, as any class or classes, any lecture or lectures, or any seminar or seminars, of the courses offered by the school, college, university, trade school, training institute or academy, continuing education facility, or learning center.

The schools, colleges, universities, trade schools, training institutes or academies, continuing education facilities, or learning centers, can approve or and/or agree beforehand regarding any similarity or equivalence of the subject matter or materials presented or covered by any of the respective classes, lectures, or seminars.

The apparatus of the present invention can also be utilized to allow a user or individual, who is enrolled in a school, college, university, trade school, training institute or academy, continuing education facility, or learning center, to fulfill requirements for a diploma, a degree, or a certificate, or to complete any other formal program, by enroll in, or to register for, a course or courses which are offered by one or more other schools, colleges, universities, trade schools, training institutes or academies, continuing education facilities, or learning centers. The user or individual can then engage in studies in and for that course or courses remotely, in a distance learning environment, with that other school, college, university, trade school, training institute or academy, continuing education facility, or learning center, and receive credit, or transfer credits, for such studies from his or her school, college, university, trade school, training institute or academy, continuing education facility, or learning center.

It is envisioned that a school, college, university, trade school, training institute or academy, continuing education facility, or learning center, can post, on its instructional facility communication device, which can also be, or which can serve as, or be linked with its server computer, its host computer, or any computer associated with its website, information regarding its various diploma programs, degree programs, certificate programs, or any other formal education programs, as well as any courses which are required for satisfying same. It is also envisioned that the a school, college, university, trade school, training institute or academy, continuing education facility, or learning center, can also post, a course or courses which are offered by other schools, colleges, universities, trade schools, training institutes or academies, continuing education facilities, or learning centers, which the user's or individual's school will accept for credit for or towards, or as transfer credit for or towards a diploma, a degree, or a certificate, or any other formal program. The user's or individual's school can agree beforehand to accept a course or any number of courses, for credit, or for transfer credit, towards a diploma, a degree, or a certificate, or any other formal program, with the user's or individual's school, regardless of whether or not the course or courses offered or provided by the other schools, colleges, universities, trade schools, training institutes or academies, continuing education facilities, or learning centers, are the same as, or similar to or in, and/or cover, the subject matter or materials covered by any course or courses offered or provided by the user's or individual's school.

Any data and/or information regarding and course or courses for which the user's or individual's school will accept credit or transfer credit can be stored in the database of the central processing computer and/or in the database of the instructional facility communication device of or associated with the user's or individual's school. For each course for which the user's or individual's school will accept credit or transfer credit, the data and/or information stored in the database of the central processing computer and/or in the database of the instructional facility computer, can include information regarding a name and description of the course, the school, college, university, trade school, training institute or academy, continuing education facility, or learning center, offering or providing same, the number of credits which the user's or individual's school will accept or accept as transfer credits, the data and/or times or other scheduling information, information regarding the instructor or instructor or of for same, whether the course can be attended in-person or in a classroom and/or whether the course can be remotely viewed, attended or participated in, the diploma, degree, certificate, or continuing education, program in which the course can be applied ad/or used to satisfy, and/or any other information regarding the course.

When the user or individual is in the process of registering for a course or courses at or with his or her school, he or she can be obtain, access, or be provided with the courses which are offered or provided by other schools, colleges, universities, trade schools, training institutes or academies, continuing education facilities, or learning centers, and for which credit or transfer credit is available, and can register or enroll in any one or more of these courses.

In this manner, the apparatus of the present invention can be utilized by user or individual who is enrolled in one school, college, university, trade school, training institute or academy, continuing education facility, or learning center, to enroll in, or to register for, a course or any number of courses, which can be offered or provided by any other school, college, university, trade school, training institute or academy, continuing education facility, or learning center, or any other schools, colleges, universities, trade schools, training institutes or academies, continuing education facilities, or learning centers, and for which the user's or individual's school has agreed to accept credit or transfer credits which can be applied towards any diploma, degree, certificate, or continuing education, program.

Any functionally described herein as being performed by the central processing computer can also be performed by any instructional facility communication device of or associated with any school, college, university, trade school, training institute or academy, continuing education facility, or learning center, in which or with which the user or individual is enrolled or registered as a student.

In this manner, the apparatus of the present invention can provide for diversity in instruction by allowing the user or individual to remotely view, attend, or participate in, classes, lectures, or seminars, offered or provided by another school, college, university, trade school, training institute or academy, continuing education facility, or learning center, or by other schools, colleges, universities, trade schools, training institutes or academies, continuing education facilities, or learning centers.

The apparatus of the present invention can provide for diversity in instruction by allowing the user or individual to remotely view, attend, or participate in, a course or any number of courses offered or provided by another school, college, university, trade school, training institute or academy, continuing education facility, or learning center, or by other schools, colleges, universities, trade schools, training institutes or academies, continuing education facilities, or learning centers, when working towards earning or receiving a diploma, a degree, or a certificate, or when or during performing continuing education studies.

Although described and illustrated as being utilizing in connection or in conjunction with providing Krav Maga instruction, it is to be understood that the apparatus and method of the present invention can be utilized in a same, a similar, and/or an analogous, manner in and for any of the herein-described and various types or kinds of exercise activities, fitness activities, work-out activities, strength and conditioning activities, any type or kinds or sports or athletic activities, aerobics activities, weight training activities, cross training activities, callisthenic activities, Pilates activities, Yoga activities, meditation activities, Tai Chi activities, boxing, wrestling, kickboxing, cheerleading, martial arts activities, including, but not limited to, Krav Maga (Israeli martial arts), Karate, Kung Fu, Judo, Jujitsu, Kick Boxing, Mixed Martial Arts, Muy Tai, Brazilian Jujitsu, Savate, and any other type or kind of martial arts, as well as any other type or kind of physical activities, exercise activities, fitness activities, or wellness activities, and/or in connection with and/or in conjunction with providing or offering of any types or kinds of instructional services and/or educational services in and for any types of kinds of academic subjects, classes, courses, diploma programs, degree programs, certificate programs, or continuing education programs, and/or any other informational, instructional, or educational, programs or activities, provided by or offered by any instructional and/or educational school, institution, facility, college, university, professional school continuing education institution, or any other learning institution or facility.

### BRIEF DESCRIPTION OF THE DRAWINGS

In the Drawings:

FIG. 1 illustrates a preferred embodiment of the apparatus of the present invention, in block diagram form;

FIG. 2 illustrates the central processing computer of FIG. 1, in block diagram form;

FIG. 3 illustrates the user communication device of FIG. 1, in block diagram form;

FIG. 4 illustrates the instructional facility communication device of FIG. 1, in block diagram form;

FIG. 5 illustrates the healthcare records computer of FIG. 1, in block diagram form;

FIG. 6 illustrates the instructional/educational records computer of FIG. 1, in block diagram form;

FIG. 7 illustrates the media computer of FIG. 1, in block diagram form;

FIG. 8 illustrates the social networking computer of FIG. 1, in block diagram form;

FIGS. 9A and 9B illustrate a preferred embodiment method for utilizing the apparatus of the present invention, in flow diagram form;

FIGS. 10A and 10B illustrate another preferred embodiment method for utilizing the apparatus of the present invention, in flow diagram form;

FIGS. 11A and 11B illustrate yet another preferred embodiment method for utilizing the apparatus of the present invention, in flow diagram form;

FIGS. 12A and 12B illustrate still another preferred embodiment method for utilizing the apparatus of the present invention, in flow diagram form;

FIGS. 13A and 13B illustrate a preferred embodiment method for utilizing the apparatus of the present invention, in flow diagram form;

FIGS. 14A and 14B illustrate another preferred embodiment method for utilizing the apparatus of the present invention, in flow diagram form;

FIGS. 15A and 15B illustrate yet another preferred embodiment method for utilizing the apparatus of the present invention, in flow diagram form;

FIG. 16 illustrates still another preferred embodiment method for utilizing the apparatus of the present invention, in flow diagram form;

FIG. 17 illustrates yet another preferred embodiment method for utilizing the apparatus of the present invention, in flow diagram form; and

FIG. 18 illustrates still another preferred embodiment method for utilizing the apparatus of the present invention, in flow diagram form.

### DESCRIPTION OF THE PREFERRED EMBODIMENTS

The present invention pertains to an apparatus and method for remotely providing instructional and/or educational information or services, and/or training information or services, in a network environment and, in particular, the present invention pertains to an apparatus and method for remotely providing instructional and/or educational information and/or services, and/or training information or services, in the fields of exercise of any type or kind, fitness of any type or kind, physical activities of any type or kind, training of any type or kind, cross training of any type or kind, athletic training and/or conditioning of any type or kind, martial arts instruction and/or training of any type or kind for any type or kind of martial arts, instructional and/or educational information and/or training regarding fitness, wellness, nutrition, dietary information, and/or healthcare information, and/or instructional and/or educational information regarding academic courses, programs, diploma programs, degree programs, certificate programs, or any other instructional and/or educational programs or offerings of a formal, informal, and/or other nature.

The apparatus and method of the present invention can provide a centralized hub for individuals of any and all ages to engage in and/or to participate in exercise programs, fitness programs, and/or martial arts programs, and/or to engage in and/or to participate in instructional programs, educational programs, diploma programs, degree programs, certificate programs, continuing education programs, and/or training programs of any type or kind, in an on-line environment and/or in a brick and mortar environment.

The apparatus and method of the present invention can be utilized to allow individuals and users to hold a membership in a gym, health club, country club, an exercise facility, a fitness facility, a fitness center, or martial arts school, or martial arts center or academy, of any type or kind, in or at which the individual or user can engage in exercise or fitness activities, programs, or classes, or martial arts training, and also allow the individual or user to view and/or engage in or participate in activities, programs, or classes, provided by that, as well as any other, gym, health club, country club, exercise facility, fitness facility, or fitness center, or martial arts school, or martial arts center or academy, while on-line and/or on, over, or via, the Internet and/or the World Wide Web. In this regard, the apparatus and method of the present invention can allow the individual or the user to engage in exercise and/or fitness, or martial arts training, activities remotely and while on-line, enabling the individual or the user to engage in exercise activities at any time and from any place with any participating individual, gym, health club, country club, exercise facility, fitness facility, or fitness center, or martial arts school, or martial arts center or academy.

An individual or user can engage in exercise activities and/or fitness activities, or martial arts training, at his or her gym, health club, country club, exercise facility, fitness facility, or fitness center, or martial arts school or martial arts center or academy, or at any other gym, health club, country club, exercise facility, fitness facility, or fitness center, or martial arts school, or martial arts center or academy, which participates in utilizing the present invention, so as to enable the individual or the user to engage in exercise and/or fitness activities, or martial arts training, from anywhere, at any time, and with any participating individual, gym, health club, country club, exercise facility, fitness facility, or fitness center, or martial arts school, or martial arts center or academy.

The apparatus and method of the present invention can allow the individual or the user to engage in exercise and/or fitness, or martial arts training, activities remotely and while on-line, enabling the individual or the user to engage in exercise activities at any time and from any place with any participating individual, gym, health club, country club, exercise facility, fitness facility, or fitness center, or martial arts school or martial arts center or academy. An individual or user can engage in exercise activities and/or fitness activities, or martial arts training, at his or her gym, health club, country club, exercise facility, fitness facility, or fitness center, or martial arts school or martial arts center or academy, or at any other gym, health club, country club, exercise facility, fitness facility, or fitness center, or martial arts school or martial arts center or academy, which participates in utilizing the present invention, so as to enable the individual or the user to engage in exercise and/or fitness activities, or martial arts training, from anywhere, at any time, and with any participating individual, gym, health club, country club, exercise facility, fitness facility, or fitness center, or martial arts school or martial arts center or academy.

The apparatus and method of the present invention can be utilized to allow individuals and users to hold a membership in a virtual gym, health club, country club, exercise facility, fitness facility, or fitness center, or martial arts school or martial arts center or academy, of any type or kind, in or at which the individual or user can engage in on-line exercise or fitness activities, programs, or classes, or martial arts training, and also allow the individual or user to view and/or engage in or participate in activities, programs, or classes, or martial arts training, provided by that virtual, as well as any other, gym, health club, country club, exercise facility, fitness facility, or fitness center, or martial arts school or martial arts center or academy, while on-line and/or on, over, or via, the Internet and/or the World Wide Web. In this regard, the apparatus and method of the present invention can allow the individual or the user to engage in exercise and/or fitness activities, or martial arts training, remotely and while on-line, thereby enabling the individual or the user to engage in exercise or fitness activities, or martial arts training, at any time, from any place, and/or with any participating individual, gym, health club, country club, exercise facility, fitness facility, or fitness center, or martial arts school or martial arts center or academy.

The apparatus and method of the present invention can be utilized to allow individuals and users to hold a membership in a virtual gym, health club, country club, exercise facility, fitness facility, or fitness center, or martial arts school, or martial arts center or academy, of any type or kind, in or at which the individual or user can engage in on-line exercise or fitness activities, programs, or classes, or martial arts training, and also allow the individual or user to view and/or engage in or participate in activities, programs, or classes, or martial arts training, provided by that virtual, as well as any other, gym, health club, country club, exercise facility, fitness facility, or fitness center, or martial arts school, or martial arts center or academy, while on-line and/or on, over, or via, the Internet and/or the World Wide Web. In this regard, the apparatus and method of the present invention can allow the individual or the user to engage in exercise and/or fitness activities, or martial arts training, remotely and while on-line, thereby enabling the individual or the user to engage in exercise or fitness activities, or martial arts training, at any time, from any place, and/or with any participating individual, gym, health club, country club, exercise facility, fitness facility, or fitness center, or martial arts school, or martial arts center or academy.

The apparatus and method of the present invention can be utilized to allow individuals and users to study at a school, a college, a university, a trade school, a training institute or academy, a continuing education facility, a learning center, or any other entity which provides instruction or academic offerings to students, while allowing the individual or the user to study while on-line and/or on, over, or via, the Internet and/or the World Wide Web with that school, college, university, trade school, training institute or academy, continuing education facility, learning center, or other entity, or with any other school, college, university, trade school, training institute or academy, continuing education facility, learning center, or other entity, which participates in utilizing the apparatus of the present invention.

The apparatus and method of the present invention can also provide for the creation and maintenance of instructional records and instructional records accounts as well as educational records and educational records accounts for any of the herein-described individuals or users of the present invention. The instructional records, instructional records accounts, educational records, and/or educational records accounts, can be utilized to maintain records for, among other things, any and/or all of an individual's or a user's education, pre-school education and instruction, grammar school and/or grade school education and/or instruction, middle school education or instruction, high school education and/or instruction, trade school education and/or instruction, college or university education and/or instruction, graduate school education and/or instruction, professional school education and/or instruction, continuing education and/or instruction, and/or any other educational and/or instructional institution or school, in, at, or with, which, the individual or user has taken, had, or completed, and/or any classes or courses taken, had, and/or completed, at, in, during, with, and/or regarding same, any and/or all records regarding an individual's or a user's exercise and/or fitness activities, and/or any exercise or fitness classes taken or participated in, gym or fitness club or facility membership(s), any and/or all records regarding an individual's or a user's training in any martial arts, sports, or athletics, and/or any school, training center, or training academy, membership(s), and/or any other information regarding the individual's or the user's instructional, educational, fitness, exercise, martial arts, sports, or athletics or any other physical, activities.

The instructional records, instructional records accounts, educational records, and/or educational records accounts, can also be utilized to maintain records of an individual's or a user's instructional, educational, fitness, exercise, martial arts, sports, or athletics or any other physical, activities throughout the individual's or the user's lifetime or for any period or periods during the individual's or the user's lifetime. In this regard, the instructional records, instructional records accounts, educational records, and/or educational records accounts, can contain an instructional, educational, and/or academic, component as well as can contain a fitness, exercise, martial arts, sports, or athletics or any other physical, activities, component.

The apparatus and method of the present invention can also be utilized in connection with and/or in conjunction with the individual's or the user's electronic healthcare records so that information individual's or a user's instructional, educational, fitness, exercise, martial arts, sports, or athletics or any other physical, activities throughout the individual's or the user's lifetime, or during any period or periods of same, can be utilized by healthcare provider's of the individual or the user in providing healthcare services for the individual or the patient. In a preferred embodiment, the apparatus and method of the present invention can be utilized to link an individual's or a user's instructional records, instructional records accounts, educational records, and/or educational records accounts, to the individual's or the user's electronic healthcare records. In this manner, a healthcare provider and/or a therapist, of any kind or type, can perform diagnoses, prescribe treatments, prescribe therapy, prescribe physical therapy, prescribe a treatment plan, and/or monitor progress of an individual or a user, based on information which can obtained or accessed from, or by monitoring and utilizing, the individual's or the user's instructional record(s), instructional records account(s), educational record(s), and/or educational records account(s).

The apparatus and method of the present invention can also be utilized to allow a healthcare provider to pre-authorize, or provide permission to, an individual or a user, to participate in any exercise program(s), martial arts program(s), sports program, athletics program(s), or any other activities and/or regimens.

The apparatus and method of the present invention can also be utilized to allow an individual or user to participate in exercise, fitness, training, martial arts, sports, athletic, instructional, or educational activities, on-line and/or via, on, or over, the Internet and/or the World Wide Web, with one or more gyms, health clubs, country clubs, exercise facilities, fitness facilities, or fitness centers, or martial arts schools, or martial arts centers or academies, and/or to participate and/or engage in educational activities, instructional activities, or studies, with or at one or more schools, colleges, universities, trade schools, training institutes or academies, continuing education facilities, or learning centers.

The apparatus and method of the present invention can be utilized in order to provide instructional services and/or educational services for any type of kind of exercise activity, fitness activities, work-out activities, strength and conditioning activities, any type or kinds or sports or athletic activities, aerobics activities, weight training activities, cross training activities, callisthenic activities, Pilates activities, Yoga activities, meditation activities, Tai Chi activities, boxing, wrestling, kickboxing, cheerleading, martial arts activities, including, but not limited to, Krav Maga (Israeli martial arts), Karate, Kung Fu, Judo, Jujitsu, Kick Boxing, Mixed Martial Arts, Muy Tai, Brazilian Jujitsu, Savate, and any other type or kind of martial arts, as well as any other type or kind of physical activities, exercise activities, fitness activities, or wellness activities.

The apparatus and method of the present invention can be utilized in order to provide instructional services and/or educational services in and for any type of kind of academic subjects, classes, courses, diploma programs, degree programs, certificate programs, or continuing education programs, and/or any other informational, instructional, or educational programs or activities.

The apparatus and method of the present invention can also be utilized to allow an individual or user to participate in exercise, fitness, training, martial arts, sports, athletic, instructional, or educational activities, with a group of other individuals or users, on-line and/or via, on, or over, the Internet and/or the World Wide Web. The apparatus and method of the present invention can also be utilized to allow an individual or user to participate and/or engage in educational activities, instructional activities, or studies, with a group of other individuals or users, on-line and/or via, on, or over, the Internet and/or the World Wide Web.

The apparatus and method of the present invention can also be utilized to allow an individual or user to search for and/or be notified about any exercise, fitness, training, martial arts, sports, athletic, instructional, or educational, activities, offered by or provided by any one or more of the gyms, health clubs, country clubs, exercise facilities, fitness facilities, or fitness centers, or martial arts schools, or martial arts centers or academies, described herein. The apparatus and method of the present invention can also be utilized to allow an individual or user to search for and/or be notified about any courses, classes, seminars, diploma programs, degree programs, certification programs, continuing education programs, offered by or provided by any one or more of the schools, colleges, universities, trade schools, training institutes or academies, continuing education facilities, or learning centers, described herein.

The apparatus and method of the present invention can also be utilized to allow individuals or users to obtain video recordings of themselves performing any exercise, fitness, training, martial arts, sports, athletic, instructional, or educational, activities, for purposes of having their techniques reviewed, analyzed, or critiqued, by instructors, trainers, or personal trainers, or other qualified individuals. The apparatus and method of the present invention can also be utilized to provide individual, personal, or group, training, instruction, tutoring, or classes, to provide for remote testing and/or evaluation of an individual's or a user's progress or achievements in any exercise, fitness, training, martial arts, sports, athletic, instructional, or educational, activities.

The apparatus and method of the present invention can also be utilized to provide individuals or users with information regarding classes, courses, or seminars, which can be pre-approved for transfer credit by a college, university, graduate school, professional school, or other school, so that an individual or a user can enroll in an take classes, courses, or seminars, at different colleges, universities, graduate schools, professional schools, or other schools, and be assured of receiving appropriate credit for same by or from the college, university, graduate school, or professional school, or other school, in which he or she is enrolled.

The apparatus and method of the present invention can also be utilized to provide individuals or users with information regarding classes, lectures, or seminars, which can be pre-approved for use in satisfying a requirements of a course offered by a college, university, graduate school, professional school, or other school, so that an individual or a user can participate in or engage in the class, lecture, or seminar, of different courses, in the individual's or the user's respective college, university, graduate school, professional school, or other school, or offered in a course or courses offered by or provided by different colleges, universities, graduate schools, professional schools, or other schools, and be assured of receiving appropriate credit for same in meeting the requirements of the course by the college, university, graduate school, or professional school, or other school, in which he or she is enrolled.

Applicant hereby incorporates by reference herein the subject matter and teachings of U.S. Provisional Patent Application Ser. No. 62/035,387, filed Aug. 9, 2014, and entitled “APPARATUS AND METHOD FOR REMOTELY PROVIDING INSTRUCTIONAL AND/OR EDUCATIONAL INFORMATION AND/OR SERVICES IN A NETWORK ENVIRONMENT”, the subject matter and teachings of which are hereby incorporated by reference herein in their entirety.

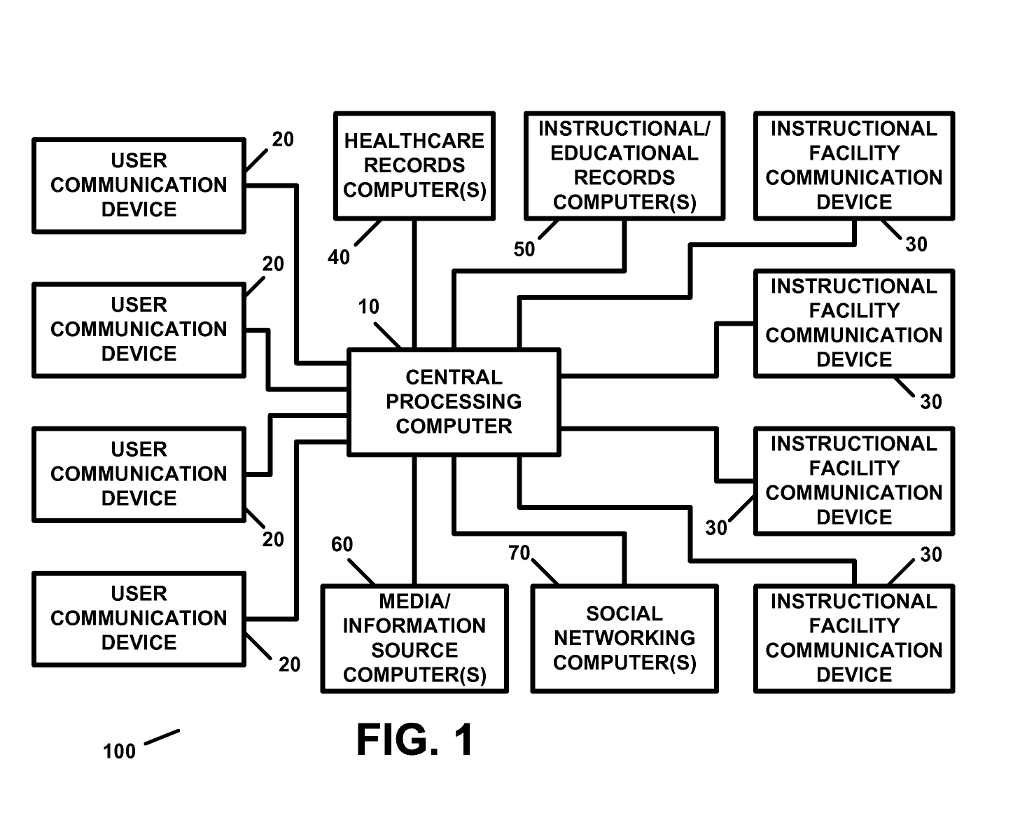

FIG. 1 illustrates the apparatus of the present invention, in block diagram form. The apparatus of the present invention is denoted generally by the reference numeral 100. In the preferred embodiment, the apparatus 100 of the present invention includes a central processing computer or central processing computer system 10 (hereinafter referred to as the “central processing computer 10”). In the preferred embodiment the central processing computer 10 can be any computer or computer system or can be a network or a server computer.

In the preferred embodiment, the central processing computer 10 can provide control over the apparatus 100 and can perform any of the various processing services and/or functions described herein. The central processing computer 10 may be a single computer or system of computers and/or may include a plurality of computers or computer systems which are utilized in conjunction with one another. The central processing computer 10, in the preferred embodiment, can provide services for any of the other computers and/or computer systems described herein as being associated with any of the individuals, users, students, instructional facilities, educational facilities, training facilities, gyms, health clubs, country clubs, fitness centers, wellness centers, athletic training centers or facilities, physical education schools, centers, or programs, martial arts schools, exercise schools or centers, schools, colleges, universities, trade schools, tutors, instructors, healthcare records services providers, healthcare records entities, healthcare records organizations, healthcare records services, instructional and/or educational records entities, instructional and/or educational records service providers, instructional or educational records organizations, instructional and/or educational records organizations, instructional and/or educational records services, instructional and/or educational records service providers, media service providers, media organizations, media sources, media services, information providers, information services providers, information organizations, information sources, information services, social networks, social networking companies, and/or social networking websites, described herein, who or which utilize the apparatus 100 and method of the present invention, who or which can be utilized in connection with the apparatus 100 and method of the present invention, and/or who or which can access the apparatus 100 and method of the present invention, and/or who or which can be accessed via the apparatus 100 and method of the present invention.

The apparatus 100 also includes a user communication device or computer 20 (hereinafter referred to as “user communication device 20” or “user computer 20”) which is associated with, or which be used by, any one or more of any of the herein-described individuals, users, students, instructional facilities, educational facilities, training facilities, gyms, health clubs, country clubs, fitness centers, wellness centers, athletic training centers or facilities, physical education schools, centers, or programs, martial arts schools, exercise schools or centers, schools, colleges, universities, trade schools, tutors, instructors, healthcare records services providers, healthcare records entities, healthcare records organizations, healthcare records services, instructional and/or educational records entities, instructional and/or educational records service providers, instructional or educational records organizations, instructional and/or educational records organizations, instructional and/or educational records services, instructional and/or educational records service providers, media service providers, media organizations, media sources, media services, information providers, information services providers, information organizations, information sources, information services, social networks, social networking companies, and/or social networking websites, described herein, who or which utilize the apparatus 100 and method of the present invention, who or which can be utilized in connection with the apparatus 100 and method of the present invention, and/or who or which can access the apparatus 100 and method of the present invention, and/or who or which can be accessed via the apparatus 100 and method of the present invention.

Any number or amount of user computers 20 can be utilized by or in conjunction with any user or any individual, student, instructional facility, educational facility, training facility, gym, health club, country club, fitness center, wellness center, athletic training center or facility, physical education school, center, or program, martial arts school, exercise school or center, school, college, university, trade school, tutor, instructor, healthcare records services provider, healthcare records entity, healthcare records organization, healthcare records service, instructional and/or educational records entity, instructional and/or educational records service provider, instructional or educational records organization, instructional and/or educational records organization, instructional and/or educational records service, instructional and/or educational records service provider, media service provider, media organization, media source, media service, information provider, information services provider, information organization, information source, information service, social network, social networking company, and/or social networking website, or any group of same or combination of same, described herein, who or which utilize the apparatus 100 and method of the present invention, who or which can be utilized in connection with the apparatus 100 and method of the present invention, and/or who or which can access the apparatus 100 and method of the present invention, and/or who or which can be accessed via the apparatus 100 and method of the present invention.

The user communication device 20 can be any communication device, computer, personal computer, laptop computer, notebook computer, Smart phone or smartphone, smart telephone, cellular telephone, personal digital assistant, tablet, tablet computer, watch, smart watch, or wearable device or computer, or any combination of same, or any equivalent of same, which can be utilized by any person, individual, or entity, who or which utilizes the apparatus 100 and method of the present invention. The user communication device 20 can also be a server computer, a mainframe computer, a mini-computer, a microcomputer, or any other computer or device for suiting the needs of the particular user. A user communication device 20 can also be any device or computer, or a kiosk, that can be located at public places or locations or which can also be publicly available.

The communication device(s) 20 can communicate with, and/or can operate in conjunction with, the central processing computer 10 and/or any of the other communication devices, computers, and/or computer systems, associated with or used by any of the individuals and/or entities who or which utilize and/or operate in conjunction with the apparatus 100 and method of the present invention.

The apparatus 100 can also include an instructional/educational facility communication device or computer 30 (hereinafter referred to as “instructional facility communication device 30”) which is associated with, or which be used by, any one or more of any of the herein-described individuals, instructional facilities, educational facilities, training facilities, gyms, health clubs, country clubs, fitness centers, wellness centers, athletic training centers or facilities, physical education schools, centers, or programs, martial arts schools, exercise schools or centers, schools, colleges, universities, trade schools, tutors, and/or instructors, who or which provide instruction, classes, courses, or training, of any type or kind, who or which utilize the apparatus 100 and method of the present invention, who or which can be utilized in connection with the apparatus 100 and method of the present invention, and/or who or which can access the apparatus 100 and method of the present invention, and/or who or which can be accessed via the apparatus 100 and method of the present invention.

Any number or amount of instructional facility communication devices 30 can be utilized by or in conjunction with any individual, instructional facility, educational facility, training facility, gym, health club, country club, fitness center, wellness center, athletic training center or facility, physical education school, center, or program, martial arts school, exercise school or center, school, college, university, trade school, tutor, and/or instructor, or any group of same or combination of same, described herein, who or which utilize the apparatus 100 and method of the present invention, who or which can be utilized in connection with the apparatus 100 and method of the present invention, and/or who or which can access the apparatus 100 and method of the present invention, and/or who or which can be accessed via the apparatus 100 and method of the present invention.

The instructional facility communication devices 30 can be a server computer, a personal computer, a mainframe computer, a mini-computer, a microcomputer, or any other computer or device for suiting the needs of the particular instructional facility or educational facility. The instructional facility communication devices 30 can also be any communication device, computer, personal computer, laptop computer, notebook computer, Smart phone or smartphone, smart telephone, cellular telephone, personal digital assistant, tablet, tablet computer, watch, smart watch, or wearable device or computer, or any combination of same, or any equivalent of same, which can be utilized by any person, individual, or entity, who or which provides the services of an instructional facility or an educational facility and/or who or which utilizes the apparatus 100 and method of the present invention.

The instructional facility communication device(s) 30 can communicate with, and/or can operate in conjunction with, the central processing computer 10 and/or any of the other communication devices, computers, and/or computer systems, associated with or used by any of the individuals and/or entities who or which utilize and/or operate in conjunction with the apparatus 100 and method of the present invention.

The apparatus 100 can also include a healthcare records computer or communication device 40 (hereinafter referred to as “healthcare records computer 40”) which, in a preferred embodiment, stores an electronic healthcare record or electronic healthcare records for any of the herein-described users or individuals who or which utilize the apparatus 100 and method of the present invention. In a preferred embodiment, the healthcare records computer 40 can also store healthcare records of any members, subscribers, or students, of any of the herein-described, instructional facilities, educational facilities, training facilities, gyms, health clubs, country clubs, fitness centers, wellness centers, athletic training centers or facilities, physical education schools, centers, or programs, martial arts schools, exercise schools or centers, schools, colleges, universities, trade schools, tutors, and/or instructors, who or which provide instruction, classes, courses, or training, of any type or kind, who or which utilize the apparatus 100 and method of the present invention, who or which can be utilized in connection with the apparatus 100 and method of the present invention, and/or who or which can access the apparatus 100 and method of the present invention, and/or who or which can be accessed via the apparatus 100 and method of the present invention.

In a preferred embodiment, the healthcare records computer 40 or computers can serve to store and house an electronic healthcare record or any number of electronic healthcare records. The healthcare records computer 40 can also be utilized to facilitate cloud storage of any electronic healthcare record(s).

Any number or amount of healthcare records computers 40 can be utilized by or in conjunction with any individual, instructional facility, educational facility, training facility, gym, health club, country club, fitness center, wellness center, athletic training center or facility, physical education school, center, or program, martial arts school, exercise school or center, school, college, university, trade school, tutor, and/or instructor, or any group of same or combination of same, described herein, who or which utilize the apparatus 100 and method of the present invention, who or which can be utilized in connection with the apparatus 100 and method of the present invention, and/or who or which can access the apparatus 100 and method of the present invention, and/or who or which can be accessed via the apparatus 100 and method of the present invention.

The healthcare records computer 40 can be a server computer, a personal computer, a mainframe computer, a mini-computer, a microcomputer, or any other computer or device for suiting the needs of the particular healthcare records storage entity. The healthcare records computer 40 can also be any communication device, computer, personal computer, laptop computer, notebook computer, Smart phone or smartphone, smart telephone, cellular telephone, personal digital assistant, tablet, tablet computer, watch, smart watch, or wearable device or computer, or any combination of same, or any equivalent of same, which can be utilized by any person, individual, or entity, who or which provides the services of a healthcare records maintenance and/or storage entity and/or who or which utilizes the apparatus 100 and method of the present invention.

The healthcare records computer(s) 40 can communicate with, and/or can operate in conjunction with, the central processing computer 10 and/or any of the other communication devices, computers, and/or computer systems, associated with or used by any of the individuals and/or entities who or which utilize and/or operate in conjunction with the apparatus 100 of the present invention.

The apparatus 100 can also include an instructional/educational records computer or communication device 50 (hereinafter referred to as “instructional/educational records computer 50”) which, in a preferred embodiment, stores an electronic instructional and/or educational record or electronic instructional and/or educational records for any of the herein-described users or individuals who or which utilize the apparatus 100 and method of the present invention. In a preferred embodiment, the electronic instructional and/or educational record can also store electronic instructional and/or educational record of any members, subscribers, or students, of and/or for any of the herein-described, instructional facilities, educational facilities, training facilities, gyms, health clubs, country clubs, fitness centers, wellness centers, athletic training centers or facilities, physical education schools, centers, or programs, martial arts schools, exercise schools or centers, schools, colleges, universities, trade schools, tutors, and/or instructors, who or which provide instruction, classes, courses, or training, of any type or kind, who or which utilize the apparatus 100 and method of the present invention, who or which can be utilized in connection with the apparatus 100 and method of the present invention, and/or who or which can access the apparatus 100 and method of the present invention, and/or who or which can be accessed via the apparatus 100 and method of the present invention.

In a preferred embodiment, any of the instructional records and/or educational records described herein as being utilized in connection with the apparatus 100 and method of the present invention can contain an instructional, educational, and/or academic, component as well as can contain a fitness, exercise, martial arts, sports, or athletics or any other physical, activities, component. In this regard, each instructional record or educational record described herein, in a preferred embodiment, can contain an instructional, educational, and/or academic, record and/or a fitness, exercise, martial arts, sports, or athletics or any other physical, record.

In a preferred embodiment, the instructional/educational records computer 50 or computers can serve to store and house an instructional/educational record or any number of instructional/educational records. The instructional/educational records computer 50 can also be utilized to facilitate cloud storage of any instructional/educational record(s).

Any number or amount of instructional/educational records computer 50 can be utilized by or in conjunction with any individual, instructional facility, educational facility, training facility, gym, health club, country club, fitness center, wellness center, athletic training center or facility, physical education school, center, or program, martial arts school, exercise school or center, school, college, university, trade school, tutor, and/or instructor, or any group of same or combination of same, described herein, who or which utilize the apparatus 100 and method of the present invention, who or which can be utilized in connection with the apparatus 100 and method of the present invention, and/or who or which can access the apparatus 100 and method of the present invention, and/or who or which can be accessed via the apparatus 100 and method of the present invention.

The instructional/educational records computer 50 can be a server computer, a personal computer, a mainframe computer, a mini-computer, a microcomputer, or any other computer or device for suiting the needs of the particular instructional/educational records storage entity. The instructional/educational records computer 50 can also be any communication device, computer, personal computer, laptop computer, notebook computer, Smart phone or smartphone, smart telephone, cellular telephone, personal digital assistant, tablet, tablet computer, watch, smart watch, or wearable device or computer, or any combination of same, or any equivalent of same, which can be utilized by any person, individual, or entity, who or which provides the services of an instructional/educational records maintenance and/or storage entity and/or who or which utilizes the apparatus 100 and method of the present invention.

The instructional/educational records computer(s) 50 can communicate with, and/or can operate in conjunction with, the central processing computer 10 and/or any of the other communication devices, computers, and/or computer systems, associated with or used by any of the individuals and/or entities who or which utilize and/or operate in conjunction with the apparatus 100 of the present invention.

The apparatus 100 can also include a media computer 60. In the preferred embodiment, the media computer 80 can provide, and can be a source of information, news information, current events information, healthcare information, healthcare or healthcare-related news, fitness information, wellness information, nutrition information, workout or training information, exercise information, martial arts information, academic information, course information, class information, current events, advertisements, and/or marketing information or materials, and/or any other information which can be provided with any of the herein-described features or services which can be provided by, with, or via, the apparatus 100 of the present invention and/or which can be disseminated via the apparatus 100 of the present invention, In a preferred embodiment, any number of media computers 80, with each being dedicated to providing any number, types, or kinds of, of information, news information, current events information, healthcare information, healthcare or healthcare-related news, fitness information, wellness information, nutrition information, workout or training information, exercise information, martial arts information, academic information, course information, class information, current events, advertisements, and/or marketing information or materials, and/or any other information or materials, can be utilized in connection with the apparatus 100.

In a preferred embodiment, the media computer 60 or computers can serve to store and house any media and/or any information. The media computer 60 can also be utilized to facilitate cloud storage of any media and/or information.

Any number or amount of media computers 60 can be utilized by or in conjunction with any media provider or information source who or which utilizes the apparatus 100 of the present invention who or which utilize the apparatus 100 and method of the present invention, who or which can be utilized in connection with the apparatus 100 and method of the present invention, and/or who or which can access the apparatus 100 and method of the present invention, and/or who or which can be accessed via the apparatus 100 and method of the present invention.

The media computer 60 can be a server computer, a personal computer, a mainframe computer, a mini-computer, a microcomputer, or any other computer or device for suiting the needs of the particular media provider or information source. The media computer 60 can also be any communication device, computer, personal computer, laptop computer, notebook computer, Smart phone or smartphone, smart telephone, cellular telephone, personal digital assistant, tablet, tablet computer, watch, smart watch, or wearable device or computer, or any combination of same, or any equivalent of same, which can be utilized by any person, individual, or entity, who or which provides the services of a media provider or information source and/or who or which utilizes the apparatus 100 and method of the present invention.

The media computer(s) 60 can communicate with, and/or can operate in conjunction with, the central processing computer 10 and/or any of the other communication devices, computers, and/or computer systems, associated with or used by any of the individuals and/or entities who or which utilize and/or operate in conjunction with the apparatus 100 of the present invention.

The apparatus 100 can also include a social networking computer 70. The social networking computer 70 can be linked with, and utilized in connection with, the apparatus 100 so as to allow and/or facilitate integrating the apparatus 100 of the present invention with social networks, social networking, and social media. In a preferred embodiment, for example, the social networking computer 70 can be associated with a social networking company, a social networking website, or social networking entity, website, group, organization, or association. The social networking computer 70 can be associated with any one or any number of social networking companies, social networking websites, or social networking entities, websites, groups, organizations, or associations. The social networking computer 70 can also provide links to any computers associated with any one or any number of social networking companies, social networking websites, or social networking entities, websites, groups, organizations, or associations. In the preferred embodiment, the social networking computer 70 can perform any and all of the functions performed by any social networking company, a social networking website, or social networking entity, website, group, organization, or association. In a preferred embodiment, any number of social networking computers 80 can be utilized in connection with the apparatus 100 of the present invention.

Any number or amount of social networking computers 70 can be utilized by or in conjunction with any social network or social networking provider who or which utilizes the apparatus 100 of the present invention who or which utilize the apparatus 100 and method of the present invention, who or which can be utilized in connection with the apparatus 100 and method of the present invention, and/or who or which can access the apparatus 100 and method of the present invention, and/or who or which can be accessed via the apparatus 100 and method of the present invention.

The social networking computer 70 can be a server computer, a personal computer, a mainframe computer, a mini-computer, a microcomputer, or any other computer or device for suiting the needs of the particular social network or social networking provider. The social networking computer 70 can also be any communication device, computer, personal computer, laptop computer, notebook computer, Smart phone or smartphone, smart telephone, cellular telephone, personal digital assistant, tablet, tablet computer, watch, smart watch, or wearable device or computer, or any combination of same, or any equivalent of same, which can be utilized by social network or social networking provider and/or who or which utilizes the apparatus 100 and method of the present invention.

The social networking computer(s) 70 can communicate with, and/or can operate in conjunction with, the central processing computer 10 and/or any of the other communication devices, computers, and/or computer systems, associated with or used by any of the individuals and/or entities who or which utilize and/or operate in conjunction with the apparatus 100 of the present invention.

In the preferred embodiment, any of the central processing computer(s) 10, the user communication device(s) 20, the instructional facility communication device (s) 30, the healthcare records computer(s) 40, the instructional/educational records computer(s) 50, the media computer(s) 60, and/or the social networking computer(s) 70, can be any computer or communication device, including, but not limited to, a personal computer, a home computer, a server computer, a network computer or any computer capable of being utilized in a network, a hand-held computer, a palmtop computer, a laptop computer, a personal communication device, a cellular telephone, a wireless telephone, a mobile telephone, a digital television, an interactive television, a digital television, a personal digital assistant, a telephone, a digital telephone, a television, an interactive television, a beeper, a pager, and/or a watch or a Smart watch, and/or any wearable device, computer or communication device.

Each of the central processing computer(s) 10, the user communication device(s) 20, the instructional facility communication device (s) 30, the healthcare records computer(s) 40, the instructional/educational records computer(s) 50, the media computer(s) 60, and/or the social networking computer(s) 70, can transmit information to, as well as receive information from, any of the computers or communication devices 10, 20, 30, 40, 50, 60, and/or 70, described herein. In this regard, each of the computers or communication devices 10, 20, 30, 40, 50, 60, and/or 70, can communicate with, process information from, and/or share data and/or information with, each other and/or any other computer(s) or communication device(s) 10, 20, 30, 40, 50, 60, and/or 70, described herein and/or utilized in conjunction with the apparatus 100 of the present invention. In this manner, data and/or information transfer between any of the computer(s) or communication device(s) 10, 20, 30, 40, 50, 60, and/or 70, can communicate with any other computer(s) or communication device(s) 10, 20, 30, 40, 50, 60, and/or 70, in a bi-directional manner.

In the preferred embodiment, the present invention is utilized on, and/or over, the Internet and/or the World Wide Web. The present invention, in the preferred embodiment, can also utilize wireless Internet and/or World Wide Web services, equipment and/or devices. The central processing computer(s) 10, in the preferred embodiment, has a web site or web sites associated therewith. Each of the other computers or communication devices described herein can also have a web site or web sites associated with same.

Although the Internet and/or the World Wide Web is a preferred communication system and/or medium utilized, the present invention, in all of the embodiments described herein, can also be utilized with any appropriate communication network or system including, but not limited to, a communication network or system, a telecommunication network or system, a telephone communication network or system, a cellular communication network or system, a wireless communication network or system, a line or wired communication network or system, a wireless Internet network or system, a wireless World Wide Web network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, a cable television network or system, and/or any other communication network or system, and/or any combination of the above communication networks or systems.

Any of the central processing computer(s) 10, the user communication device(s) 20, the instructional facility communication device (s) 30, the healthcare records computer(s) 40, the instructional/educational records computer(s) 50, the media computer(s) 60, and/or the social networking computer(s) 70, can communicate with one another, and/or be linked to one another, over or via any communication network, telecommunication network, telephone network, a line-connected network, and/or a wireless communication network, and/or the Internet and/or the World Wide Web. Each of the computers or communication devices 10, 20, 30, 40, 50, 60, and 70, can be linked with any other computer or computers directly or indirectly with one another so as to facilitate a direct or indirect bi-directional communication between said respective computers or communication devices. Communications between each of the computers or communication devices 10, 20, 30, 40, 50, 60, and 70, can also involve an e-mail server or e-mail servers in those instances when e-mails are described as being used to transmit or to send any of the information, signals, messages, reports, notification messages, or any other communications, described herein, by or between any of the computers or communication devices 10, 20, 30, 40, 50, 60, and 70, or when any of the information, signals, messages, reports, notification messages, or any other computers or communications, described herein, are transmitted by and/or between any of the parties described herein and/or by or between any of the computers or communication devices 10, 20, 30, 40, 50, 60, and 70, or any other computers or communication devices, computer systems, communication network equipment, server computers, etc., or any other devices used or needed, in order to facilitate communications or the transmission of any of the herein-described information, signals, messages, reports, notification messages, or any other communications.

In a preferred embodiment, each of the central processing computer(s) 10, the user communication device(s) 20, the instructional facility communication device (s) 30, the healthcare records computer(s) 40, the instructional/educational records computer(s) 50, the media computer(s) 60, and/or the social networking computer(s) 70, can communication in a bi-directional manner with, and/or can send and/or receive signals, messages, reports, notification messages, alerts, or any other communications or electronic communication transmissions, to, from and/or between, any other, or any number of, other central processing computer(s) 10, user communication device(s) 20, instructional facility communication device (s) 30, healthcare records computer(s) 40, instructional/educational records computer(s) 50, media computer(s) 60, and/or social networking computer(s) 70.

In a preferred embodiment, each of the central processing computer(s) 10, the user communication device(s) 20, the instructional facility communication device (s) 30, the healthcare records computer(s) 40, the instructional/educational records computer(s) 50, the media computer(s) 60, and/or the social networking computer(s) 70, can be linked to or with any other the central processing computer(s) 10, the user communication device(s) 20, the instructional facility communication device (s) 30, the healthcare records computer(s) 40, the instructional/educational records computer(s) 50, the media computer(s) 60, and/or the social networking computer(s) 70, via a wired link or line or a wireless link.

In a preferred embodiment, each of the user communication device(s) 20, the instructional facility communication device (s) 30, the healthcare records computer(s) 40, the instructional/educational records computer(s) 50, the media computer(s) 60, and/or the social networking computer(s) 70, can be connected with or linked with the central processing computer(s) 10 as shown in FIG. 1.

In a preferred embodiment, any and/or all of the signals, messages, reports, notification messages, or any other communications, described herein as being transmitted from one device, computer, or communication device, to another, can be, or can be included in, or be attached to, an e-mail message, an instant messaging message, an electronic transmission, or an electronic data transmission or electronic data interchange, or can be transmitted via any other data or information transmission, and/or can be transmitted via or using any appropriate or necessary computer(s) or device(s).

In the preferred embodiment, each of the central processing computer(s) 10, the user communication device(s) 20, the instructional facility communication device (s) 30, the healthcare records computer(s) 40, the instructional/educational records computer(s) 50, the media computer(s) 60, and/or the social networking computer(s) 70, can transmit data and/or information using TCP/IP, as well as any other Internet and/or World Wide Web, and/or communication, protocols.

The apparatus 100 of the present invention can utilize electronic commerce technologies and security methods, techniques and technologies, including any encryption or security technologies and/or techniques, in any and/or all of the instances of data and/or information processing, and/or data and/or information transmission described herein.

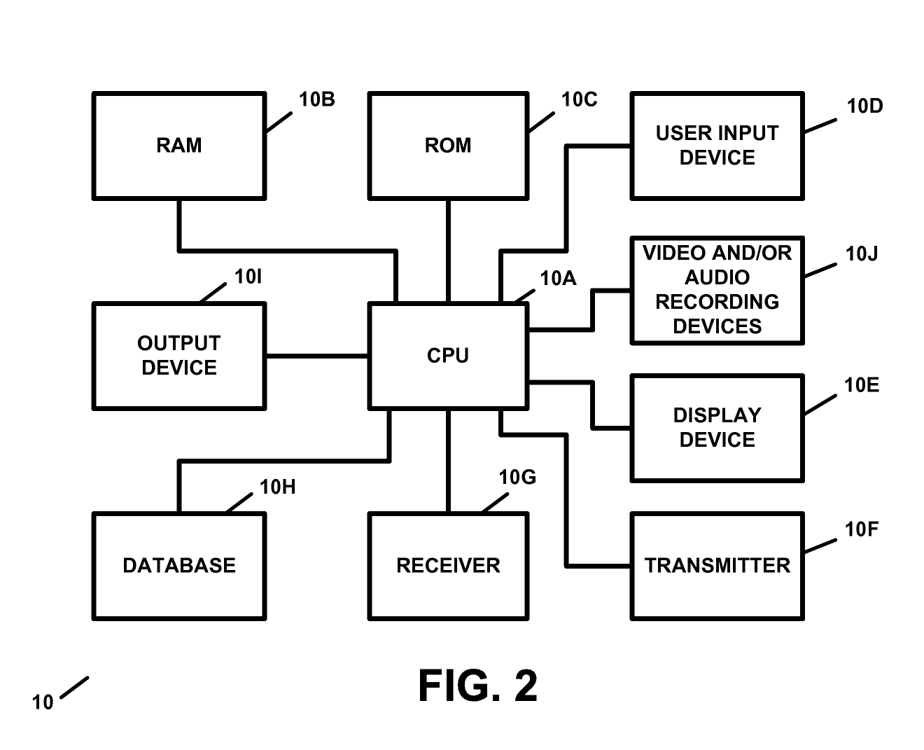

FIG. 2 illustrates the central processing computer 10, in block diagram form. In the preferred embodiment, the central processing computer 10 can be any computer capable of performing the functionality of the central processing computer 10 as described herein, a server computer, a network computer, or a computer system, or any other communication device which can provide the functionality of, and which can be utilized as, a central processing computer 10. The central processing computer 10 can also be any suitable server computer or server computer system, a cloud computer or cloud computer system, or a network computer or computer system. The central processing computer 10 can also be an Internet server computer and/or a web site server computer. In the preferred embodiment, the central processing computer 10 includes a central processing unit or CPU 10A, which in the preferred embodiment, is a microprocessor. The CPU 10A may also be a microcomputer, a minicomputer, a macro-computer, and/or a mainframe computer, depending upon the application.

The central processing computer 10 also includes a random access memory device(s) 10B (RAM), a read only memory device(s) 10C (ROM), each of which is connected to the CPU 10A, and a user input device 10D, for entering data and/or commands into the central processing computer 10, which can include any one or more of a keyboard, a scanner, a user pointing device, such as, for example, a mouse, a touch pad, and/or an audio input device and/or a video input device, a microphone or audio recording device, a camera or a video recording device, and/or any device, electronic and/or otherwise which can be utilized for inputting and/or entering data and/or information, as well as instructions and/or commands, into the central processing computer 10. The central processing computer 10 also includes a display device 10E for displaying data and/or information to a user or operator.

The central processing computer 10 also includes a transmitter(s) 10F, for transmitting signals and/or data and/or information to any one or more of the user communication device(s) 20, the instructional facility communication device (s) 30, the healthcare records computer(s) 40, the instructional/educational records computer(s) 50, the media computer(s) 60, and/or the social networking computer(s) 70, and/or any other central processing computer(s) 10, which may be utilized in conjunction with the present invention. The central processing computer 10 also includes a receiver 10G, for receiving signals and/or data and/or information from any one or more of the user communication device(s) 20, the instructional facility communication device (s) 30, the healthcare records computer(s) 40, the instructional/educational records computer(s) 50, the media computer(s) 60, and/or the social networking computer(s) 70, and/or any other central processing computer(s) 10, which may be utilized in conjunction with the present invention.

The central processing computer 10 also includes a database(s) 10H which, in the preferred embodiment, contains any and/or all of the data and/or information needed or desired for or by the central processing computer 10 to perform all of the operations, actions, functions, and/or functionality, described herein as being provided by, and/or as being performed by, the central processing computer 10 and/or the apparatus 100 of the present invention. In the preferred embodiment, the database 10H also contains and/or includes and and/or all data and information regarding each of the users or individuals who or which utilize the apparatus 100 of the present invention, data and/or information regarding each of the individuals, instructional facilities, educational facilities, training facilities, gyms, health clubs, country clubs, fitness centers, wellness centers, athletic training centers or facilities, physical education schools or centers, martial arts schools, or exercise schools or centers, or schools, colleges, universities, trade schools, tutors, and/or instructors, who or which provides instruction, classes, courses, or training, of any type or kind, and/or who or which utilizes the apparatus 100 and method of the present invention, each entity associated with, or operator of, each healthcare records computer 40 who or which utilizes the apparatus 100 and method of the present invention, each entity associated with, or operator of, each instructional/educational records computer 50 who or which utilizes the apparatus 100 and method of the present invention, each media provider, media source, information provider, information source, who or which utilizes the apparatus 100 of the present invention, or each entity associated with, or operator of, each media computer 60 who or which utilizes the apparatus 100 and method of the present invention, and/or each social networking company or entity, or social network, who or which utilizes the apparatus 100 and method of the present invention, and/or each entity associated with, or operator of, each social networking computer 60 who or which utilizes the apparatus 100 and method of the present invention.

In the preferred embodiment, the database 10H also contains and/or includes any link(s) or hyperlink(s) to any and/or all data and/or information regarding each of the users or individuals who or which utilize the apparatus 100 of the present invention, a data and/or information regarding each of the individuals, instructional facilities, educational facilities, training facilities, gyms, health clubs, country clubs, fitness centers, wellness centers, athletic training centers or facilities, physical education schools or centers, martial arts schools, or exercise schools or centers, or schools, colleges, universities, trade schools, tutors, and/or instructors, who or which provides instruction, classes, courses, or training, of any type or kind, and/or who or which utilizes the apparatus 100 and method of the present invention, each entity associated with, or operator of, each healthcare records computer 40 who or which utilizes the apparatus 100 and method of the present invention, each entity associated with, or operator of, each instructional/educational records computer 50 who or which utilizes the apparatus 100 and method of the present invention, each media provider, media source, information provider, information source, who or which utilizes the apparatus 100 of the present invention, or each entity associated with, or operator of, each media computer 60, and/or each social networking company or entity, or social network, who or which utilizes the apparatus 100 and method of the present invention, and/or each entity associated with, or operator of, each social networking computer 60 who or which utilizes the apparatus 100 and method of the present invention.

In the preferred embodiment, the database 10H can also contain and/or include healthcare records, healthcare histories, and/or healthcare files, and/or instructional records, instructional transcripts, educational records, and/or educational transcripts, of, for, or regarding, any of the users or individuals who or which utilize the apparatus 100 of the present invention, and/or of, for, or regarding, any of the herein-described individuals, instructional facilities, educational facilities, training facilities, gyms, health clubs, country clubs, fitness centers, wellness centers, athletic training centers or facilities, physical education schools or centers, martial arts schools, or exercise schools or centers, or schools, colleges, universities, trade schools, tutors, and/or instructors, who or which provides instruction, classes, courses, or training, of any type or kind, and/or who or which utilizes the apparatus 100 and method of the present invention, any entity associated with, or operator of, each healthcare records computer 40 who or which utilizes the apparatus 100 and method of the present invention, and/or each entity associated with, or operator of, each instructional/educational records computer 50 who or which utilizes the apparatus 100 and method of the present invention.

In the preferred embodiment, the database 10H can also contain and/or include any and/or all data and/or information regarding any of the media providers, media sources, information providers, and/or information sources, who or which utilizes the apparatus 100 of the present invention, or each entity associated with, or operator of, each media computer 60, and/or each social networking company or entity, or social network, who or which utilizes the apparatus 100 and method of the present invention, and/or each entity associated with, or operator of, each social networking computer 60 who or which utilizes the apparatus 100 and method of the present invention.

In the preferred embodiment, the database 10H also contains and/or includes, for each user or individual, for each individual, instructional facility, educational facility, training facility, gym, health club, country club, fitness center, wellness center, athletic training center or facility, physical education school or center, martial arts school, or exercise school or center, or school, college, university, trade school, tutor, and/or instructor, for each entity associated with, or operator of, each healthcare records computer 40, for each entity associated with, or operator of, each instructional/educational records computer 50, for each media provider, media source, information provider, information source, or each entity associated with, or operator of, each media computer 60, and/or for each social networking company or entity, or social network, or each entity associated with, or operator of, each social networking computer 60, information regarding the, name, address, telephone number (s), cellular telephone number(s), mobile or wireless telephone number(s), e-mail address or e-mail addresses, and/or text message, instant message, SMS message, or MMS message, or any other messaging, telephone number or other address or identifier, website(s), domain name, and/or IP address(es), of or for same.

The database 10H can also contain and/or include, for each user or individual who or which utilizes the apparatus 100, data and/or information regarding, and/or a link(s) and/or hyperlink(s) to, the each of the user's or the individual's instructional records, instructional records accounts, educational records, and/or educational records accounts, which can contain and/or include data and/or information regarding the user's or the individual's instructional, educational, fitness, exercise, martial arts, sports, or athletics or any other physical, activities and records, as well as data and/or information regarding the user's or the individual's instructional, educational, and/or academic, records.

The database 10H can also contain and/or include, for each user or individual who or which utilizes the apparatus 100, data and/or information regarding each school, or educational or instructional institution in, at, or with, which, the individual or user has been enrolled or is enrolled, and/or has taken, has engaged in, is engaging in, or has completed, any classes, courses, seminars, information regarding the user's or the individual's date(s) or attendance, data and information regarding the classes or courses taken by the user or the individual, class attendance, course description, course schedule, course dates and times, any grades earned, diploma(s) earned, degree(s) earned, certificate(s) earned, information regarding any teachers, instructors, professors, or advisors, had by the user or the individual, and/or any information regarding the user or the individual that would be recorded in the user's or the individual's student academic or educational record(s) and/or transcript(s). The database 10H can also contain and/or include, for each school, or educational or instructional institution, information regarding the name, address, or location of same, information regarding and/or a link or hyperlink to a website of or associated with same, and/or any information regarding any and/or all offerings, classes, courses, seminars, programs, diploma programs, degree programs, certificate programs, or continuing education programs, and/or any instructional and/or training activities, provided by same and the schedules of same, and/or any information regarding any teachers, instructors, professors, and/or any tutors, teaching assistants of or associated with the school, or educational or instructional institution.

The database 10H can also include video clips, audio clips, video information and/or audio information, of or regarding any activities or performances of the user or the individual, such as performance in class or in a course or seminar, video clips, audio clips, video information and/or audio information, of or regarding any reports, presentations, work products, projects, reviews by other students or by instructors, and/or any other information regarding the user's or the individual's performance during a class, course, or seminar.

The video clips, audio clips, video information and/or audio information, of or regarding any activities or performances of the user or the individual, can be stored in, or linked or hyperlinked with, the user's or the individual's academic or educational record(s) and/or transcript(s). In this regard, the apparatus 100 of the present invention provides academic or educational record(s) and/or transcript(s) which can contain video information, audio information, video clips, and/or audio clips, of or regarding the user or the individual, or of or regarding the user's or the individual's performances or accomplishments, thereby providing for multimedia academic or educational record(s) and/or transcript(s).

The database 10H can also contain and/or include, for each user or individual who or which utilizes the apparatus 100, data and/or information regarding each gym, health club, country club, exercise facility, fitness facility, fitness center, or martial arts school, or martial arts center or academy, in which the user or the individual is or was a member, or belongs to or has belonged to, or takes classes or courses and/or has otherwise engaged in exercise or fitness activities, programs, or classes, or martial arts training. For each individual, gym, health club, country club, exercise facility, fitness facility, fitness center, or martial arts school, or martial arts center or academy, the database 10H can contain and/or include information regarding the name, address, or location of same, information regarding and/or a link or hyperlink to a website of or associated with same, and/or any information regarding any and/or all offerings, classes, courses, seminars, or training activities, provided by same and the schedules of same, and/or any information regarding any instructors or trainers of or associated with the individual, gym, health club, country club, exercise facility, fitness facility, fitness center, or martial arts school, or martial arts center or academy. The database 10H can also contain and/or include, for each user or individual who or which utilizes the apparatus 100, data and/or information regarding each user's or individual's membership date(s), time of membership, type of membership, data and/or information regarding the exercise or fitness activities, programs, or classes or courses, or martial arts classes or training, in which the user or the individual enrolled or is enrolled, and/or has taken, has engaged in, is engaging in, or has completed, any classes, courses, seminars, information regarding the user's or the individual's date(s) of member and/or attendance, data and information regarding the classes, courses, or seminars, taken by the user or the individual, class attendance, course description, course schedule, course dates and times, any grades earned, diploma(s) earned, belts, awards, or degree(s) earned, certificate(s) earned, information regarding any teachers, instructors, trainers, or advisors, had by the user or the individual, and/or any information regarding the user or the individual that would be recorded in the user's or the individual's fitness, exercise, martial arts, sports, or athletics or any other physical, activities, record(s) or transcript(s).

The database 10H can also contain and/or include, for each user or individual who or which utilizes the apparatus 100, data and/or information regarding each the user's or the individual's student academic or educational record(s) and/or transcript(s) and/or the user's or the individual's fitness, exercise, martial arts, sports, or athletics or any other physical, activities, record(s) and/or transcript(s). The database 10H can also contain and/or include, for each user or individual who or which utilizes the apparatus 100, the user's or the individual's student academic or educational record(s) and/or transcript(s) and/or the user's or the individual's fitness, exercise, martial arts, sports, or athletics or any other physical, activities, record(s) and/or transcript(s).

The database 10H can also contain and/or include, for each user or individual who or which utilizes the apparatus 100, a universal transcript or a universal record containing any data and/or information regarding the user's or the individual's lifetime or combined or cumulative student academic or educational record(s) and/or transcript(s) and/or fitness, exercise, martial arts, sports, or athletics or any other physical, activities, record(s) and/or transcript(s), for any and/or all schools or educational or instructional institutions attended by the user or the individual, or being attended by the user or the individual, and/or for any and/or all gyms, health clubs, country clubs, exercise facilities, fitness facilities, fitness centers, or martial arts schools, or martial arts centers or academies, in which the user or the individual is or was a member, or belongs to or has belonged to, or taken classes or courses and/or has otherwise engaged in exercise or fitness activities, programs, or classes, or martial arts training.

The database 10H can also contain and/or include, for each user or individual who or which utilizes the apparatus 100, data and/or information regarding the user's or the individual's class schedules, course schedules, or seminar schedules, for any courses, classes, or seminars, enrolled in by the user or the individual, at any and/or schools or educational or instructional institutions attended by the user or the individual, or being attended by the user or the individual, and/or the user's or the individual's class schedules, course schedules, or seminar schedules, for any courses, classes, or seminars, for any and/or all of the gyms, health clubs, country clubs, exercise facilities, fitness facilities, fitness centers, or martial arts schools, or martial arts centers or academies, in which the user or the individual is a member or belongs.

The database 10H can also contain and/or include, for each user or individual who or which utilizes the apparatus 100, data and/or information regarding any searches for or regarding, any requests for alerts, or any requests for notification messages, for or regarding any classes, courses, or seminars, offered by any selected or other schools or educational or instructional institutions, or by any gyms, health clubs, country clubs, exercise facilities, fitness facilities, fitness centers, or martial arts schools, or martial arts centers or academies, which utilize the apparatus 100 and method of the present invention or with which the apparatus 100 and method of the present invention can be utilized.

The database 10H can also contain and/or include, for each user or individual who or which utilizes the apparatus 100, data and/or information regarding, and/or a link or a hyperlink to, the user's or the individual's healthcare record, personal healthcare record, or electronic healthcare record, as well as data and/or information regarding, and/or a link or a hyperlink to, the user's or the individual's instructional/education record.

The database 10H can also contain and/or include, for each user or individual who or which utilizes the apparatus 100, data and/or information regarding, and/or a link or a hyperlink to, the user's or the individual's media subscriptions and/or any media computers 60 of any media provider(s) or information provider(s) with whom or which the user or the individual subscribes to or from whom or which the user or the individual obtains media or information.

The database 10H can also contain and/or include, for each user or individual who or which utilizes the apparatus 100, data and/or information regarding, and/or a link or a hyperlink to, the user's or the individual's social networking websites or any social networking computers 70 of any social networking site or social network to which the user or the individual is a member or belongs. The database 10H can also contain and/or include, for each user or individual who or which utilizes the apparatus 100, data and/or information regarding, and/or a link or a hyperlink to, any information regarding any friends, classmates, study group partners, teammates, students, exercise partners, workout partners, or any other users or individuals with whom the user of the individual might have a relationship with in utilizing the apparatus 100 and method of the present invention.

The database 10H can also contain and/or include, for each individual, instructional facility, educational facility, training facility, gym, health club, country club, fitness center, wellness center, athletic training center or facility, physical education school or center, martial arts school, or exercise school or center, or school, college, university, trade school, tutor, and/or instructor, who or which provides instruction, classes, courses, or training, of any type or kind, associated with or who or which utilizes the apparatus 100, the name and address of same, the phone numbers, e-mail addresses, or other contact information, for same, the website(s) for same, the programs offered by same, the classes or courses offered by same, the programs, diploma programs, degree programs, certificate programs, continuing education programs, or the curriculums, offered by same, schedule of classes for same, and/or class schedules, and/or times and days of classes for same.

The database 10H can also contain and/or include, for each individual, instructional facility, educational facility, training facility, gym, health club, country club, fitness center, wellness center, athletic training center or facility, physical education school or center, martial arts school, or exercise school or center, or school, college, university, trade school, tutor, and/or instructor, the names of the respective students or members of the individual, instructional facility, educational facility, training facility, gym, health club, country club, fitness center, wellness center, athletic training center or facility, physical education school or center, martial arts school, or exercise school or center, or school, college, university, trade school, tutor, and/or instructor, attendance records for each student or member, the instructors or teachers for the student or member, any classes, courses, or seminars, in which the student or member is enrolled or is taking, and/or any attendance records for any student or member. The database 10H can also contain and/or include an instructional record or transcript for each student or member containing information regarding dates of enrollment or membership, grades achieved or levels achieved, and any diploma(s), degree(s), or certificate(s), or ranks or levels, earned or achieved by the student or member.

The database 10H can also contain and/or include, for each individual, instructional facility, educational facility, training facility, gym, health club, country club, fitness center, wellness center, athletic training center or facility, physical education school or center, martial arts school, or exercise school or center, or school, college, university, trade school, tutor, and/or instructor, information regarding the courses or instructors of the instructional facility, educational facility, training facility, gym, health club, country club, fitness center, wellness center, athletic training center or facility, physical education school or center, martial arts school, or exercise school or center, or school, college, university, and/or trade school.

The database 10H can also contain and/or include, for each individual, instructional facility, educational facility, training facility, gym, health club, country club, fitness center, wellness center, athletic training center or facility, physical education school or center, martial arts school, or exercise school or center, or school, college, university, trade school, tutor, and/or instructor, information regarding any affiliations with any other, individuals, instructional facilities, educational facilities, training facilities, gyms, health clubs, country clubs, fitness centers, wellness centers, athletic training centers or facilities, physical education schools or centers, martial arts schools, or exercise schools or centers, or schools, colleges, universities, trade schools, tutors, and/or instructors, such as those affiliates who or which will agree to accept credits for courses offered by the individual, instructional facility, educational facility, training facility, gym, health club, country club, fitness center, wellness center, athletic training center or facility, physical education school or center, martial arts school, or exercise school or center, or school, college, university, trade school, tutor, and/or instructor, or who or which will agree to share facilities and/or teachers or instructors with the individual, instructional facility, educational facility, training facility, gym, health club, country club, fitness center, wellness center, athletic training center or facility, physical education school or center, martial arts school, or exercise school or center, or school, college, university, trade school, tutor, and/or instructor, and/or who or which agrees to operate in any cooperative manner with the individual, instructional facility, educational facility, training facility, gym, health club, country club, fitness center, wellness center, athletic training center or facility, physical education school or center, martial arts school, or exercise school or center, or school, college, university, trade school, tutor, and/or instructor.

The database 10H can also contain and/or include, for each individual, instructional facility, educational facility, training facility, gym, health club, country club, fitness center, wellness center, athletic training center or facility, physical education school or center, martial arts school, or exercise school or center, or school, college, university, trade school, tutor, and/or instructor, information regarding the class, course, or seminar, offering, the schedules for same, stored classes or stored lectures for same, schedules of or for live classes, lectures, or seminars, for same, and/or schedules of or for recorded classes, lectures, or seminars, for same, and/or any schedules of live and/or recorded classes, lectures, or seminars, of any affiliates of the individual, instructional facility, educational facility, training facility, gym, health club, country club, fitness center, wellness center, athletic training center or facility, physical education school or center, martial arts school, or exercise school or center, or school, college, university, trade school, tutor, and/or instructor.

The database 10H can also contain and/or include any and/or all of the healthcare records, healthcare files, and/or healthcare histories, and/or any other healthcare information or healthcare-related information, for any and/or all of the users or individuals described herein who utilize the apparatus 100 of the present invention. The database 10H can also serve as a centralized healthcare database for all of the users or individuals who or which utilize the apparatus 100 of the present invention.

In the preferred embodiment, the database 10H can also contain and/or include, for each user or individual, information regarding his or her name, address, telephone number(s), cellular telephone number(s), e-mail address(es), text messaging, SMS messaging, or MMS messaging, phone number(s), social security number, identifying information, the doctor(s), dentist(s), or any other healthcare provider(s), of the user or the individual, and any information regarding the user's or the individual's parent(s) or caregiver(s), including, but not limited to, the parent's name or caregiver's name, address, telephone number(s), cellular telephone number(s), e-mail address(es), text messaging, SMS messaging, or MMS messaging, phone number(s).

The database 10H can also contain and/or include, for each user or individual, the user's or individual's healthcare records, healthcare files, or healthcare histories, including, but not limited to, the user's or the individual's doctors, dentists, or other healthcare providers, and their respective names, addresses, telephone number(s), cellular telephone number(s), e-mail address(es), text messaging, SMS messaging, or MMS messaging, phone number(s), social security number, or other identifying information.

The database 10H can also contain and/or include, for each user or individual, the user's or individual's healthcare records, healthcare files, or healthcare histories, including, but not limited to, any and/or all provider visits, dates of same as well as information regarding any examinations or procedures performed, tests performed, examination findings obtained, symptoms identified, diagnoses made, treatments prescribed of suggested, treatment plans prescribed, and/or any diagnostic reports and/or treatment reports or treatment plans generated pursuant to, or as the result of, the provider visit. The database 10H can also contain and/or include family history information as well as any other data and/or information typically included in a user's or individual's healthcare record or electronic healthcare record.

The database 10H can also contain and/or include, for each user or individual, any information regarding any insurance claims generated or filed by, for, or on behalf of, the user or the individual. The database 10H can also contain and/or include any data and/or information contained in, or a link or a hyperlink to, any instructional/educational record of or for the user or the individual.

The database 10H can also contain and/or include, for each user or individual who utilizes the apparatus 100 and method of the present invention, a comprehensive instructional record(s) and/or educational records(s), which can include any and/or all of the data and/or information described herein as being stored in each and every instructional facility communication device 30 of or associated with each individual, instructional facility, educational facility, training facility, gym, health club, country club, fitness center, wellness center, athletic training center or facility, physical education school or center, martial arts school, or exercise school or center, or school, college, university, trade school, tutor, and/or instructor, which the user or the individual has respectively been a student of, has attended, has been enrolled in, or has been a member of, or is currently a student of, is currently attending, is currently enrolled in, or is a currently a member.

The database 10H can serve as a centralized instructional records and/or educational records database for all of the users or individuals who or which utilize the apparatus 100 of the present invention. In a preferred embodiment, the instructional record(s) and/or educational records(s), which are stored in the database 10H for each user or individual, can be comprehensive in nature and contain and/or include the instructional record(s) and/or educational records(s), from any and/or all of individuals, instructional facilities, educational facilities, training facilities, gyms, health clubs, country clubs, fitness centers, wellness centers, athletic training centers or facilities, physical education schools or centers, martial arts schools, or exercise schools or centers, or schools, colleges, universities, trade schools, tutors, and/or instructors, which the user or the individual has respectively been a student of, has attended, has been enrolled in, or has been a member of, or is currently a student of, is currently attending, is currently enrolled in, or is a currently a member.

In the preferred embodiment, the database 10H can also contain and/or include, for each user or individual, information regarding his or her name, address, telephone number(s), cellular telephone number(s), e-mail address(es), text messaging, SMS messaging, or MMS messaging, phone number(s), social security number, identifying information, the individuals, instructional facilities, educational facilities, training facilities, gyms, health clubs, country clubs, fitness centers, wellness centers, athletic training centers or facilities, physical education schools or centers, martial arts schools, or exercise schools or centers, or schools, colleges, universities, trade schools, tutors, and/or instructors, which the user or the individual has respectively been a student of, has attended, has been enrolled in, or has been a member of, or is currently a student of, is currently attending, is currently enrolled in, or is a currently a member, and any information regarding same, including, but not limited to, each respective individual's, instructional facility's, educational facility's′, training facility's, gym's, fitness center's, wellness center's, athletic training center's or facility's, physical education school's or center's, martial arts school's, or exercise school's or center's, or school's, college's, university's, trade school's, tutor's, and/or instructor's, name, address, website(s), domain name(s), IP address(es), telephone number(s), cellular telephone number(s), e-mail address(es), text messaging, SMS messaging, or MMS messaging, phone number(s).

In the preferred embodiment, the database 10H can also contain and/or include, for each user or individual, and for each individual, instructional facility, educational facility, training facility, gym, health club, country club, fitness center, wellness center, athletic training center or facility, physical education school or center, martial arts school, or exercise school or center, or school, college, university, trade school, tutor, and/or instructor, which the user or the individual has respectively been a student of, has attended, has been enrolled in, or has been a member of, or is currently a student of, is currently attending, is currently enrolled in, or is a currently a member, an instructional record and/or an educational record for the user or the individual with or at that individual, and for each individual, instructional facility, educational facility, training facility, gym, health club, country club, fitness center, wellness center, athletic training center or facility, physical education school or center, martial arts school, or exercise school or center, or school, college, university, trade school, tutor, and/or instructor.

The database 10H can also contain and/or include, for each user or individual, and for each individual, instructional facility, educational facility, training facility, gym, health club, country club, fitness center, wellness center, athletic training center or facility, physical education school or center, martial arts school, or exercise school or center, or school, college, university, trade school, tutor, and/or instructor, which the user or the individual has respectively been a student of, has attended, has been enrolled in, or has been a member of, or is currently a student of, is currently attending, is currently enrolled in, or is a currently a member, the name and address of same, the phone numbers, e-mail addresses, or other contact information, for same, the website(s) for same, the programs offered by same, the classes or courses offered by same, the programs, diploma programs, degree programs, certificate programs, continuing education programs, or the curriculums, offered by same, schedule of classes for same, and/or class schedules, and/or times and days of classes for same.

The database 10H can also contain and/or include, for each individual, instructional facility, educational facility, training facility, gym, health club, country club, fitness center, wellness center, athletic training center or facility, physical education school or center, martial arts school, or exercise school or center, or school, college, university, trade school, tutor, and/or instructor, the names of the respective students or members of the individual, instructional facility, educational facility, training facility, gym, health club, country club, fitness center, wellness center, athletic training center or facility, physical education school or center, martial arts school, or exercise school or center, or school, college, university, trade school, tutor, and/or instructor, the attendance records for each student or member, the instructors or teachers for the student or member, any classes, courses, or seminars, in which the student or member is enrolled or is taking, and/or any attendance records for any student or member. The database 10H can also contain and/or include, for each individual, instructional facility, educational facility, training facility, gym, health club, country club, fitness center, wellness center, athletic training center or facility, physical education school or center, martial arts school, or exercise school or center, or school, college, university, trade school, tutor, and/or instructor, an instructional record or transcript and/or an educational record or transcript for each student or member containing information regarding dates of enrollment or membership, grades achieved or levels achieved, and any diploma(s), degree(s), or certificate(s), or ranks or levels, earned or achieved by the student or member.

The database 10H can also contain and/or include, for each individual, instructional facility, educational facility, training facility, gym, health club, country club, fitness center, wellness center, athletic training center or facility, physical education school or center, martial arts school, or exercise school or center, or school, college, university, trade school, tutor, and/or instructor, information regarding the courses or instructors of the individual, instructional facility, educational facility, training facility, gym, health club, country club, fitness center, wellness center, athletic training center or facility, physical education school or center, martial arts school, or exercise school or center, or school, college, university, and/or trade school.

The database 10H can also contain and/or include, for each individual, instructional facility, educational facility, training facility, gym, health club, country club, fitness center, wellness center, athletic training center or facility, physical education school or center, martial arts school, or exercise school or center, or school, college, university, trade school, tutor, and/or instructor, information regarding any affiliations with any other, individuals, instructional facilities, educational facilities, training facilities, gyms, health clubs, country clubs, fitness centers, wellness centers, athletic training centers or facilities, physical education schools or centers, martial arts schools, or exercise schools or centers, or schools, colleges, universities, trade schools, tutors, and/or instructors, such as those affiliates who or which will agree to accept credits for courses offered by the individual, instructional facility, educational facility, training facility, gym, health club, country club, fitness center, wellness center, athletic training center or facility, physical education school or center, martial arts school, or exercise school or center, or school, college, university, trade school, tutor, and/or instructor, or who or which will agree to share facilities and/or teachers or instructors with the individual, instructional facility, educational facility, training facility, gym, health club, country club, fitness center, wellness center, athletic training center or facility, physical education school or center, martial arts school, or exercise school or center, or school, college, university, trade school, tutor, and/or instructor, and/or who or which agrees to operate in any cooperative manner with the individual, instructional facility, educational facility, training facility, gym, health club, country club, fitness center, wellness center, athletic training center or facility, physical education school or center, martial arts school, or exercise school or center, or school, college, university, trade school, tutor, and/or instructor.

The database 10H can also contain and/or include, for each individual, instructional facility, educational facility, training facility, gym, health club, country club, fitness center, wellness center, athletic training center or facility, physical education school or center, martial arts school, or exercise school or center, or school, college, university, trade school, tutor, and/or instructor, information regarding the classes, courses, or seminars, offerings, and/or the schedules for same, stored classes or stored lectures for same, schedules of or for live classes, lectures, or seminars, for same, and/or schedules of or for recorded classes, lectures, or seminars, for same, and/or any schedules of live and/or recorded classes, lectures, or seminars, of any affiliates of the individual, instructional facility, educational facility, training facility, gym, health club, country club, fitness center, wellness center, athletic training center or facility, physical education school or center, martial arts school, or exercise school or center, or school, college, university, trade school, tutor, and/or instructor.

In a preferred embodiment, the database 10H can also contain and/or include any data and/or information regarding the users or individuals who utilize the apparatus 100 and method of the present invention, any of their respective instructional records and/or education records, any of their respective comprehensive instructional record(s) or educational record(s), and any and/or all of the data and/or information regarding the respective individuals, instructional facilities, educational facilities, training facilities, gyms, health clubs, country clubs, fitness centers, wellness centers, athletic training centers or facilities, physical education schools or centers, martial arts schools, or exercise schools or centers, or schools, colleges, universities, trade schools, tutors, and/or instructors, which the user or the individual has respectively been a student of, has attended, has been enrolled in, or has been a member of, or is currently a student of, is currently attending, is currently enrolled in, or is a currently a member.

The database 10H can contain and/or can be linked to any of the data and/or information typically found in or utilized by any of the media computers 60 used in conjunction with the apparatus 100 of the present invention as well as any of the respective media, news, information, advertisements, or marketing materials, and/or any data and/or information typically utilized in providing or performing the functionality and/or services described-herein as being provided or offered by the media computer 60.

The database 10H can also contain credit report data or information, a credit report, credit reports, or a credit history, for any users or individuals who utilize the apparatus 100 and method of the present invention. The credit report or credit reports, or credit history, can contain any of the information which is typically provided by, or which may be provided by, any commercial or other credit reporting company or agency, such as, for example, but not limited to, credit reporting companies such as TransUnion LLC, Experian Information Solutions, Inc., Equifax, Inc., or any other credit reporting company, agency, or bureau, or any credit card company or financial institution. The database 10H can also contain any data or information which is typically found in a credit report database or credit history database, and/or any data and/or information which is, or which can be, utilized in generating, and/or analyzing, a credit report or credit reports, or a credit history, for, or on behalf of, any user or individuals who utilize the apparatus 100 and method of the present invention. The database 10H can also contain e-mail contact information, telephone contact information, cellular telephone contact information, and/or any other suitable contact information, for a user or individual which can be utilized to notify the user or the individual when information regarding his or her credit report or credit reports, or credit history, is accessed, obtained, changed, or when a new entry of information is made in same.

The database 10H can also include advertisements, advertisement materials and information, marketing materials or information, commercials, video clips, infomercials, and any other information, which can include text information. video information, audio information, or any combination of same, which can be used to provide an advertisement, or advertisement material or information, to or for any user or individual, or any individual, instructional facility, educational facility, training facility, gym, health club, country club, fitness center, wellness center, athletic training center or facility, physical education school or center, martial arts school, or exercise school or center, or school, college, university, trade school, tutor, and/or instructor, who or which utilizes the apparatus 100 and method of the present invention. A respective advertisement, advertisement material and information, marketing material or information, commercial, video clips, infomercials, and/or any other information, can be used to advertise or market any product(s) or service(s) which can be used by, provided to, provided by, advertised to, advertised by, marketed to, or marketed by, any user or individual, or any individual, instructional facility, educational facility, training facility, gym, health club, country club, fitness center, wellness center, athletic training center or facility, physical education school or center, martial arts school, or exercise school or center, or school, college, university, trade school, tutor, and/or instructor, who or which utilizes the apparatus 100 and method of the present invention.

The database 10H can also contain and/or include news information, news reports, published reports, theses, study reports, programs, television programs, video information, and/or audio information, or any other data or information regarding any instructional, educational, academic, scholastic, health, fitness, wellness, exercise, martial arts, sports, or athletics, or any healthcare, therapeutic, or other, information, issues, news, news reports, published papers, white papers, magazine articles, television shows or programs, radio programs, Internet or World Wide Web broadcasts or programs, video clips, audio clips, videos, or any other media or information which can be provided to any user or individual, or any individual, instructional facility, educational facility, training facility, gym, health club, country club, fitness center, wellness center, athletic training center or facility, physical education school or center, martial arts school, or exercise school or center, or school, college, university, trade school, tutor, and/or instructor, who or which utilizes the apparatus 100 and method of the present invention. The news information, news reports, published reports, theses, study reports, or any other data or information can include text information, video information, audio information, or any combination of same.

The news information, news reports, published reports, theses, study reports, or any other data or information, stored in the database 10H, can be transmitted to, or fed to, the central processing computer 10, for storage in the database 10H, by or from any appropriate computer or communication device, which is associated with or used by any news source, news organization, research institution, research professional, healthcare facility, author, researcher, academician, or any user or individual, or any individual, instructional facility, educational facility, training facility, gym, health club, country club, fitness center, wellness center, athletic training center or facility, physical education school or center, martial arts school, or exercise school or center, or school, college, university, trade school, tutor, and/or instructor. The database 10H can also contain prescription drugs information, prescription medication information, over-the-counter drug or medication information, wellness information, exercise and fitness information, and/or any other information pertinent to an individual's or a patient's heath, well-being, or treatment.

The database 10H can also include language translation information or software so that any of the data or information described herein as being stored in the database 10H, or as being provided in any of the messages, reports, or other communications, described herein can be translated into any language.

The database 10H can also contain any notes, comments, or messages, which can be provided in text, in audio recordings or audio clips, and/or in video recordings or video clips. The database 10H can also contain any data, information, and/or software programs for translating audio information to text information and for translating test information to audio information. The database 10H can also contain any data, information, and/or software programs for translating text information or audio information from one language to another so as to provide a multi-lingual healthcare information and records keeping system. The database 10H can also contain any notes, comments, or messages, which can be provided by any of the herein-described users or individuals, or any individuals, instructional facilities, educational facilities, training facilities, gyms, health clubs, country clubs, fitness centers, wellness centers, athletic training centers or facilities, physical education schools or centers, martial arts schools, or exercise schools or centers, or schools, colleges, universities, trade schools, tutors, and/or instructors, who or which utilizes the apparatus 100 and method of the present invention.

The database 10H can also contain any notes, comments, or messages, which can be stored in any and/or all of the instructional records, instructional transcripts, educational records, or education transcripts described herein, or in any of the healthcare records, healthcare histories, or healthcare files described herein as being utilized in connection with the apparatus 100 and method of the present invention. In this regard, it is important to note that, in a preferred embodiment of the present invention, any and/or all of the instructional records, instructional transcripts, educational records, or education transcripts described herein, or in any of the healthcare records, healthcare histories, or healthcare files described herein, described herein as being utilized in connection with the apparatus 100 are or can be designed to receive, store, and/or provide, any notes, comments, and/or messages, provided by any of the herein-described users or individuals, or any individuals, instructional facilities, educational facilities, training facilities, gyms, health clubs, country clubs, fitness centers, wellness centers, athletic training centers or facilities, physical education schools or centers, martial arts schools, or exercise schools or centers, or schools, colleges, universities, trade schools, tutors, and/or instructors, and/or any other person or entity, as text information or in text form, as audio information or in audio form, or as video information or in video form. Any text or audio information can be translated to from text to audio or from audio to text, and any text or audio information can be translated from one language to any one of more of any other language.

The database 10H can also contain or include instructional records and/or educational records, as well as sports medicine-related data and/of information for and/or including healthcare records, histories, or files, of and for athletes or sports participants of any age and in or for any sport or athletic activity. The database 10H can also contain data and/or information regarding instructional records and/or educational records and/or healthcare records, histories, and/or files, for any athletes or sport participants and their respective organizations, teams, clubs, leagues, or other entities. The database 10H can also contain data and/or information for creating and for maintaining a comprehensive and/or centralized instructional records and/or educational records and/or healthcare records, histories, and/or files, system for athletes or participants of any sport or sports or any activity or activities, athletes or sports participants of any age, professional athletes, minor league athletes, Olympic athletes, competitive athletes, government team athletes, world class competition athletes, amateur athletes, college athletes, high school age athletes, children athletes, secondary school athletes, recreational organization athletes or members, child recreational organization athletes or members, adult recreational organization athletes or members, little league athletes or members, boys club athletes or members, girls club athletes or members, hobbyist athletes, or any other individuals, male or female, who participate in athletic endeavors, sporting events, exercise activities or programs, the martial arts, mixed martial arts, Krav Maga, Karate, Judo, Jujitsu, and any types or kinds of martial arts, boxing and other fighting or combat sports, any and/or all team sports, including but not limited to baseball, football, basketball, hockey, soccer, lacrosse, track and field, gymnastics, car racing, skiing and winter sports, swimming and aquatic sports, weightlifting, dancing, and/or any other sports or sporting activities, and/or other physical activities, or any team sporting activities or individual sporting activities.

The database 10H can also contain and/or include data and/or information regarding any organization, governmental entity, business, team, league, club, network, or any other entity, which oversees, manages, uses, employs, provides oversight over, owns or otherwise has playing or managing rights over, provides control over, or provides or is responsible for the instruction, education, fitness, wellness, and/or healthcare, of any of the herein-described or other athletes or sports participants.

The database 10H can also contain and/or include data and/or information for or regarding sports-related injuries or athletic related injuries, or conditions, or other healthcare information relating to sports-related injuries, athletic injuries, sport-related conditions, and/or athletics-related conditions. The database 10H can also contain and/or include data and/or information for diagnosing, treating, treatment planning, curing, rehabilitating, and/or for performing therapy or therapies for, sports-related injuries or conditions or athletic-related injuries or conditions. The database 10H can also contain and/or include information regarding diagnoses, treatments, treatment plans, procedures, corrective procedures or surgical procedures, cures, rehabilitation, therapies, physical therapies, exercise therapies, drug or medicinal therapies, diets, nutritional therapies, alternate medicine therapies, herbal therapies, and/or any other information which can or which may be utilized or needed for monitoring and/or managing the health and well-being of athletes or sports participants.

The database 10H can also contain and/or include data, information, or algorithms, for devising and planning treatments, treatment plans, procedures, operations, rehabilitation programs, plans, or regimens, physical therapy programs, plans, or regimens, occupational therapy programs, plans, or regimens, exercise programs, plans, or regimens, massage therapy programs, plans, or regimes, and/or any other programs, plans, or regimens for treating, curing, or otherwise dealing with, a sports-related injury or diagnosis.

The database 10H can also contain and/or include data and/or information regarding, for identifying or locating, healthcare providers, doctors, specialists, dentists, dental specialists, psychiatrists, psychologists, chiropractors, podiatrists, optometrists, or any other providers, hospitals, treatments facilities, therapists, nurses, physical therapists, massage therapists, occupational therapists, trainers, and/or any other providers or care givers, and/or testing laboratories, who or which can provide services for any other athletes and/or sports participants who may or which my utilize or be serviced by the apparatus 100 and method of the present invention, or any of their respective organizations, teams, clubs, or other entities.

The database 10H can also contain information, text information, audio, audio information or audio clips, video, video information, video clips, audio and video information, audio and video clips, news story, television programs, and/or information in any other form or type regarding fitness, fitness exercises, exercises, fitness routines, fitness regimens, wellness, wellness exercises, wellness routines, wellness regimens, diets, diet exercises, diet or dieting routines, diet ort dieting regimens, training, training principals, training exercises, training routines, training regimens, nutrition, health and well being, meditation and any other information.

The database 10H can also contain statistical and/or other probabilistic and/or mathematical information for assigning and/or correlating certain levels and/or estimates for any and/or all of the information, diagnoses, prognoses, treatments, procedures, and/or any other information processed and/or generated by the central processing computer 10 and/or the apparatus 100.

The database 10H, in the preferred embodiment, can be a database which may include individual databases or collections of databases, with each database being designated to store any and all of the data and/or information described herein. The database 10H, or collection of databases, may also be updated by any of the users or individuals, or any individuals, instructional facilities, educational facilities, training facilities, gyms, health clubs, country clubs, fitness centers, wellness centers, athletic training centers or facilities, physical education schools or centers, martial arts schools, or exercise schools or centers, or schools, colleges, universities, trade schools, tutors, and/or instructors, who or which utilize the apparatus 100 and method of the present invention and/or by any other third party, in real-time, and/or via dynamically linked database management techniques.

The data and/or information stored in the database 10H can also be updated by and/or dynamically linked to, various external sources, including but not limited to news services, research publications, research facilities, healthcare laboratories, providers of any instructional, educational, academic, exercise, fitness, wellness, and/or healthcare, goods and/or services,

The database 10H can also contain any information or software, or rules algorithms, which can be used in generating insurance claim forms which can be submitted error-free to any of the insurers or payers described herein.

The database 10H can also contain any other data and/or information, including software for performing any and all of the operations, routines, processing routines, and other functions and/or functionality, described herein as being capable of being performed by the apparatus 100, and/or the central processing computer(s) 10 and/or by any of the herein-described user communication device(s) 20, instructional facility communication device (s) 30, healthcare records computer(s) 40, instructional/educational records computer(s) 50, media computer(s) 60, and/or social networking computer(s) 70.

The database 10H can also contain any data and/or information, as well as any links or hyperlinks to any of the herein-described user communication device(s) 20, instructional facility communication device (s) 30, healthcare records computer(s) 40, instructional/educational records computer(s) 50, media computer(s) 60, and/or social networking computer(s) 70, described herein as being used in connection with the present invention, and/or can contain data and/or information and/or links or hyperlinks to any data and/or information located or stored on, at, or in any of the user communication device(s) 20, instructional facility communication device (s) 30, healthcare records computer(s) 40, instructional/educational records computer(s) 50, media computer(s) 60, and/or social networking computer(s) 70, described herein.

The database 10H can also contain information, links and/or hyperlinks, to any media sources, media providers, information sources, or information providers, and/or to any social networking web sites, social networks, web pages, support groups, on-line forums, on-link information services, as well as social networking web sites or social networking web pages to or for social networking members, support groups, information providers, instructors, tutors, trainers, healthcare providers, as well as to any user or individual, or to any individual, instructional facility, educational facility, training facility, gym, health club, country club, fitness center, wellness center, athletic training center or facility, physical education school or center, martial arts school, or exercise school or center, or school, college, university, trade school, tutor, and/or instructor, or any other persons or entities described herein.

In any and/or all of the embodiments described herein, any of the data and/or information which is or which may be stored in the database 10H, and/or any of the other databases described herein, can be utilized and/or can appear in any of the reports, messages, claims, claim forms, evaluation reports, training reports, academic reports, report cards, alerts, alert messages, notification message, or any other information described herein as being generated by the apparatus 100 of the present invention.

The database 10H can also contain and/or include, for each user or individual who uses the apparatus 100, information regarding the user's or individual's instructional/educational record identification number. The database 10H can also contain and/or include, for each user or individual who uses the apparatus 100, information regarding any search criteria or alert or notification criteria of or associated with the user or individual. The database 10H can also contain and/or include, for each user or individual who uses the apparatus 100, information regarding the any alerts, alert messages, notifications, or notification messages, the subject matter or contents of same, and any information regarding any requests to receive same.

The database 10H can also contain and/or include, for each user or individual who uses the apparatus 100, any other data and/or information described being utilized, processed, generated by, or stored by, any of the herein-described central processing computers 10, user communication devices 20, instructional facility communication devices 30, healthcare records computers 40, instructional/educational records computers 50, media computers 60, and/or social networking computers 70.

In a preferred embodiment, the database 10H can also contain and/or include any software programs, software algorithms, and/or software applications (“apps”) deemed to be necessary, desirable, and/or useful, in utilizing the apparatus 100 and method of the present invention in the various embodiments described herein. In a preferred embodiment, the database 10H can also contain and/or include any other data and/or information deemed to be necessary, desirable, and/or useful, in utilizing the apparatus 100 and method of the present invention in the various embodiments described herein. The database 10H can also contain and/or include any other data and/or information which is or may be needed and/or desired in performing any and/or all of the features and/or functionality described herein as being provided by the apparatus 100 of the present invention and/or the central processing computer 10.

The database 10H can also contain and/or include any other data and/or information which is or may be needed and/or desired in performing any and/or all of the features and/or functionality described herein as being generated by, and/or provided by, the apparatus 100 of the present invention and/or described herein as being generated by, and/or provided by, the central processing computer 10 and/or any of the communication devices or computers 20, 30, 40, 50, 60, and/or 70.

The central processing computer 10 also includes an output device 10I for outputting any of the data, information, and/or reports, described herein as being generated by or via the central processing computer 10. In the preferred embodiment, the output device 10I can be a printer, a display, a transmitter, a modem, and/or any other device which can be used to output data or information of any kind or type.

The central processing computer 10 also includes also includes a video and/or audio recording device(s) 10J which can include a camera and/or a video recording device for recording pictures or video and/or video clips and/or a microphone or an audio recording device for recording audio or audio clips which can be recorded by, and/or transmitted live, by or from the central processing computer 10, or which can be recorded by, and stored at or in, the central processing computer 10 for transmission by or from the central processing computer 10 at a later time. The video and/or audio recording device(s) 10J can also be utilized to facilitate one-way broadcasts from the central processing computer 10, and/or can be utilized to facilitate video conferencing, video chatting, and/or audio conferencing, and/or video and audio conferencing, between users of the central processing computer 10 and any of the herein-described users, individuals, providers, or entities, who or which utilize the apparatus 100 and method of the present invention.

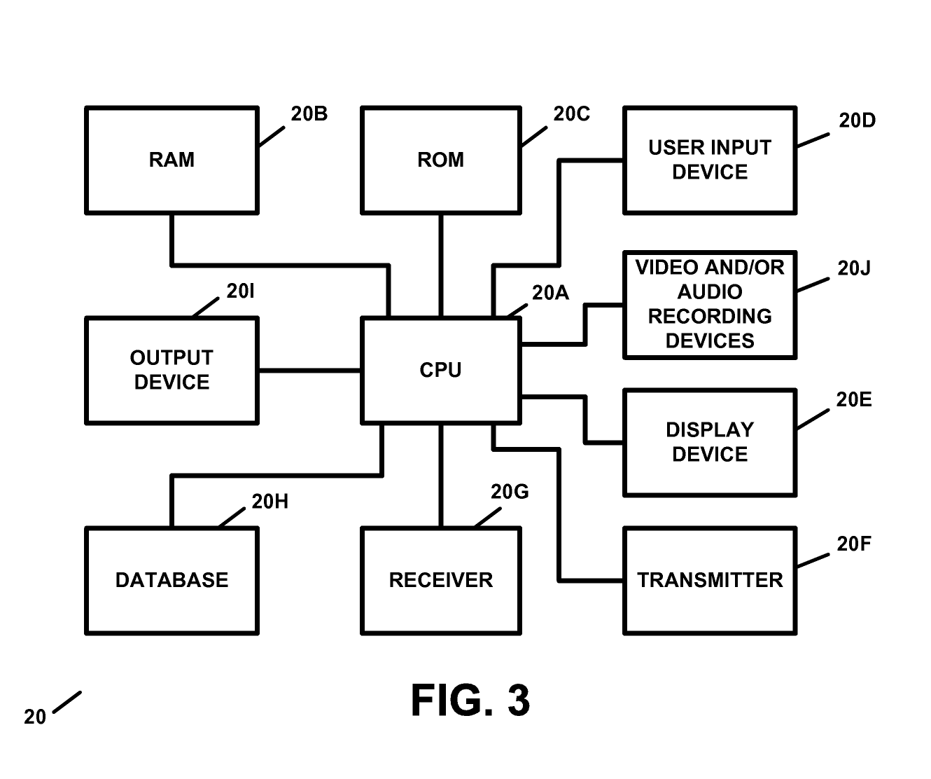

FIG. 3 illustrates the user communication device 20, in block diagram form. The user communication device 20, in the preferred embodiment, can be a personal computer, a home computer, a laptop computer, a notebook computer, a tablet computer, a tablet, a hand-held computer, a palmtop computer, a personal communication device, a cellular telephone, a wireless telephone, a mobile telephone, a Smart phone, a Smart phone or smartphone, a personal digital assistant, a digital television, an interactive television, a digital television, a telephone, a digital telephone, a television, an interactive television, a beeper, a pager, and/or a watch or a Smart watch, and/or any wearable device, computer or communication device. The user communication device 20 can also be a server computer, a network computer, or any other computer capable of being utilized in a network.

With reference to FIG. 3, in the preferred embodiment, the user communication device 20 includes a central processing unit or CPU 20A, which in the preferred embodiment, is a microprocessor. The CPU 20A may also be a microcomputer, a minicomputer, a macro-computer, and/or a mainframe computer, depending upon the application.

The user communication device 20 also includes a random access memory device(s) 20B (RAM), a read only memory device(s) 20C (ROM), each of which is connected to the CPU 20A, and a user input device 20D, for entering data or information and/or instructions and/or commands into the user communication device 20, which can include any one or more of a keyboard, a scanner, a user pointing device, such as, for example, a mouse, a touch pad, and/or an audio input device and/or a video input device, and/or any device, electronic and/or otherwise which can be utilized for inputting and/or entering data and/or information and/or instructions and/or commands into the user communication device 20. The input device(s) 20D is/are also connected to the CPU 20A.

The user input device 20D can also be utilized to acquire, receive, generate, and/or provide, data which can be entered by a user or individual and/or can be a device which can acquire, receive, generate and/or provide, digital data such as medical, healthcare, bio-metric, physiological, and/or any other type or kind of data and/or information. For example, a user input device 20D can be a keyboard for allowing a user to input information into the user communication device 20 and/or a user input device 20D can, for example, by a heart rate monitor which can receive information from a user, such as during periods of exercise, and which can generate a digital signal, digital data, analog data, and/or any other signal, data, and/or information, which is representative of the user's heart rate, pulse rate, and/or cardiac activity, which can be monitored during exercise or fitness activities.

The user input device 20D can also be, or can include, any one or more of, and/or any combination of, a thermometer, a digital thermometer, a stethoscope, a heart rate monitor or measurement device, a pulse rate monitor or measurement device, a blood pressure monitor or measurement device, a blood pressure measurement device, or any other bio-medical or bio-metric measurement device which can be utilized to obtain healthcare data and/or information about the user. The user communication device 20 also includes a display device 20E for displaying data and/or information to a user or operator.

The user communication device 20 also includes a transmitter(s) 20F, for transmitting signals and/or data and/or information to any one or more of the central processing computer(s) 10, the instructional facility communication device (s) 30, the healthcare records computer(s) 40, the instructional/educational records computer(s) 50, the media computer(s) 60, and/or the social networking computer(s) 70, and/or any other user communication device(s) 20, which may be utilized in conjunction with the present invention. The user communication device 20 also includes a receiver 20G, for receiving signals and/or data and/or information from any one or more of the central processing computer(s) 10, the instructional facility communication device (s) 30, the healthcare records computer(s) 40, the instructional/educational records computer(s) 50, the media computer(s) 60, and/or the social networking computer(s) 70, and/or any other user communication device(s) 20, which may be utilized in conjunction with the present invention.

The user communication device 20 also includes a database(s) 20H. The database 20H can contain and/or be linked to any of the data and/or information described herein as being stored in the database 10H.

The database 20H can contain and/or include data and/or information regarding the user or the individual, or any users or individuals, who or which utilize the user communication device, which can include, but which is not limited to, the user's or the individual's, or each user's or each individual's, name, address, telephone number (s), cellular telephone number(s), mobile or wireless telephone number(s), e-mail address or e-mail addresses, and/or text message, instant message, SMS message, or MMS message, or any other messaging, telephone number or other address or identifier.

The database 20H can also contain and/or include, for each user or individual who or which utilizes the user communication device 20, data and/or information regarding, and/or a link(s) and/or hyperlink(s) to, the each of the user's or the individual's instructional records, instructional records accounts, educational records, and/or educational records accounts, which can contain and/or include data and/or information regarding the user's or the individual's instructional, educational, fitness, exercise, martial arts, sports, or athletics or any other physical, activities and records, as well as data and/or information regarding the user's or the individual's instructional, educational, and/or academic, records.

The database 20H can also contain and/or include, for each user or individual who or which utilizes the user communication device 20, data and/or information regarding each school, or educational or instructional institution in, at, or with, which, the individual or user has been enrolled or is enrolled, and/or has taken, has engaged in, is engaging in, or has completed, any classes, courses, seminars, information regarding the user's or the individual's date(s) or attendance, data and information regarding the classes or courses taken by the user or the individual, class attendance, course description, course schedule, course dates and times, any grades earned, diploma(s) earned, degree(s) earned, certificate(s) earned, information regarding any teachers, instructors, professors, or advisors, had by the user or the individual, and/or any information regarding the user or the individual that would be recorded in the user's or the individual's student academic or educational record(s) and/or transcript(s). For each school, or educational or instructional institution, the database 20H can contain and/or include information regarding the name, address, or location of same, information regarding and/or a link or hyperlink to a website of or associated with same, and/or any information regarding any and/or all offerings, classes, courses, seminars, programs, diploma programs, degree programs, certificate programs, or continuing education programs, and/or any instructional and/or training activities, provided by same and the schedules of same, and/or any information regarding any teachers, instructors, professors, and/or any tutors, teaching assistants of or associated with the school, or educational or instructional institution.

The database 20H can also include video clips, audio clips, video information and/or audio information, of or regarding any activities or performances of the user or the individual, such as performance in class or in a course or seminar, video clips, audio clips, video information and/or audio information, of or regarding any reports, presentations, work products, projects, reviews by other students or by instructors, and/or any other information regarding the user's or the individual's performance during a class, course, or seminar.

The video clips, audio clips, video information and/or audio information, of or regarding any activities or performances of the user or the individual, can be stored in, or linked or hyperlinked with, the user's or the individual's academic or educational record(s) and/or transcript(s). In this regard, the apparatus 100 of the present invention provides academic or educational record(s) and/or transcript(s) which can contain video information, audio information, video clips, and/or audio clips, of or regarding the user or the individual, or of or regarding the user's or the individual's performances or accomplishments, thereby providing for multimedia academic or educational record(s) and/or transcript(s).

The database 20H can also contain and/or include, for each user or individual who or which utilizes the user communication device 20, data and/or information regarding each gym, health club, country club, exercise facility, fitness facility, fitness center, or martial arts school, or martial arts center or academy, in which the user or the individual is or was a member, or belongs to or has belonged to, or takes classes or courses and/or has otherwise engaged in exercise or fitness activities, programs, or classes, or martial arts training. For each individual, gym, health club, country club, exercise facility, fitness facility, fitness center, or martial arts school, or martial arts center or academy, the database 20H can contain and/or include information regarding the name, address, or location of same, information regarding and/or a link or hyperlink to a website of or associated with same, and/or any information regarding any and/or all offerings, classes, courses, seminars, or training activities, provided by same and the schedules of same, and/or any information regarding any instructors or trainers of or associated with the individual, gym, health club, country club, exercise facility, fitness facility, fitness center, or martial arts school, or martial arts center or academy. The database 20H can also contain and/or include, for each user or individual who or which utilizes the user communication device 20, data and/or information regarding each user's or individual's membership date(s), time of membership, type of membership, data and/or information regarding the exercise or fitness activities, programs, or classes or courses, or martial arts classes or training, in which the user or the individual enrolled or is enrolled, and/or has taken, has engaged in, is engaging in, or has completed, any classes, courses, seminars, information regarding the user's or the individual's date(s) of member and/or attendance, data and information regarding the classes, courses, or seminars, taken by the user or the individual, class attendance, course description, course schedule, course dates and times, any grades earned, diploma(s) earned, belts, awards, or degree(s) earned, certificate(s) earned, information regarding any teachers, instructors, trainers, or advisors, had by the user or the individual, and/or any information regarding the user or the individual that would be recorded in the user's or the individual's fitness, exercise, martial arts, sports, or athletics or any other physical, activities, record(s) or transcript(s).

The database 20H can also contain and/or include, for each user or individual who or which utilizes the user communication device 20, data and/or information regarding each the user's or the individual's student academic or educational record(s) and/or transcript(s) and/or the user's or the individual's fitness, exercise, martial arts, sports, or athletics or any other physical, activities, record(s) and/or transcript(s). The database 20H can also contain and/or include, for each user or individual who or which utilizes the user communication device 20, the user's or the individual's student academic or educational record(s) and/or transcript(s) and/or the user's or the individual's fitness, exercise, martial arts, sports, or athletics or any other physical, activities, record(s) and/or transcript(s).

The database 20H can also contain and/or include, for each user or individual who or which utilizes the user communication device 20, a universal transcript or a universal record containing any data and/or information regarding the user's or the individual's lifetime or combined or cumulative student academic or educational record(s) and/or transcript(s) and/or fitness, exercise, martial arts, sports, or athletics or any other physical, activities, record(s) and/or transcript(s), for any and/or all schools or educational or instructional institutions attended by the user or the individual, or being attended by the user or the individual, and/or for any and/or all gyms, health clubs, country clubs, exercise facilities, fitness facilities, fitness centers, or martial arts schools, or martial arts centers or academies, in which the user or the individual is or was a member, or belongs to or has belonged to, or taken classes or courses and/or has otherwise engaged in exercise or fitness activities, programs, or classes, or martial arts training.

The database 20H can also contain and/or include, for each user or individual who or which utilizes the user communication device 20, data and/or information regarding the user's or the individual's class schedules, course schedules, or seminar schedules, for any courses, classes, or seminars, enrolled in by the user or the individual, at any and/or schools or educational or instructional institutions attended by the user or the individual, or being attended by the user or the individual, and/or the user's or the individual's class schedules, course schedules, or seminar schedules, for any courses, classes, or seminars, for any and/or all of the gyms, health clubs, country clubs, exercise facilities, fitness facilities, fitness centers, or martial arts schools, or martial arts centers or academies, in which the user or the individual is a member or belongs.

The database 20H can also contain and/or include, for each user or individual who or which utilizes the user communication device 20, data and/or information regarding any searches for or regarding, any requests for alerts, or any requests for notification messages, for or regarding any classes, courses, or seminars, offered by any selected or other schools or educational or instructional institutions, or by any gyms, health clubs, country clubs, exercise facilities, fitness facilities, fitness centers, or martial arts schools, or martial arts centers or academies, which utilize the apparatus 100 and method of the present invention or with which the apparatus 100 and method of the present invention can be utilized.

The database 20H can also contain and/or include, for each user or individual who or which utilizes the user communication device 20, data and/or information regarding, and/or a link or a hyperlink to, the user's or the individual's healthcare record, personal healthcare record, or electronic healthcare record, as well as data and/or information regarding, and/or a link or a hyperlink to, the user's or the individual's instructional/education record.

The database 20H can also contain and/or include, for each user or individual who or which utilizes the user communication device 20, data and/or information regarding, and/or a link or a hyperlink to, the user's or the individual's media subscriptions and/or any media computers 60 of any media provider(s) or information provider(s) with whom or which the user or the individual subscribes to or from whom or which the user or the individual obtains media or information.

The database 20H can also contain and/or include, for each user or individual who or which utilizes the user communication device 20, data and/or information regarding, and/or a link or a hyperlink to, the user's or the individual's social networking websites or any social networking computers 70 of any social networking site or social network to which the user or the individual is a member or belongs. The database 20H can also contain and/or include, for each user or individual who or which utilizes the user communication device 20, data and/or information regarding, and/or a link or a hyperlink to, any information regarding any friends, classmates, study group partners, teammates, students, exercise partners, workout partners, or any other users or individuals with whom the user of the individual might have a relationship with in utilizing the apparatus 100 and method of the present invention.

In a preferred embodiment, the database 20H can also contain and/or include any other data and/or information deemed to be necessary, desirable, and/or useful, in utilizing the apparatus 100 and method of the present invention in the various embodiments described herein.

The database 20H can also contain and/or include and/or can be linked to any of the data and/or information described herein as being stored in the database 10H. The database 20H can also contain and/or include any other data and/or information which is or may be needed and/or desired in performing any and/or all of the features and/or functionality described herein as being provided by the apparatus 100 of the present invention and/or the user communication device 20.

The user communication device 20 also includes an output device 20I for outputting any of the data, information, and/or reports, described herein as being generated by or via the user communication device 20. In the preferred embodiment, the output device 20I can be a printer, a display, a transmitter, a modem, and/or any other device which can be used to output data or information of any kind or type.

The user communication device 20 also includes also includes a video and/or audio recording device(s) 20J which can include a camera and/or a video recording device for recording pictures or video and/or video clips and/or a microphone or an audio recording device for recording audio or audio clips which can be recorded by, and/or transmitted live, by or from the user communication device 20, or which can be recorded by, and stored at or in, the user communication device 20 for transmission by or from the user communication device 20 at a later time. The video and/or audio recording device(s) 20J can also be utilized to facilitate one-way broadcasts from the user communication device 20, and/or can be utilized to facilitate video conferencing, video chatting, and/or audio conferencing, and/or video and audio conferencing, between users of the user communication device 20 and any of the herein-described users, individuals, providers, or entities, who or which utilize the apparatus 100 and method of the present invention.

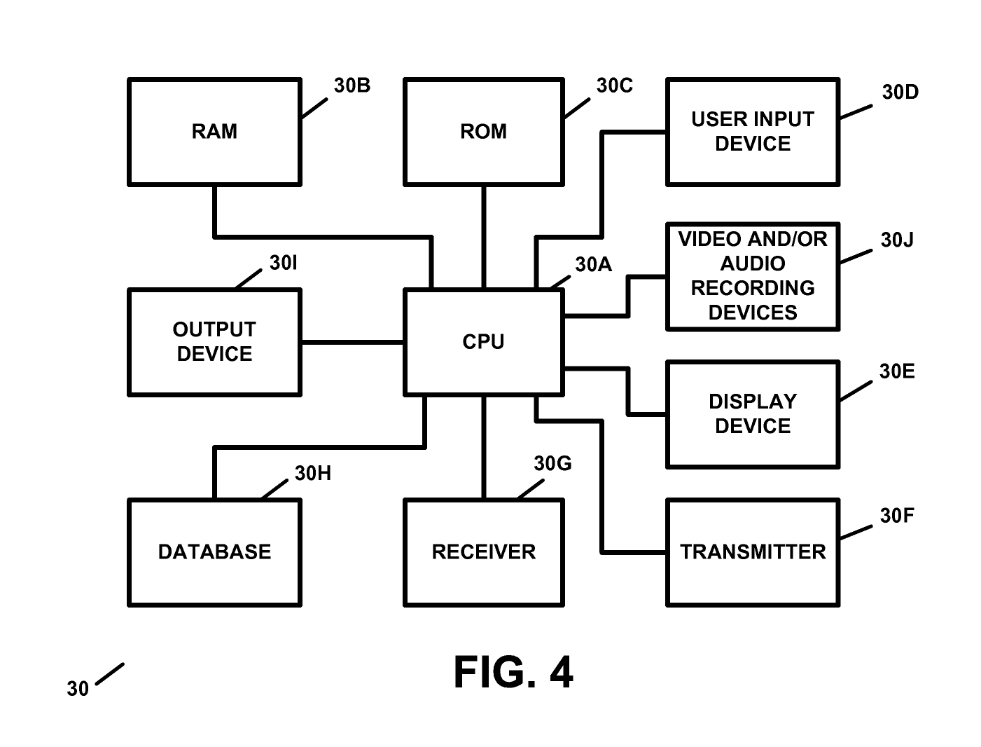

FIG. 4 illustrates the instructional facility communication device 30, in block diagram form. The instructional facility communication device 30, in the preferred embodiment, can be a server computer, a personal computer, a home computer, a laptop computer, a notebook computer, a tablet computer, a tablet, a hand-held computer, a palmtop computer, a personal communication device, a cellular telephone, a wireless telephone, a mobile telephone, a Smart phone, a Smart phone or smartphone, a personal digital assistant, a digital television, an interactive television, a digital television, a telephone, a digital telephone, a television, an interactive television, a beeper, a pager, and/or a watch or a Smart watch, and/or any wearable device, computer or communication device. The user communication device 20 can also be a website server computer, a network computer, or any other computer capable of being utilized in a network. The instructional facility communication device 30 can be utilized by any instructional facility, educational facility, training facility, gym, health club, country club, fitness center, wellness center, athletic training center or facility, physical education school, center, or program, martial arts school, exercise school or center, school, college, university, trade school, tutor, instructors, described herein, or by any one or more of the herein-described instructional facilities, educational facilities, training facilities, gyms, health clubs, country clubs, fitness centers, wellness centers, athletic training centers or facilities, physical education schools, centers, or programs, martial arts schools, exercise schools or centers, schools, colleges, universities, trade schools, tutors, and/or instructors.

With reference to FIG. 4, in the preferred embodiment, the instructional facility communication device 30 includes a central processing unit or CPU 30A, which in the preferred embodiment, is a microprocessor. The CPU 30A may also be a microcomputer, a minicomputer, a macro-computer, and/or a mainframe computer, depending upon the application.

The instructional facility communication device 30 also includes a random access memory device(s) 30B (RAM), a read only memory device(s) 30C (ROM), each of which is connected to the CPU 30A, and a user input device 30D, for entering data or information and/or instructions and/or commands into the instructional facility communication device 30, which can include any one or more of a keyboard, a scanner, a user pointing device, such as, for example, a mouse, a touch pad, and/or an audio input device and/or a video input device, and/or any device, electronic and/or otherwise which can be utilized for inputting and/or entering data and/or information and/or instructions and/or commands into the instructional facility communication device 30. The input device(s) 30D is/are also connected to the CPU 30A. The instructional facility communication device 30 also includes a display device 30E for displaying data and/or information to a user or operator.

The instructional facility communication device 30 also includes a transmitter(s) 30F, for transmitting signals and/or data and/or information to any one or more of the central processing computer(s) 10, the user communication device(s) 20, the healthcare records computer(s) 40, the instructional/educational records computer(s) 50, the media computer(s) 60, the social networking computer(s) 70, and/or any other instructional facility communication device (s) 30, which may be utilized in conjunction with the present invention. The instructional facility communication device 30 also includes a receiver 30G, for receiving signals and/or data and/or information from any one or more of the central processing computer(s) 10, the user communication device(s) 20, the healthcare records computer(s) 40, the instructional/educational records computer(s) 50, the media computer(s) 60, the social networking computer(s) 70, and/or any other instructional facility communication device (s) 30, which may be utilized in conjunction with the present invention.

The instructional facility communication device 30 also includes a database 30H which can contain and/or include, for the individual, instructional facility, educational facility, training facility, gym, health club, country club, fitness center, wellness center, athletic training center or facility, physical education school or center, martial arts school, or exercise school or center, or school, college, university, trade school, tutor, and/or instructor, who or which provides instruction, classes, courses, or training, of any type or kind, associated with or who or which utilizes the instructional facility communication device 30 and/or who or which utilizes the apparatus 100 and method of the present invention, the name and address of same, the phone numbers, e-mail addresses, or other contact information, for same, the website(s) for same, the programs offered by same, the classes or courses offered by same, the programs, diploma programs, degree programs, certificate programs, continuing education programs, or the curriculums, offered by same, schedule of classes for same, and/or class schedules, and/or times and days of classes for same.

The database 30H can also contain and/or include, the names of the respective member or students or members of the individual, instructional facility, educational facility, training facility, gym, health club, country club, fitness center, wellness center, athletic training center or facility, physical education school or center, martial arts school, or exercise school or center, or school, college, university, trade school, tutor, and/or instructor, attendance records for each student or member, the instructors or teachers for the student or member, any classes, courses, or seminars, in which the student or member is enrolled or is taking, and/or any attendance records for any student or member. The database 30H can also contain and/or include an instructional record or transcript for each student or member containing information regarding dates of enrollment or membership, grades achieved or levels achieved, and any diploma(s), degree(s), or certificate(s), or ranks or levels, earned or achieved by the student or member.

The database 30H can also contain and/or include, information regarding the courses or instructors of the instructional facility, educational facility, training facility, gym, health club, country club, fitness center, wellness center, athletic training center or facility, physical education school or center, martial arts school, or exercise school or center, or school, college, university, and/or trade school.

The database 30H can also contain and/or include, for the individual, instructional facility, educational facility, training facility, gym, health club, country club, fitness center, wellness center, athletic training center or facility, physical education school or center, martial arts school, or exercise school or center, or school, college, university, trade school, tutor, and/or instructor, information regarding any affiliations with any other, individuals, instructional facilities, educational facilities, training facilities, gyms, health clubs, country clubs, fitness centers, wellness centers, athletic training centers or facilities, physical education schools or centers, martial arts schools, or exercise schools or centers, or schools, colleges, universities, trade schools, tutors, and/or instructors, such as those affiliates who or which will agree to accept credits for courses offered by the individual, instructional facility, educational facility, training facility, gym, health club, country club, fitness center, wellness center, athletic training center or facility, physical education school or center, martial arts school, or exercise school or center, or school, college, university, trade school, tutor, and/or instructor, or who or which will agree to share facilities and/or teachers or instructors with the individual, instructional facility, educational facility, training facility, gym, health club, country club, fitness center, wellness center, athletic training center or facility, physical education school or center, martial arts school, or exercise school or center, or school, college, university, trade school, tutor, and/or instructor, and/or who or which agrees to operate in any cooperative manner with the individual, instructional facility, educational facility, training facility, gym, health club, country club, fitness center, wellness center, athletic training center or facility, physical education school or center, martial arts school, or exercise school or center, or school, college, university, trade school, tutor, and/or instructor.

The database 30H can also contain and/or include, for the individual, instructional facility, educational facility, training facility, gym, health club, country club, fitness center, wellness center, athletic training center or facility, physical education school or center, martial arts school, or exercise school or center, or school, college, university, trade school, tutor, and/or instructor, information regarding the class, course, or seminar, offering, the schedules for same, stored classes or stored lectures for same, schedules of or for live classes, lectures, or seminars, for same, and/or schedules of or for recorded classes, lectures, or seminars, for same, and/or any schedules of live and/or recorded classes, lectures, or seminars, of any affiliates of the individual, instructional facility, educational facility, training facility, gym, health club, country club, fitness center, wellness center, athletic training center or facility, physical education school or center, martial arts school, or exercise school or center, or school, college, university, trade school, tutor, and/or instructor.

The database 30H can also contain a video library of video clips and/or video recordings of workout programs and/or of movements or techniques, such as techniques for working out, training, exercising, or martial arts techniques or any kind or type.

The database 30H can contain and/or include and/or can be linked to any of the data and/or information described herein as being stored in the database 10H. The database 30H also contains and/or includes any other data and/or information which is or may be needed and/or desired in performing any and/or all of the features and/or functionality described herein as being provided by the apparatus 100 of the present invention and/or the instructional facility communication device 30.

The instructional facility communication device 30 also includes an output device 30I for outputting any of the data, information, and/or reports, described herein as being generated by or via the instructional facility communication device 30. In the preferred embodiment, the output device 30I can be a printer, a display, a transmitter, a modem, and/or any other device which can be used to output data or information of any kind or type.

The instructional facility communication device 30 also includes also includes a video and/or audio recording device(s) 30J which can include a camera and/or a video recording device for recording pictures or video and/or video clips and/or a microphone or an audio recording device for recording audio or audio clips which can be recorded by, and/or transmitted live, by or from the instructional facility communication device 30, or which can be recorded by, and stored at or in, instructional facility communication device 30 for transmission by or from the instructional facility communication device 30 at a later time. The video and/or audio recording device(s) 30J can also be utilized to facilitate one-way broadcasts from the instructional facility communication device 30, and/or can be utilized to facilitate video conferencing, video chatting, and/or audio conferencing, and/or video and audio conferencing, between users of the instructional facility communication device 30 and any of the herein-described users, individuals, providers, or entities, who or which utilize the apparatus 100 and method of the present invention.

In the preferred embodiment, the video and/or audio recording device(s) 30J can be used to record and broadcast, or to record, store, and broadcast, any of the classes, instructional sessions, educational sessions, or any other content described herein as being provided via the apparatus 100 of the present invention.

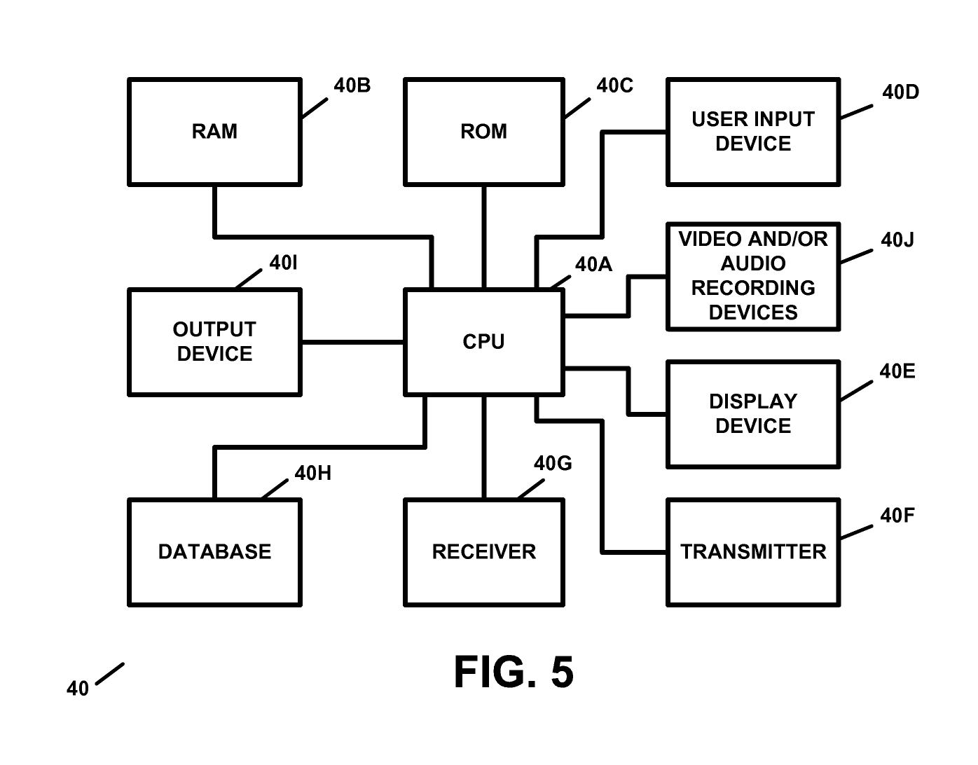

FIG. 5 illustrates the healthcare records computer 40, in block diagram form. In the preferred embodiment, the healthcare records computer 40, can be any computer capable of performing the functionality of the healthcare records computer 40 as described herein, a server computer, a network computer, or a computer system, or any other communication device which can provide the functionality of, and which can be utilized as, a healthcare records computer 40. The healthcare records computer 40 can also be any suitable server computer or server computer system, a cloud computer or cloud computer system, or a network computer or computer system. The healthcare records computer 40 can also be an Internet server computer and/or a web site server computer. In the preferred embodiment, the healthcare records computer 40 includes a central processing unit or CPU 40A, which in the preferred embodiment, is a microprocessor. The CPU 40A may also be a microcomputer, a minicomputer, a macro-computer, and/or a mainframe computer, depending upon the application.

The healthcare records computer 40 also includes a random access memory device(s) 40B (RAM), a read only memory device(s) 40C (ROM), each of which is connected to the CPU 40A, and a user input device 40D, for entering data and/or commands into the healthcare records computer 40, which can include any one or more of a keyboard, a scanner, a user pointing device, such as, for example, a mouse, a touch pad, and/or an audio input device and/or a video input device, a microphone or audio recording device, a camera or a video recording device, and/or any device, electronic and/or otherwise which can be utilized for inputting and/or entering data and/or information, as well as instructions and/or commands, into the healthcare records computer 40.

The user input device 40D can also acquire, receive, generate and/or provide, data which can be entered by a user or individual and/or can be a device which can acquire, receive, generate and/or provide, digital data such as medical, healthcare, bio-metric, physiological, and/or any other kind of healthcare data and/or healthcare-related data. For example, a user input device 40D can be a keyboard for allowing a user to input information into the patient communication device and/or a user input device can, for example, by a heart rate monitor or EKG machine which can receive information from a patient or individual and generate a digital signal, digital data, analog data, and/or any other signal, data, and/or information, which is representative of the patient's or individual's heart rate, pulse rate, and/or cardiac activity.

The user input device 40D can also be, or can include, any one or more of, and/or any combination of, a thermometer, a digital thermometer, a stethoscope, a heart rate monitor or measurement device, a pulse rate monitor or measurement device, a blood pressure monitor or measurement device, a blood pressure measurement device, a blood analysis device or machine, a respirator, a respiration monitoring or measurement device, a dialysis machine, a dialysis device, electrocardiograph (EKG) machine or device, electrocephalograph (EEG) machine or device, electromyograph (EMG) machine or device, a magnetic resonance imaging (MRI) machine or device, X-ray machine or device, medical imaging machine or device, thermal imaging machine or device, a heart sound monitor or measurement device, a lung sound monitoring or measurement device, respiration rate monitoring or measurement device, a laprascopic device, an arthroscopic device, a vascular testing device, a catheter device, a cardiac performance testing, monitoring, or measurement device, a pulmonary performance testing, monitoring, or measurement device, a vascular system performance monitoring or measurement device, a vascular system testing, monitoring, or measurement device, a metabolism monitoring or measurement device, a sonogram imaging device, a sonogram measurement device, a sonograph device, an optical response device, an optical response measurement device, an intravenous device, an arterial blood pressure measurement or monitoring device, a respiration rate measurement or monitoring device, an ultrasound imaging device, an ultrasound measurement device, a CAT SCAN device, an optical metabolism measurement or monitoring device, a radiotelemetric device, a doppler medical device, a mammogram device, a carbon dioxide detection or measurement device, a carbon monoxide detection or measurement device, a transvascular impedance measurement or monitoring device, an ultrasonic imaging device, a bone conduction device, a brain function scan analyzer device, external pulse cardiac monitoring or measurement device, a fetal heart rate measurement, monitoring, or probing, device, an endotrachial cardiac monitoring device, a finger tip blood pressure monitoring device, a psychological monitoring device, a surgical instrument, a vital signs measurement device, ear pressure regulating device, phonocardiograph device, acoustic aneurysm detector device, blood oxygen detection device, esophageal probing device, ultrasonic probing device, ausculoscope, vital signs monitoring system, heart activity monitoring device, pulmonary activity monitoring device, sphygmomanometer, esophageal stethoscope, venous pressure measuring device, differential doppler device, physiological data measuring device, body tissue movement device, breathalyzer device, camera probing device, microscopic camera probing device, and/or any other bio-metric or physiological data measuring device(s) and/or data acquisition device data acquisition device (hereinafter referred to generally or collectively as “healthcare equipment input device”, “healthcare measurement input device”, or “healthcare monitoring input device”). The healthcare records computer 40 also includes a display device 40E for displaying data and/or information to a user or operator.

The healthcare records computer 40 also includes a transmitter(s) 40F, for transmitting signals and/or data and/or information to any one or more of the central processing computer(s) 10, the user communication device(s) 20, the instructional facility communication device (s) 30, the instructional/educational records computer(s) 50, the media computer(s) 60, the social networking computer(s) 70, and/or any other the healthcare records computer(s) 40, which may be utilized in conjunction with the present invention. The healthcare records computer 40 also includes a receiver 40G, for receiving signals and/or data and/or information from any one or more of the central processing computer(s) 10, the user communication device(s) 20, the instructional facility communication device (s) 30, the instructional/educational records computer(s) 50, the media computer(s) 60, the social networking computer(s) 70, and/or any other the healthcare records computer(s) 40, which may be utilized in conjunction with the present invention.

The healthcare records computer 40 also includes a database 40H which can include any and/or all of the healthcare records, healthcare files, and/or healthcare histories, and/or any other healthcare information or healthcare-related information, for any and/or all of the users or individuals described herein who utilize the apparatus 100 of the present invention. The database 40H can serve as a centralized healthcare database for all of the users or individuals who or which utilize the apparatus 100 of the present invention. In a preferred embodiment, the healthcare records, healthcare files, and/or healthcare histories, which are stored in the database 40H for each user or individual, are comprehensive in nature and contain and/or include the healthcare records, healthcare files, and/or healthcare histories, from any and/or all of the past or present healthcare providers of the user or the individual.

In the preferred embodiment, the database 40H can contain and/or include, for each user or individual, information regarding his or her name, address, telephone number(s), cellular telephone number(s), e-mail address(es), text messaging, SMS messaging, or MMS messaging, phone number(s), social security number, identifying information, the doctor(s), dentist(s), or any other healthcare provider(s), of the user or the individual, and any information regarding the user's or the individual's parent(s) or caregiver(s), including, but not limited to, the parent's name or caregiver's name, address, telephone number(s), cellular telephone number(s), e-mail address(es), text messaging, SMS messaging, or MMS messaging, phone number(s).

The database 40H can also contain and/or include, for each user or individual, the user's or individual's healthcare records, healthcare files, or healthcare histories, including, but not limited to, the user's or the individual's doctors, dentists, or other healthcare providers, and their respective names, addresses, telephone number(s), cellular telephone number(s), e-mail address(es), text messaging, SMS messaging, or MMS messaging, phone number(s), social security number, or other identifying information.

The database 40H can also contain and/or include, for each user or individual, the user's or individual's healthcare records, healthcare files, or healthcare histories, including, but not limited to, any and/or all provider visits, dates of same as well as information regarding any examinations or procedures performed, tests performed, examination findings obtained, symptoms identified, diagnoses made, treatments prescribed of suggested, treatment plans prescribed, and/or any diagnostic reports and/or treatment reports or treatment plans generated pursuant to, or as the result of, the provider visit. The database 40H can also contain and/or include family history information as well as any other data and/or information typically included in a user's or individual's healthcare record or electronic healthcare record.

The database 40H can also contain and/or include, for each user or individual, any information regarding any insurance claims generated or filed by, for, or on behalf of, the user or the individual. The database 40H can also contain and/or include any data and/or information contained in, or a link or a hyperlink to, any instructional/educational record of or for the user or the individual.

The database 40H can also contain and/or include and/or can be linked to any of the data and/or information described herein as being stored in the database 10H. The database 40H can also contain and/or include any other data and/or information which is or may be needed and/or desired in performing any and/or all of the features and/or functionality described herein as being provided by the apparatus 100 of the present invention and/or the healthcare records computer 40.

The healthcare records computer 40 also includes an output device 40I for outputting any of the data, information, and/or reports, described herein as being generated by or via the healthcare records computer 40. In the preferred embodiment, the output device 40I can be a printer, a display, a transmitter, a modem, and/or any other device which can be used to output data or information of any kind or type.

The healthcare records computer 40 also includes also includes a video and/or audio recording device(s) 40J which can include a camera and/or a video recording device for recording pictures or video and/or video clips and/or a microphone or an audio recording device for recording audio or audio clips which can be recorded by, and/or transmitted live, by or from the healthcare records computer 40, or which can be recorded by, and stored at or in, the healthcare records computer 40 for transmission by or from the healthcare records computer 40 at a later time. The video and/or audio recording device(s) 40J can also be utilized to facilitate one-way broadcasts from the healthcare records computer 40, and/or can be utilized to facilitate video conferencing, video chatting, and/or audio conferencing, and/or video and audio conferencing, between users or operators of the healthcare records computer 40 and any of the herein-described users, individuals, providers, or entities, who or which utilize the apparatus 100 and method of the present invention.

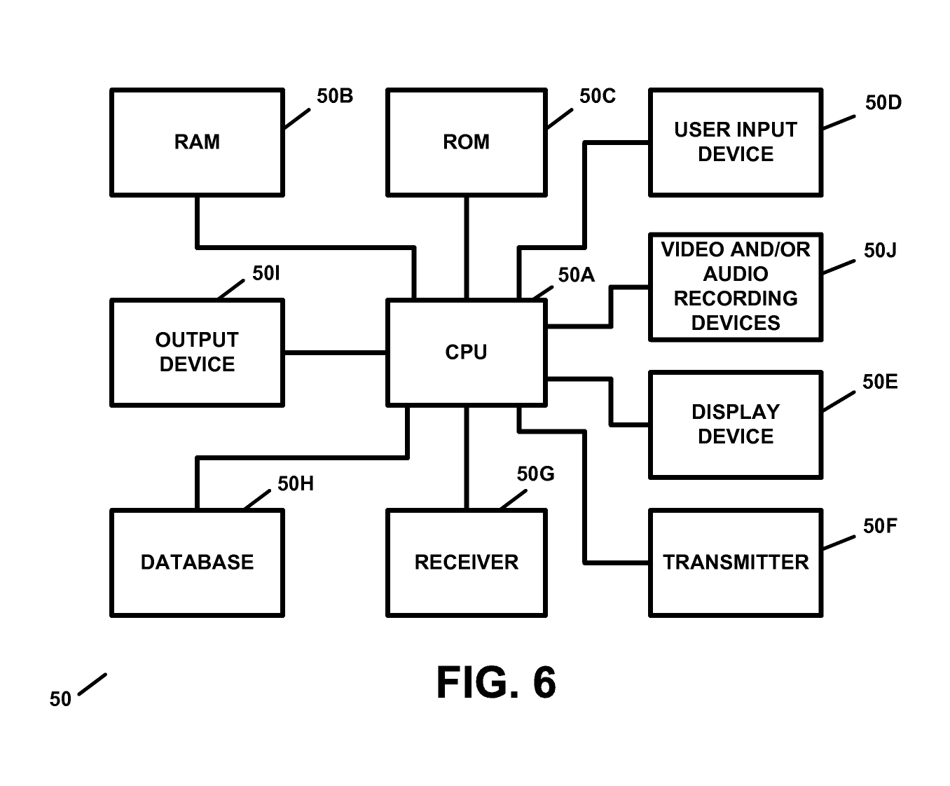

FIG. 6 illustrates the instructional/educational records computer 50, in block diagram form. In the preferred embodiment, the instructional/educational records computer 50, can be any computer capable of performing the functionality of the instructional/educational records computer 50 as described herein, a server computer, a network computer, or a computer system, or any other communication device which can provide the functionality of, and which can be utilized as, an instructional/educational records computer 50. The instructional/educational records computer 50 can also be any suitable server computer or server computer system, a cloud computer or cloud computer system, or a network computer or computer system. The instructional/educational records computer 50 can also be an Internet server computer and/or a web site server computer. In the preferred embodiment, the instructional/educational records computer 50 includes a central processing unit or CPU 50A, which in the preferred embodiment, is a microprocessor. The CPU 50A may also be a microcomputer, a minicomputer, a macro-computer, and/or a mainframe computer, depending upon the application.

The instructional/educational records computer 50 also includes a random access memory device(s) 50B (RAM), a read only memory device(s) 50C (ROM), each of which is connected to the CPU 50A, and a user input device 50D, for entering data and/or commands into the instructional/educational records computer 50, which can include any one or more of a keyboard, a scanner, a user pointing device, such as, for example, a mouse, a touch pad, and/or an audio input device and/or a video input device, a microphone or audio recording device, a camera or a video recording device, and/or any device, electronic and/or otherwise which can be utilized for inputting and/or entering data and/or information, as well as instructions and/or commands, into the instructional/educational records computer 50. The instructional/educational records computer 50 also includes a display device 50E for displaying data and/or information to a user or operator.

The instructional/educational records computer 50 also includes a transmitter(s) 50F, for transmitting signals and/or data and/or information to any one or more of the central processing computer(s) 10, the user communication device(s) 20, the instructional facility communication device (s) 30, the healthcare records computer(s) 40, the media computer(s) 60, the social networking computer(s) 70, and/or any other the instructional/educational records computer(s) 50, which may be utilized in conjunction with the present invention. The instructional/educational records computer 50 also includes a receiver 50G, for receiving signals and/or data and/or information from any one or more of the central processing computer(s) 10, the user communication device(s) 20, the instructional facility communication device (s) 30, the healthcare records computer(s) 40, the media computer(s) 60, the social networking computer(s) 70, and/or any other the instructional/educational records computer(s) 50, which may be utilized in conjunction with the present invention.

The instructional/educational records computer 50 also includes a database 50H which can include, for each user or individual who utilizes the apparatus 100 and method of the present invention, a comprehensive instructional record(s) and/or educational records(s), which can include any and/or all of the data and/or information described herein as being stored in the database 30H of each and every instructional facility communication device 30 of or associated with each individual, instructional facility, educational facility, training facility, gym, health club, country club, fitness center, wellness center, athletic training center or facility, physical education school or center, martial arts school, or exercise school or center, or school, college, university, trade school, tutor, and/or instructor, which the user or the individual has respectively been a student of, has attended, has been enrolled in, or has been a member of, or is currently a student of, is currently attending, is currently enrolled in, or is a currently a member.

The database 50H can serve as a centralized instructional records and/or educational records database for all of the users or individuals who or which utilize the apparatus 100 of the present invention. In a preferred embodiment, the instructional record(s) and/or educational records(s), which are stored in the database 50H for each user or individual, are comprehensive in nature and contain and/or include the instructional record(s) and/or educational records(s), from any and/or all of individuals, instructional facilities, educational facilities, training facilities, gyms, health clubs, country clubs, fitness centers, wellness centers, athletic training centers or facilities, physical education schools or centers, martial arts schools, or exercise schools or centers, or schools, colleges, universities, trade schools, tutors, and/or instructors, which the user or the individual has respectively been a student of, has attended, has been enrolled in, or has been a member of, or is currently a student of, is currently attending, is currently enrolled in, or is a currently a member.

In the preferred embodiment, the database 50H can contain and/or include, for each user or individual, information regarding his or her name, address, telephone number(s), cellular telephone number(s), e-mail address(es), text messaging, SMS messaging, or MMS messaging, phone number(s), social security number, identifying information, the individuals, instructional facilities, educational facilities, training facilities, gyms, health clubs, country clubs, fitness centers, wellness centers, athletic training centers or facilities, physical education schools or centers, martial arts schools, or exercise schools or centers, or schools, colleges, universities, trade schools, tutors, and/or instructors, which the user or the individual has respectively been a student of, has attended, has been enrolled in, or has been a member of, or is currently a student of, is currently attending, is currently enrolled in, or is a currently a member, and any information regarding same, including, but not limited to, each respective individual's, instructional facility's, educational facility's′, training facility's, gym's, fitness center's, wellness center's, athletic training center's or facility's, physical education school's or center's, martial arts school's, or exercise school's or center's, or school's, college's, university's, trade school's, tutor's, and/or instructor's, name, address, website(s), domain name(s), IP address(es), telephone number(s), cellular telephone number(s), e-mail address(es), text messaging, SMS messaging, or MMS messaging, phone number(s).

In the preferred embodiment, the database 50H can contain and/or include, for each user or individual, and for each individual, instructional facility, educational facility, training facility, gym, health club, country club, fitness center, wellness center, athletic training center or facility, physical education school or center, martial arts school, or exercise school or center, or school, college, university, trade school, tutor, and/or instructor, which the user or the individual has respectively been a student of, has attended, has been enrolled in, or has been a member of, or is currently a student of, is currently attending, is currently enrolled in, or is a currently a member, an instructional record and/or an educational record for the user or the individual with or at that individual, and for each individual, instructional facility, educational facility, training facility, gym, health club, country club, fitness center, wellness center, athletic training center or facility, physical education school or center, martial arts school, or exercise school or center, or school, college, university, trade school, tutor, and/or instructor.

The database 50H can also contain and/or include, for each user or individual, and for each individual, instructional facility, educational facility, training facility, gym, health club, country club, fitness center, wellness center, athletic training center or facility, physical education school or center, martial arts school, or exercise school or center, or school, college, university, trade school, tutor, and/or instructor, which the user or the individual has respectively been a student of, has attended, has been enrolled in, or has been a member of, or is currently a student of, is currently attending, is currently enrolled in, or is a currently a member, the name and address of same, the phone numbers, e-mail addresses, or other contact information, for same, the website(s) for same, the programs offered by same, the classes or courses offered by same, the programs, diploma programs, degree programs, certificate programs, continuing education programs, or the curriculums, offered by same, schedule of classes for same, and/or class schedules, and/or times and days of classes for same.

The database 50H can also contain and/or include, for each individual, instructional facility, educational facility, training facility, gym, health club, country club, fitness center, wellness center, athletic training center or facility, physical education school or center, martial arts school, or exercise school or center, or school, college, university, trade school, tutor, and/or instructor, the names of the respective students or members of the individual, instructional facility, educational facility, training facility, gym, health club, country club, fitness center, wellness center, athletic training center or facility, physical education school or center, martial arts school, or exercise school or center, or school, college, university, trade school, tutor, and/or instructor, the attendance records for each student or member, the instructors or teachers for the student or member, any classes, courses, or seminars, in which the student or member is enrolled or is taking, and/or any attendance records for any student or member. The database 50H can also contain and/or include, for each individual, instructional facility, educational facility, training facility, gym, health club, country club, fitness center, wellness center, athletic training center or facility, physical education school or center, martial arts school, or exercise school or center, or school, college, university, trade school, tutor, and/or instructor, an instructional record or transcript and/or an educational record or transcript for each student or member containing information regarding dates of enrollment or membership, grades achieved or levels achieved, and any diploma(s), degree(s), or certificate(s), or ranks or levels, earned or achieved by the student or member.

The database 50H can also contain and/or include, for each individual, instructional facility, educational facility, training facility, gym, health club, country club, fitness center, wellness center, athletic training center or facility, physical education school or center, martial arts school, or exercise school or center, or school, college, university, trade school, tutor, and/or instructor, information regarding the courses or instructors of the individual, instructional facility, educational facility, training facility, gym, health club, country club, fitness center, wellness center, athletic training center or facility, physical education school or center, martial arts school, or exercise school or center, or school, college, university, and/or trade school.

The database 50H can also contain and/or include, for each individual, instructional facility, educational facility, training facility, gym, health club, country club, fitness center, wellness center, athletic training center or facility, physical education school or center, martial arts school, or exercise school or center, or school, college, university, trade school, tutor, and/or instructor, information regarding any affiliations with any other, individuals, instructional facilities, educational facilities, training facilities, gyms, health clubs, country clubs, fitness centers, wellness centers, athletic training centers or facilities, physical education schools or centers, martial arts schools, or exercise schools or centers, or schools, colleges, universities, trade schools, tutors, and/or instructors, such as those affiliates who or which will agree to accept credits for courses offered by the individual, instructional facility, educational facility, training facility, gym, health club, country club, fitness center, wellness center, athletic training center or facility, physical education school or center, martial arts school, or exercise school or center, or school, college, university, trade school, tutor, and/or instructor, or who or which will agree to share facilities and/or teachers or instructors with the individual, instructional facility, educational facility, training facility, gym, health club, country club, fitness center, wellness center, athletic training center or facility, physical education school or center, martial arts school, or exercise school or center, or school, college, university, trade school, tutor, and/or instructor, and/or who or which agrees to operate in any cooperative manner with the individual, instructional facility, educational facility, training facility, gym, health club, country club, fitness center, wellness center, athletic training center or facility, physical education school or center, martial arts school, or exercise school or center, or school, college, university, trade school, tutor, and/or instructor.

The database 50H can also contain and/or include, for each individual, instructional facility, educational facility, training facility, gym, health club, country club, fitness center, wellness center, athletic training center or facility, physical education school or center, martial arts school, or exercise school or center, or school, college, university, trade school, tutor, and/or instructor, information regarding the classes, courses, or seminars, offerings, and/or the schedules for same, stored classes or stored lectures for same, schedules of or for live classes, lectures, or seminars, for same, and/or schedules of or for recorded classes, lectures, or seminars, for same, and/or any schedules of live and/or recorded classes, lectures, or seminars, of any affiliates of the individual, instructional facility, educational facility, training facility, gym, health club, country club, fitness center, wellness center, athletic training center or facility, physical education school or center, martial arts school, or exercise school or center, or school, college, university, trade school, tutor, and/or instructor.

In a preferred embodiment, the database 50H can also contain and/or include any data and/or information regarding the users or individuals who utilize the apparatus 100 and method of the present invention, any of their respective instructional records and/or education records, any of their respective comprehensive instructional record(s) or educational record(s), and any an/do all of the data and/or information regarding the respective individuals, instructional facilities, educational facilities, training facilities, gyms, health clubs, country clubs, fitness centers, wellness centers, athletic training centers or facilities, physical education schools or centers, martial arts schools, or exercise schools or centers, or schools, colleges, universities, trade schools, tutors, and/or instructors, which the user or the individual has respectively been a student of, has attended, has been enrolled in, or has been a member of, or is currently a student of, is currently attending, is currently enrolled in, or is a currently a member.

The database 50H can also contain and/or include and/or can be linked to any of the data and/or information described herein as being stored in the database 10H. The database 50H can also contain and/or include any other data and/or information which is or may be needed and/or desired in performing any and/or all of the features and/or functionality described herein as being provided by the apparatus 100 of the present invention and/or instructional/educational records computer 50.

The instructional/educational records computer 50 also includes an output device 50I for outputting any of the data, information, and/or reports, described herein as being generated by or via the instructional/educational records computer 50. In the preferred embodiment, the output device 50I can be a printer, a display, a transmitter, a modem, and/or any other device which can be used to output data or information of any kind or type.

The instructional/educational records computer 50 also includes also includes a video and/or audio recording device(s) 50J which can include a camera and/or a video recording device for recording pictures or video and/or video clips and/or a microphone or an audio recording device for recording audio or audio clips which can be recorded by, and/or transmitted live, by or from the instructional/educational records computer 50, or which can be recorded by, and stored at or in, the instructional/educational records computer 50 for transmission by or from the instructional/educational records computer 50 at a later time. The video and/or audio recording device(s) 50J can also be utilized to facilitate one-way broadcasts from the instructional/educational records computer 50, and/or can be utilized to facilitate video conferencing, video chatting, and/or audio conferencing, and/or video and audio conferencing, between users or operators of the instructional/educational records computer 50 and any of the herein-described users, individuals, providers, or entities, who or which utilize the apparatus 100 and method of the present invention.

In a preferred embodiment, the central processing computer(s) 10, the user communication device(s) 20, the instructional facility communication device(s) 30, the healthcare records computers 40, and the instructional/educational records computer(s) 50, can be programmed, and/or they can be linked together or dynamically linked together, or their respective databases 10H, 20H, 30H, 40H, and 50H, can all be linked together or dynamically linked together, so that a change, a modification, or an update, to any user's or individual's instructional record or educational record, once stored in one or the databases 10H, 20H, 30H, 40H, or 50H, can and will be automatically effectuated and stored in all of the database 10H, 20H. 30H, 40, or 50H, in which an instructional record or educational record is stored of the user or individual. In this regard, a change, modification, or update, to a user's or individual's instructional record or educational record on one computer or communication device can and will automatically be effectuated and made to the user's or individual's instructional record or educational record on every computer or communication device which stores an instructional record or educational record for the user or individual. In this manner, any and/or all information contained in, or stored in, a user's or individual's instructional record or educational record can always be continuously updated on all computers or communication devices 10, 20, 30, 40, and 50, any time a change, modification, or update is made to same on any one computer or communication device 10, 20, 30, 40, or 50. In another preferred embodiment, each computer or communication device 20, 30, 40, or 50 can automatically transmit, to the central processing computer 10, any data and/or information regarding any change, modification, or update, to a user's or individual's instructional record or educational record, upon the storage of same, and the central processing computer 10 can automatically transmit the data and/or information regarding the change, modification, or update to each of the computers or communication devices 20, 30, 40, and 50, as well as to any other central processing computer(s).

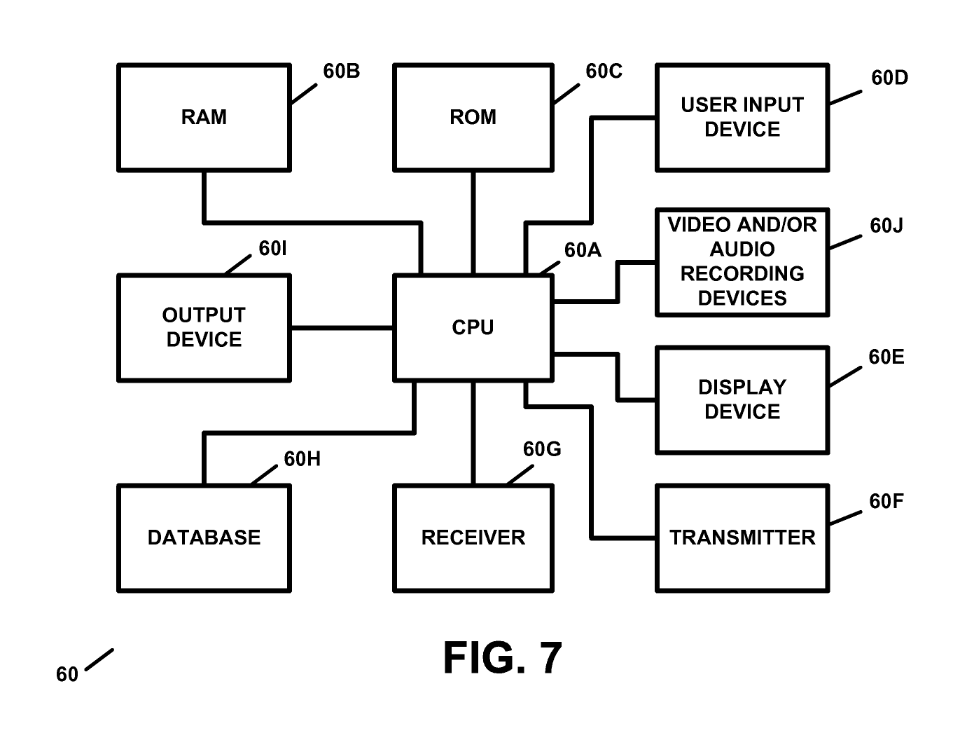

FIG. 7 illustrates the media computer 60, in block diagram form. With reference to FIG. 2, the media computer 60, in the preferred embodiment, is any computer capable of performing the functionality of the media computer 60 as described herein, a server computer, a network computer, or a computer system, or any other communication device which can provide the functionality of, and which can be utilized as, a media computer 60. The media computer 60 can also be any suitable server computer or server computer system, a cloud computer or cloud computer system, or a network computer or computer system. The media computer 60 can also be an Internet server computer and/or a web site server computer.

The media computer 60 can be used by, maintained by, or associated with media company or provider or any information or content provider, website, or other entity, and can provide any of the herein-described media, content information, activities, and/or functionality, described herein as being provided via the apparatus 100 and method of the present invention and which can be provided by any media and/or information provider company, website, or other entity.

In the preferred embodiment, the media computer 60 includes a central processing unit or CPU 60A, which in the preferred embodiment, is a microprocessor. The CPU 60A may also be a microcomputer, a minicomputer, a macro-computer, and/or a mainframe computer, depending upon the application. The media computer 60 also includes a random access memory device(s) 60B (RAM) and a read only memory device(s) 60C (ROM), each of which is connected to the CPU 60A, and a user input device 60D, for entering data and/or commands into the media computer 60, which can include any one or more of a keyboard, a scanner, a user pointing device, such as, for example, a mouse, a touch pad, and/or an audio input device and/or a video input device, a microphone or audio recording device, a camera or a video recording device, and/or any device, electronic and/or otherwise which can be utilized for inputting and/or entering data and/or information, as well as instructions and/or commands, into the media computer 60. The media computer 60 also includes a display device 60E for displaying data and/or information to a user or operator.

The media computer 60 also includes a transmitter(s) 60F, for transmitting signals and/or data and/or information to any one or more of the central processing computer(s) 10, the user communication device(s) 20, the instructional facility communication device (s) 30, the healthcare records computer(s) 40, the instructional/educational records computer(s) 50, the social networking computer(s) 70, and/or any other media computer(s) 60, which may be utilized in conjunction with the present invention. The media computer 60 also includes a receiver 60G, for receiving signals and/or data and/or information from any one or more of the central processing computer(s) 10, the user communication device(s) 20, the instructional facility communication device (s) 30, the healthcare records computer(s) 40, the instructional/educational records computer(s) 50, the social networking computer(s) 70, and/or any other media computer(s) 60, which may be utilized in conjunction with the present invention.

The media computer 60 also includes a database(s) 60H. The database 60H can contain and/or can be linked to any of the data and/or information described herein as being stored in the database 60H and can also contain any data and/or information typically found in or utilized by a media computer 60 as well as any of the respective media, news, information, advertisements, or marketing materials, and/or any data and/or information typically utilized in providing or performing the functionality and/or services described-herein as being provided or offered by the media computer 60.

The database 60H can also contain and/or include and/or can be linked to any of the data and/or information described herein as being stored in the database 10H. The database 60H can also contain and/or include any other data and/or information which is or may be needed and/or desired in performing any and/or all of the features and/or functionality described herein as being provided by the apparatus 100 of the present invention and/or the media computer 60.

The media computer 60 also includes an output device 60I for outputting any of the data, information, and/or reports, described herein as being generated by or via the media computer 60. In the preferred embodiment, the output device 60I can be a printer, a display, a transmitter, a modem, and/or any other device which can be used to output data or information of any kind or type.

The media computer 60 also includes also includes a video and/or audio recording device(s) 60J which can include a camera and/or a video recording device for recording pictures or video and/or video clips and/or a microphone or an audio recording device for recording audio or audio clips which can be recorded by, and/or transmitted live, by or from the media computer 60, or which can be recorded by, and stored at or in, the media computer 60 for transmission by or from the media computer 60 at a later time. The video and/or audio recording device(s) 60J can also be utilized to facilitate one-way broadcasts from the media computer 60, and/or can be utilized to facilitate video conferencing, video chatting, and/or audio conferencing, and/or video and audio conferencing, between users of the media computer 60 and any of the herein-described users, individuals, providers, or entities, who or which utilize the apparatus 100 and method of the present invention.

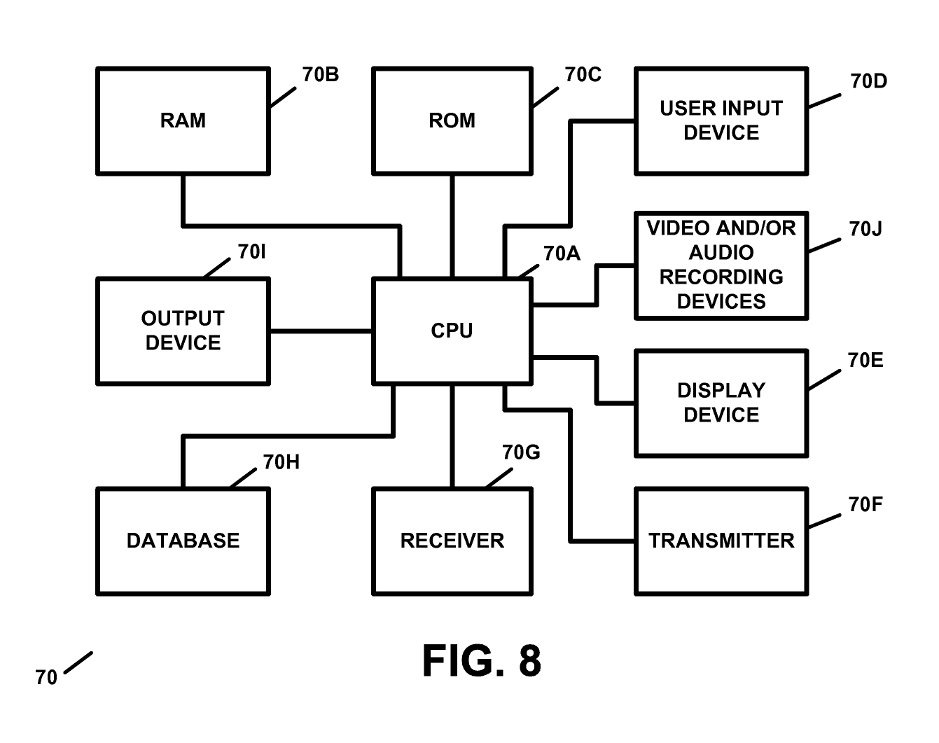

FIG. 8 illustrates the social networking computer 70, in block diagram form. The social networking computer 70, in the preferred embodiment, can be any social networking computer or computer system or any computer or computer system used by or associated with any social networking company or social networking website, or can be any suitable server computer or server computer system, a cloud computer or cloud computer system, a network computer or computer system, a personal computer or any other computer or communication device, or any cellular telephone, tablet, personal digital assistant, wireless communication device or wireless computer, or any other communication device, which is capable of performing the functionality of the social networking computer 70 as described herein. In a preferred embodiment, the social networking computer 70 can be any computer of computer system for providing the functionality described herein as being provided by the social networking computer 70 or any social networking computer or website or which can be utilized to function as a social networking computer 70. The social networking computer 70, in the preferred embodiment, can also be a server computer, a network computer, or a computer system, or any other communication device which can provide the functionality of, and which can be utilized as, a social networking computer 70. The media computer 60 can also be an Internet server computer and/or a web site server computer.

The social networking computer 70 can be used by, maintained by, or associated with social networking company, website, or other entity and can provide any of the herein-described social networking information, activities, and/or functionality, described herein as being provided via the apparatus 100 and method of the present invention and which can be provided by any social networking company, website, or other entity.

In the preferred embodiment, the social networking computer 70 includes a central processing unit or CPU 70A, which in the preferred embodiment, is a microprocessor. The CPU 70A may also be a microcomputer, a minicomputer, a macro-computer, and/or a mainframe computer, depending upon the application.

The social networking computer 70 also includes a random access memory device(s) 70B (RAM), a read only memory device(s) 70C (ROM), each of which is connected to the CPU 70A, and a user input device 70D, for entering data and/or commands into social networking computer 70, which can include any one or more of a keyboard, a scanner, a user pointing device, such as, for example, a mouse, a touch pad, and/or an audio input device and/or a video input device, a microphone or audio recording device, a camera or a video recording device, and/or any device, electronic and/or otherwise which can be utilized for inputting and/or entering data and/or information, as well as instructions and/or commands, into the social networking computer 70. The social networking computer 70 also includes a display device 70E for displaying data and/or information to a user or operator.

The social networking computer 70 also includes a transmitter(s) 70F, for transmitting signals and/or data and/or information to any one or more of the central processing computer(s) 10, the user communication device(s) 20, the instructional facility communication device (s) 30, the healthcare records computer(s) 40, the instructional/educational records computer(s) 50, the media computer(s) 60, and/or any other social networking computer(s) 70, which may be utilized in conjunction with the present invention. The social networking computer 70 also includes a receiver 70G, for receiving signals and/or data and/or information from any one or more of the central processing computer(s) 10, the user communication device(s) 20, the instructional facility communication device (s) 30, the healthcare records computer(s) 40, the instructional/educational records computer(s) 50, media computer(s) 60, and/or any other social networking computer(s) 70, which may be utilized in conjunction with the present invention.

The social networking computer 70 also includes a database(s) 70H. The database 70H can contain and/or be linked to any of the data and/or information described herein as being stored in the database 10H and can also contain any data and/or information typically found in or utilized by a social networking computer or any members of the social network serviced thereby as well as any data and/or information typically utilized in providing or performing the functionality and/or services described-herein as being provided or offered by the social network associated with the social networking computer 70.

The database 70H can also contain and/or include and/or can be linked to any of the data and/or information described herein as being stored in the database 10H. The database 70H can also contain and/or include any other data and/or information which is or may be needed and/or desired in performing any and/or all of the features and/or functionality described herein as being provided by the apparatus 100 of the present invention and/or the social networking computer 70.

The social networking computer 70 also includes an output device 70I for outputting any of the data, information, and/or reports, described herein as being generated by or via the social networking computer 70. In the preferred embodiment, the output device 70I can be a printer, a display, a transmitter, a modem, and/or any other device which can be used to output data or information of any kind or type.

The social networking computer 70 also includes also includes a video and/or audio recording device(s) 70J which can include a camera and/or a video recording device for recording pictures or video and/or video clips and/or a microphone or an audio recording device for recording audio or audio clips which can be recorded by, and/or transmitted live, by or from the social networking computer 70, or which can be recorded by, and stored at or in, the social networking computer 70 for transmission by or from the social networking computer 70 at a later time. The video and/or audio recording device(s) 70J can also be utilized to facilitate one-way broadcasts from the social networking computer 70, and/or can be utilized to facilitate video conferencing, video chatting, and/or audio conferencing, and/or video and audio conferencing, between users of the social networking computer 70 and any of the herein-described users, individuals, providers, or entities, who or which utilize the apparatus 100 and method of the present invention.

In any and/or all of the preferred embodiments described herein, any of the processing routines, functions, and/or functionality, described herein as being performed by or with the central processing computer 10 can also be performed by or with the instructional facility communication device 30. In this regard, the instructional facility communication device 30 can be programmed to perform all of processing routines, functions, and/or functionality, which is described herein as being performed by or with the central processing computer 10 in any and/or all of the embodiments described herein.

In any and/or all of the preferred embodiments described herein, any of the processing routines, functions, and/or functionality, described herein as being performed by or with the instructional facility communication device 30 can also be performed by or with central processing computer 10. In this regard, the central processing computer 10 can be programmed to perform all of processing routines, functions, and/or functionality, which is described herein as being performed by or with the instructional facility communication device 30 in any and/or all of the embodiments described herein.

The apparatus 100 and method of the present invention can be utilized in order to allow a user or individual who is a respective student or member of any instructional facility, educational facility, training facility, gym, health club, country club, fitness center, wellness center, athletic training center or facility, physical education school or center, martial arts school, or exercise school or center, or school, college, university, trade school, tutor, and/or instructor, described herein or otherwise, to view, attend, or participate in, classes offered by same remotely and/or via the Internet and/or the World Wide Web, or via any other communication network.

In a preferred embodiment, the apparatus 100 and method of the present invention can be utilized in order to allow a user or individual, who is a student or member of any given instructional facility, educational facility, training facility, gym, health club, country club, fitness center, wellness center, athletic training center or facility, physical education school or center, martial arts school, or exercise school or center, or school, college, university, trade school, tutor, and/or instructor, to view, attend, or participate in, classes or other activities offered by same remotely and/or via the Internet and/or the World Wide Web, or via any other communication network, or to view, attend, or participate in, classes or other activities offered by any other instructional facility, educational facility, training facility, gym, health club, country club, fitness center, wellness center, athletic training center or facility, physical education school or center, martial arts school, or exercise school or center, or school, college, university, trade school, tutor, and/or instructor, who or which utilizes the apparatus 100 and method of the present invention, remotely and/or via the Internet and/or the World Wide Web, or via any other communication network.

In a preferred embodiment, a user or individual can be a registered or subscribing student or member of a given instructional facility, educational facility, training facility, gym, health club, country club, fitness center, wellness center, athletic training center or facility, physical education school or center, martial arts school, or exercise school or center, or school, college, university, trade school, tutor, and/or instructor, and/or can be a registered or subscribing student or member of any program, class, course, or seminar, offered or provided by same. In another preferred embodiment, the user or the individual can be a registered or subscribing student or member of any one or more instructional facilities, educational facilities, training facilities, gyms, health clubs, country clubs, fitness centers, wellness centers, athletic training centers or facilities, physical education schools or centers, martial arts schools, or exercise schools or centers, or schools, colleges, universities, trade schools, tutors, and/or instructors, and/or can be a registered or subscribing student or member of any one or more programs, classes, courses, or seminars, offered or provided by same. In a preferred embodiment, the user or the individual can actually attend the respective instructional facility, educational facility, training facility, gym, health club, country club, fitness center, wellness center, athletic training center or facility, physical education school or center, martial arts school, or exercise school or center, or school, college, university, trade school, or meet with the tutor and/or the instructor, and/or the user or individual can also view, attend, or participate in, classes or other activities offered by same remotely and/or via the Internet and/or the World Wide Web, or via any other communication network, and/or to view, attend, or participate in, classes or other activities offered by any other instructional facility, educational facility, training facility, gym, health club, country club, fitness center, wellness center, athletic training center or facility, physical education school or center, martial arts school, or exercise school or center, or school, college, university, trade school, tutor, and/or instructor, who or which utilizes the apparatus 100 and method of the present invention, remotely and/or via the Internet and/or the World Wide Web, or via any other communication network.

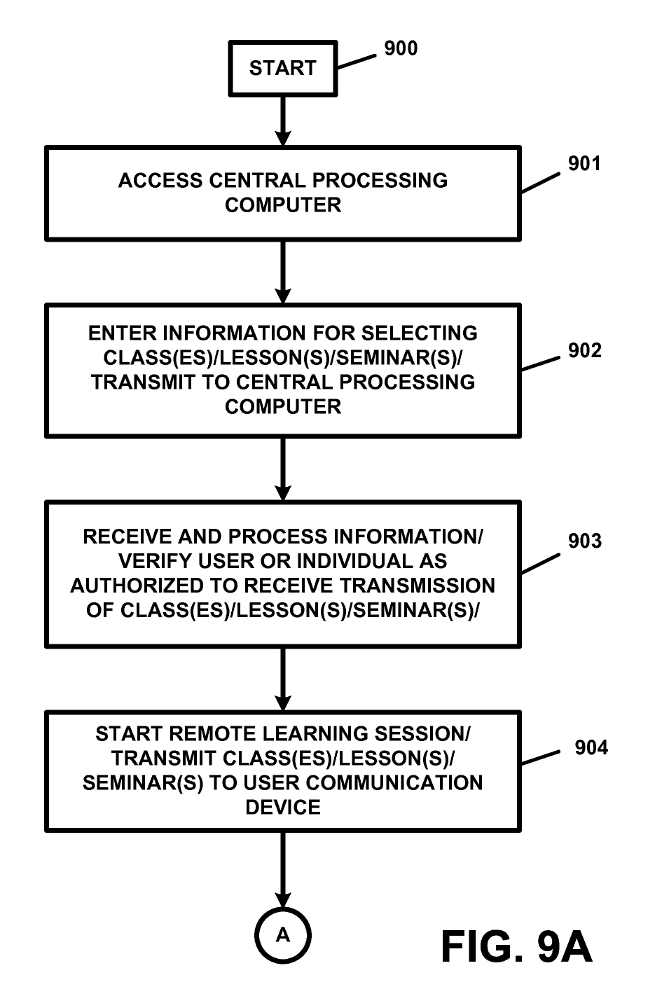

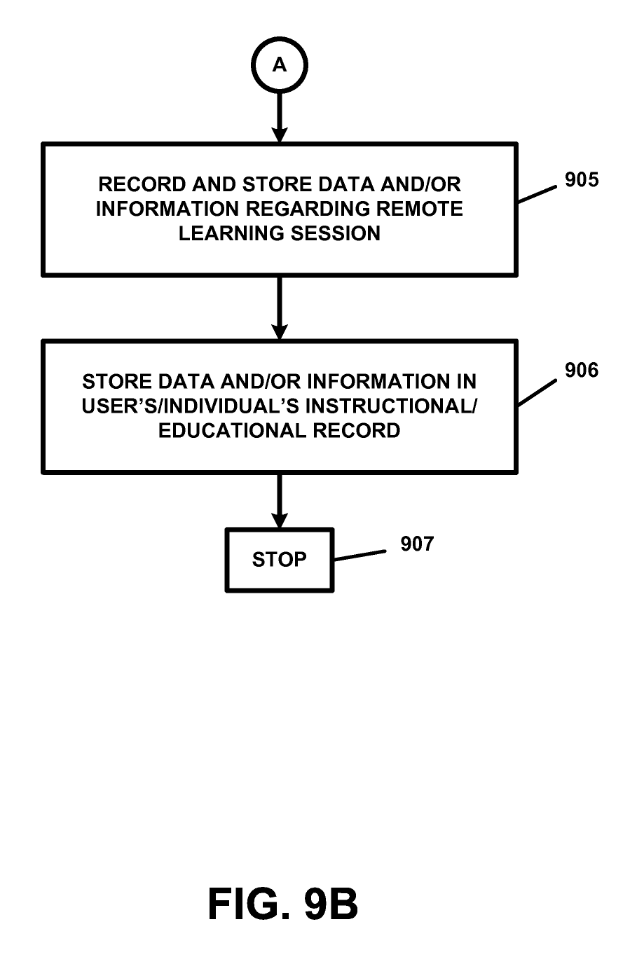

FIGS. 9A and 9B illustrate a preferred embodiment method for utilizing the apparatus 100 of the present invention, in flow diagram form. In a preferred embodiment, the operation of the apparatus 100 and method of the present invention can be described as being utilized by a user or individual who is enrolled or registered with a martial arts school in order to study Krav Maga both at the actual martial arts school as well as remotely at that martial arts school as well as any other martial arts school that teaches Krav Maga or offers Krav Maga training and which also offers same via, and/or which utilizes, the apparatus 100 of the present invention. Although described and illustrated as being utilized in connection with Krav Maga martial arts instruction, it is important to note that the embodiment of FIGS. 9A and 9B can be utilized in a same, a similar, and/or an analogous, manner in connection with and/or in conjunction with any of the herein-described and various types or kinds of exercise activities, fitness activities, work-out activities, strength and conditioning activities, any type or kinds or sports or athletic activities, aerobics activities, weight training activities, cross training activities, callisthenic activities, Pilates activities, Yoga activities, meditation activities, Tai Chi activities, boxing, wrestling, kickboxing, cheerleading, martial arts activities, including, but not limited to, Krav Maga (Israeli martial arts), Karate, Kung Fu, Judo, Jujitsu, Kick Boxing, Mixed Martial Arts, Muy Tai, Brazilian Jujitsu, Savate, and any other type or kind of martial arts, as well as any other type or kind of physical activities, exercise activities, fitness activities, or wellness activities, and/or in connection with and/or in conjunction with the providing or offering of any types or kinds of instructional services and/or educational services in and for any types of kinds of academic subjects, classes, courses, diploma programs, degree programs, certificate programs, or continuing education programs, and/or any other informational, instructional, or educational, programs or activities, provided by or offered by any instructional and/or educational school, institution, facility, college, university, professional school continuing education institution, or any other learning institution or facility.

With reference once again to FIGS. 9A and 9B, in the preferred embodiment, the user or individual can be a member of, a student of, or be enrolled in a Krav Maga school or center where he or she can physically go to take or attend Krav Maga classes. In the preferred embodiment, the user or individual can also have an instructional record or education record which reflects his or her being a member or, a student of, or being enrolled in or with, the Krav Maga school or center. In a preferred embodiment, any information regarding the user's or the individual's attendance at classes, advancement through the program, belt or rank level, any other Krav Maga schools or centers where the user or individual studies Krav Maga either in-person or remotely, and/or any other data and/or information regarding the user or individual can be stored in the user's or individual's instructional record or education record stored in the database 10H and in the database 30H of the instructional facility communication device 30 of or associated with any of the Krav Maga schools or centers in which the user or individual has viewed, attended, or participated in, any classes, lessons, or seminars.

In the preferred embodiment of FIGS. 9A and 9B, the user or individual can supplement his or her Krav Maga training by viewing, attending, or participating in, classes offered or provided by his or her school or schools by viewing, attending, or participating in, same remotely, via the apparatus 100 of the present invention, and/or by viewing, attending, or participating in, classes offered or provided by other Krav Maga schools or centers which make their classes available remotely via the apparatus 100 of the present invention. In this regard, the apparatus 100 can be utilized to allow the user or individual to supplement his or her Krav Maga training by viewing, attending, or participating in, a Krav Maga class, lesson, or seminar with his or her Krav Maga school or center or with any other Krav Maga school or center remotely via the apparatus 100 of the present invention.

With reference to FIGS. 9A and 9B, the operation of the apparatus 100 commences at step 900. At step 901, the user or individual can access the central processing computer 10 via his or her user communication device 20, and/or via any communication device 20 available to the user or individual, in order request a remote learning session. For example, if the user or individual is traveling, he or she can utilize a communication device 20, such as computer in a hotel business center or a television in a hotel room which can be capable of connecting to the Internet and/or the World Wide Web or to any other suitable communication network.

At step 902, the user or individual can input or enter any login information to gain access to the central processing computer 10, and/or to gain access to his or her account and/or to gain access to his or her instructional record or educational record. At step 902, the user or individual can also input or enter any data and/or information for selecting and/or for accessing the class, lesson, or seminar offered by or provided by his or her Krav Maga school or center, or the user or individual can also input or enter any data and/or information for selecting and/or accessing the class, lesson, or seminar offered by or provided by any other Krav Maga school or center. At step 902, any data and/or information input or entered by the user or individual can be transmitted to the central processing computer 10. In a preferred embodiment, the central processing computer 10 can provide and/or can transmit to the user communication device 20 any data and/or information needed or desired for allowing the user or individual to input or enter any data or information described herein as being input or entered by the user or individual at step 902.

For example, the central processing computer 10 can provide the user or individual with class schedule(s) for classes, lessons, or seminars at his or her Krav Maga school or center at that time, or on that day, as well as any information regarding any class, lesson, or seminar plan, agenda, or syllabus, material to be covered or planned to be covered in, during, and/or for, each class, lesson, or seminar, the instructor or trainer for each class, lesson, or seminar, and/or any materials or techniques planned to be covered or taught in or during that class, lesson, or seminar. The central processing computer 10 can provide the user or individual with information regarding live classes, lessons, or seminars which are available at that time or on that day, as well as provide information regarding any recordings of any classes prior to that time, available at that time, or available on that day, along with any information about these recorded classes, lessons, or seminars. At step 902, the user or individual can input or enter any data and/or information requesting to receive any number of live classes, lessons, or seminars, and/or any recorded classes, lessons, or seminars, from his or her Krav Maga school or center, or from any one or more of any other Krav Maga schools or centers in which he or she is a student or member, and/or from any other Krav Maga school(s) or center(s) from which he or she wants to receive classes, lessons, or seminars. At step 902, in the case when multiple classes, lessons, or seminars are requested, the user or individual can also select any sequence or order for receiving same.

In a preferred embodiment, only a single class, lesson, or seminar, can be selected. In another embodiment, any number of classes, lessons, or seminars, can be selected.

At step 903, the central processing computer 10 can receive and process any data and/or information which is input or entered by the user or individual at step 902. In a preferred embodiment, the central processing computer 10 can verify that the user or individual is a student or member of the Krav Maga school or center or can verify that the user or individual is a registered user, student, or member, of the apparatus 100 of the present invention and/or of any instructional facilities, educational facilities, training facilities, gyms, health clubs, country clubs, fitness centers, wellness centers, athletic training centers or facilities, physical education schools or centers, martial arts schools, or exercise schools or centers, or schools, colleges, universities, trade schools, tutors, and/or instructors, registered with the apparatus 100 of the present invention.

In a preferred embodiment, the central processing computer 10 and, in particular, the database 10H of same can be a repository of any and/or all recorded classes, lessons, or seminars of each Krav Maga school or center registered with the apparatus 100.

In a preferred embodiment, the central processing computer 10 is capable of broadcasting, and/or receiving and storing, live broadcasts of classes and lessons broadcast by or transmitted by or from the instructional facility communication device(s) 30 of or associated with each Krav Maga school or center registered with the apparatus 100. In another preferred embodiment, the central processing computer 10 can also provide the user communication device 20 with a link or hyperlink to the instructional facility communication device(s) 30 associated with or used by each Krav Maga school or center registered with the apparatus 100 in order to facilitate a connection or communication link with and between the user communication device 20 and the respective instructional facility communication device(s) 30 associated with or used by the user's or individual's Krav Maga school or center or any other selected Krav Maga school or center. In this regard, a class, lesson, or seminar can be transmitted to the user communication device 20 from the central processing computer 10 and/or the class, lesson, or seminar can be transmitted to the user communication device 20 from the instructional facility communication device 30 of the Krav Maga school or center broadcasting or transmitting the class, lesson, or seminar pursuant to the user's or individual's request.

At step 904, the central processing computer 10, or the instructional facility communication device(s) 30 associated with or used by each Krav Maga school or center from which a class, lesson, or seminar has been requested, can start the remote learning session and can transmit the live Krav Maga class, lesson, or seminar or the recorded Krav Maga class, lesson, or seminar, whichever is selected, to the user communication device 20, or to any other computer or communication device 20 being used by the user or individual, in order to allow the user or individual to view, attend, or participate in, the class or the lesson either being offered by or provided by the user's or the individual's Krav Maga school or center or offered by or provided by any other Krav Maga school of center selected by the user or individual. In a preferred embodiment, the live and/or recorded class, lesson, or seminar can be transmitted to the user communication device 20, or any other computer or communication device 20 used by the user or individual, from or via the central processing computer 10 or from or via the instructional facility communication device 30 associated with or used by the user's or individual's Krav Maga school or center, or from or via the instructional facility communication device 30 associated with or used by any other selected Krav Maga school or center.

In a preferred embodiment, at step 904, if a single class, lesson, or seminar is selected by the user or individual, that class, lesson, or seminar will be transmitted to the user's or individual's user communication device 20. If more than one class, lesson, or seminar is selected by the user or individual, each class, lesson, or seminar can be transmitted to the user's or individual's user communication device 20, one at a time, or simultaneously, so as to be viewed in split screen format via the display device 20E of the user's or individual's user communication device 20.

In a preferred embodiment, any selected live or recorded class(es) or lesson(s) can be transmitted to the user communication device 20, or any other computer or communication device 20 used by the user or individual, from or via the central processing computer 10 or from or via the instructional facility communication device 30 associated with or used by the user's or individual's Krav Maga school or center or by the other selected Krav Maga school or center, in any appropriate sequence selected by the user or individual. In a preferred embodiment, at step 904, a live class, lesson, or seminar can be transmitted to the user communication device 20 so as to allow the user or individual to view, attend, or participate in, a live class, lesson, or seminar either at or with his or her Krav Maga school or center or at or with any other Krav Maga school or center. In another preferred embodiment, at step 904, the user or individual can view a recorded class, lesson, or seminar provided by his or her Krav Maga school or center or provided by any other Krav Maga school or center. In a preferred embodiment, at step 904, the user or individual can be provided with one or more live broadcasts of classes, lessons, or seminars or with any one or more of recorded classes, lessons, or seminars provided or offered by his or her Krav Maga school or center or provided or offered by any other Krav Maga school or center.

At step 904, the user or individual can view, attend, or participate in, any one of, or all of, any selected classes, lessons, or seminars. At any time during step 904, the user or individual can terminate his or her remote learning session upon a conclusion of a class, lesson, or seminar, upon the conclusion of all classes, lessons, or seminars, or during any viewing, attending, or participation in, any class, lesson, or seminar, or at any time or for any reason. Once the remote learning session has been terminated, the operation of the apparatus 100 will proceed to step 905.

At step 905, the central processing computer 10 will record and store any and/or data and/or information regarding the remote learning session by recording and storing any data and/or information regarding the user or individual, the time of the remote learning session, the duration of the remote learning session, the Krav Maga school or center or the Krav Maga schools or centers from which any class(es) or lesson(s) were viewed, attended, or participated in, by the user or individual during the remote learning session, and/or the particular time(s)/and/or date, of each respective class, lesson, or seminar viewed, attended, or participated in, and/or any materials or techniques covered by same, by the user or individual, and/or the Krav Maga school or center providing or offering same, during the remote learning session.

At step 906, the central processing computer 10 can store any of the data and/or information, described as being recorded and stored at step 905, in the user's or individual's instructional record or educational record. Thereafter, the operation of the apparatus 100 will cease at step 907.

In another preferred embodiment, in a case where the user communication device 20 is linked to or with the an instructional facility communication device 30 during the session, the instructional facility communication device 30 can also record and store, in the user's or individual's instructional record or education record in the database 30H of same, any data and/or information, described herein as being recorded and stored by the central processing computer 10 at step 905, regarding the user or individual, the time of the remote learning session, the duration of the remote learning session, and/or the class(es) or lesson(s) viewed, attended, or participated in, by the user or individual. Thereafter, the instructional facility communication device 30 can automatically transmit or upload any data and/or information recorded and stored by same to the central processing computer 10 for storage in the user's or individual's instructional record or education record stored in the database 10H.

Although described and illustrated as being utilizing in connection or in conjunction with providing Krav Maga instruction, it is to be understood that the apparatus 100 of the present invention and, in particular, the apparatus of FIGS. 9A and 9B, can be utilized in a same, a similar, and/or an analogous, manner in providing any of the herein-described and various types or kinds of exercise activities, fitness activities, work-out activities, strength and conditioning activities, any type or kinds or sports or athletic activities, aerobics activities, weight training activities, cross training activities, callisthenic activities, Pilates activities, Yoga activities, meditation activities, Tai Chi activities, boxing, wrestling, kickboxing, cheerleading, martial arts activities, including, but not limited to, Krav Maga (Israeli martial arts), Karate, Kung Fu, Judo, Jujitsu, Kick Boxing, Mixed Martial Arts, Muy Tai, Brazilian Jujitsu, Savate, and any other type or kind of martial arts, as well as any other type or kind of physical activities, exercise activities, fitness activities, or wellness activities, and/or in connection with and/or in conjunction with providing or offering of any types or kinds of instructional services and/or educational services in and for any types of kinds of academic subjects, classes, courses, diploma programs, degree programs, certificate programs, or continuing education programs, and/or any other informational, instructional, or educational, programs or activities, provided by or offered by any instructional and/or educational school, institution, facility, college, university, professional school continuing education institution, or any other learning institution or facility.

In another preferred embodiment, the apparatus 100 and method of the present invention can be utilized in order to provide exclusively online instructional services and/or exclusively online educational services. In such a preferred embodiment, the user or individual can enroll or register as a student or as a member with one instructional facility, educational facility, training facility, gym, health club, country club, fitness center, wellness center, athletic training center or facility, physical education school or center, martial arts school, or exercise school or center, or school, college, university, trade school, tutor, and/or instructor, in order to study or train, or engage in, any type of kind of exercise activities, fitness activities, work-out activities, strength and conditioning activities, any type or kinds or sports or athletic activities, aerobics activities, weight training activities, cross training activities, callisthenic activities, Pilates activities, Yoga activities, meditation activities, Tai Chi activities, boxing, wrestling, kickboxing, cheerleading, martial arts activities, including, but not limited to, Krav Maga (Israeli martial arts), Karate, Kung Fu, Judo, Jujitsu, Kick Boxing, Mixed Martial Arts, Muy Tai, Brazilian Jujitsu, Savate, and any other type or kind of martial arts, as well as any other type or kind of physical activities, exercise activities, fitness activities, or wellness activities, or in order to enroll in and/or engage in instructional services and/or educational services in and for any type of kind of academic subjects, classes, courses, diploma programs, degree programs, certificate programs, or continuing education programs, and/or any other informational, instructional, or educational programs or activities, in an exclusively on-line environment.

In a preferred embodiment, the user or individual can enroll in or register with, or become a student or a member of an instructional facility, educational facility, training facility, gym, health club, country club, fitness center, wellness center, athletic training center or facility, physical education school or center, martial arts school, or exercise school or center, or school, college, university, trade school, tutor, and/or instructor (hereinafter the “primary instruction provider”), and can view, attend, or participate in, classes, courses, lessons, or seminars, with that an instructional facility, educational facility, training facility, gym, health club, country club, fitness center, wellness center, athletic training center or facility, physical education school or center, martial arts school, or exercise school or center, or school, college, university, trade school, tutor, and/or instructor, as well any other instructional facility or facilities, educational facility or facilities, training facility or facilities, gym or gyms, health club(s), country club(s), fitness center(s), wellness center(s), athletic training center(s) or facility or facilities, physical education school(s) or center(s), martial arts school(s), or exercise school(s) or center(s), or school(s), college(s), university or universities, trade school(s), tutor(s), and/or instructor(s) (hereinafter the “secondary instruction provider”).

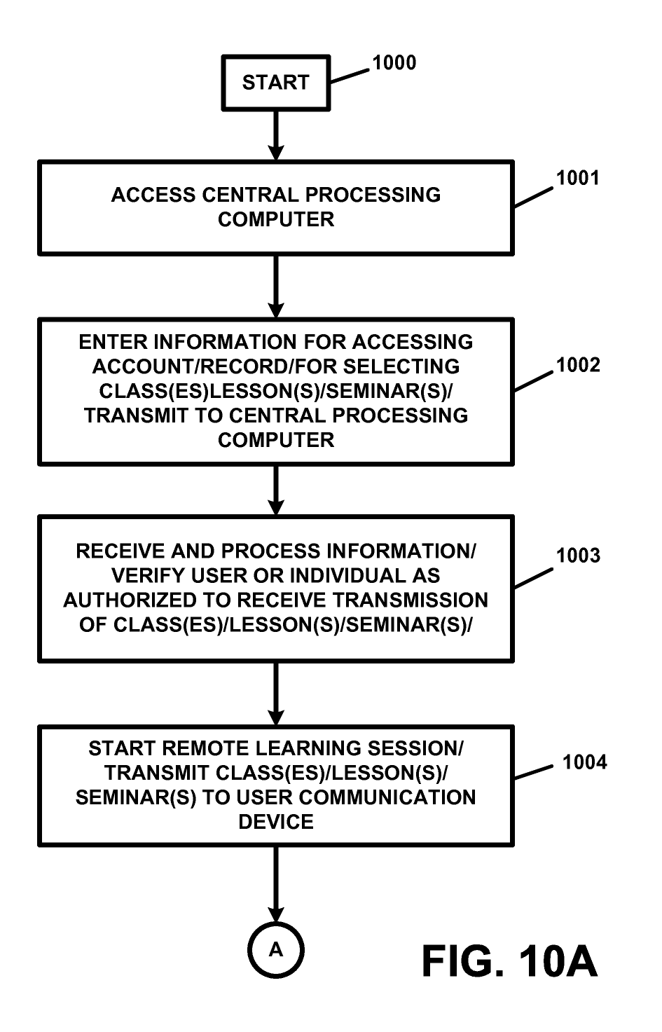

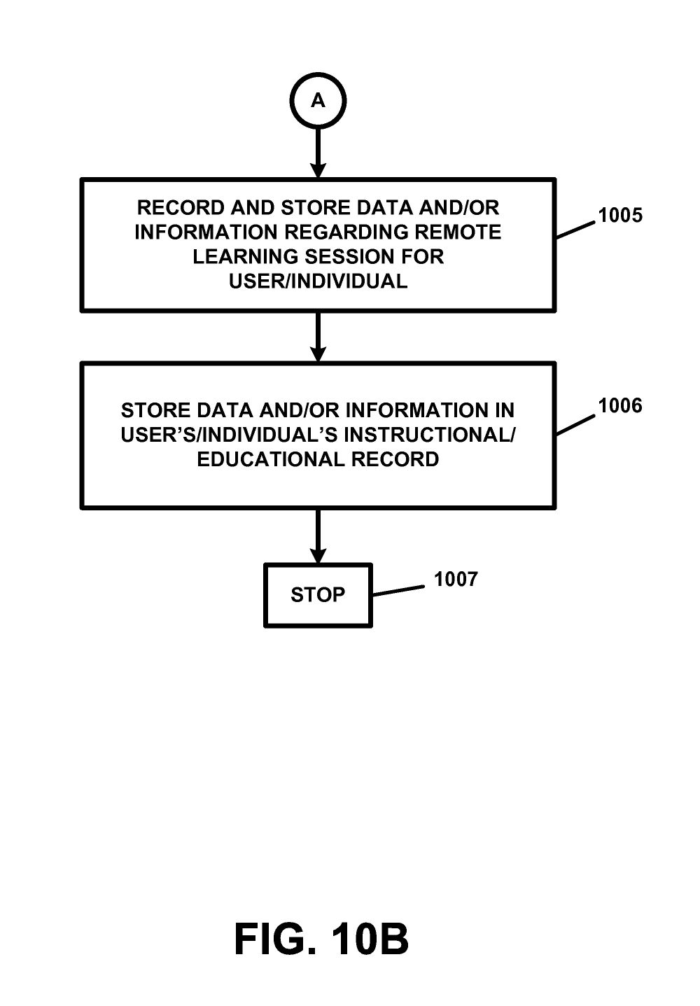

FIGS. 10A and 10B illustrate a preferred embodiment method for utilizing the apparatus 100 of the present invention, in flow diagram form. In a preferred embodiment, the operation of the apparatus 100 and method of the present invention can be described as being utilized by a user or individual who is enrolled or registered with a primary martial arts school in order to study Krav Maga remotely at that martial arts school as well as at or with any other martial arts school that teaches Krav Maga or offers Krav Maga training and which also offers same via, and/or which utilizes, the apparatus 100 of the present invention. Although described and illustrated as being utilized in connection with Krav Maga martial arts instruction, it is important to note that the embodiment of FIGS. 10A and 10B can also be utilized in a same, a similar, and/or an analogous, manner, in connection with and/or in conjunction with providing exclusively on-line or distance learning in or with any of the herein-described and various types or kinds of exercise activities, fitness activities, work-out activities, strength and conditioning activities, any type or kinds or sports or athletic activities, aerobics activities, weight training activities, cross training activities, callisthenic activities, Pilates activities, Yoga activities, meditation activities, Tai Chi activities, boxing, wrestling, kickboxing, cheerleading, martial arts activities, including, but not limited to, Krav Maga (Israeli martial arts), Karate, Kung Fu, Judo, Jujitsu, Kick Boxing, Mixed Martial Arts, Muy Tai, Brazilian Jujitsu, Savate, and in or with any other type or kind of martial arts, as well as any other type or kind of physical activities, exercise activities, fitness activities, or wellness activities, and/or in connection with and/or in conjunction with providing exclusively on-line or distance learning in or with the providing or offering of any types or kinds of instructional services and/or educational services in and for any types of kinds of academic subjects, classes, courses, diploma programs, degree programs, certificate programs, or continuing education programs, and/or any other informational, instructional, or educational, programs or activities, provided by or offered by any instructional and/or educational school, institution, facility, college, university, professional school continuing education institution, or any other learning institution or facility.

With reference once again to FIGS. 10A and 10B, in the preferred embodiment, the user or individual can be a member of, a student of, or be enrolled in a Krav Maga school or center where he or she can attend Krav Maga classes exclusively on-line or remotely and which is referred to as his or her primary instruction provider. In the preferred embodiment, the user or individual can also have an instructional record or education record which reflects his or her being a member or, a student of, or being enrolled in or with, the primary instruction provider. In a preferred embodiment, any information regarding the user's or the individual's attendance at classes, advancement through the program, belt or rank level, any other Krav Maga schools or centers, which are referred to as his or her secondary instruction providers, where the user or individual can also study Krav Maga remotely, and/or any other data and/or information regarding the user or individual can be stored in the user's or individual's instructional record or education record stored in the database 10H and in the database 30H of the instructional facility communication device 30 of or associated with the primary instruction provider and any secondary instruction provider.

In the preferred embodiment of FIGS. 10A and 10B, the user or individual can be provided with his or her Krav Maga training by viewing, attending, or participating in, classes offered or provided remotely by his or her primary instruction provider, via the apparatus 100 of the present invention, and/or by viewing, attending, or participating in, classes offered or provided remotely by any of the secondary instruction providers which make their classes available remotely via the apparatus 100 of the present invention. In this regard, the apparatus 100 can be utilized to allow the user or individual to engage in exclusively remote training with the primary instruction provider and any secondary instruction provider by viewing, attending, or participating in, a Krav Maga class(es) or lesson(s) remotely via the apparatus 100 of the present invention.

With reference to FIGS. 10A and 10B, the operation of the apparatus 100 commences at step 1000. At step 1001, the user or individual can access the central processing computer 10 via his or her user communication device 20, and/or via any communication device 20 available to the user or individual, in order request a remote learning session. For example, if the user or individual is traveling, he or she can utilize a communication device 20, such as computer in a hotel business center or a television in a hotel room which can be capable of connecting to the Internet and/or the World Wide Web or to any other suitable communication network.

At step 1002, the user or individual can input or enter any login information to gain access to the central processing computer 10, and/or to gain access to his or her account and/or to gain access to his or her instructional record or educational record. At step 1002, the user or individual can also input or enter any data and/or information for selecting and/or for accessing the class, lesson, or seminar offered by or provided by his or her primary instruction provider or any secondary instruction provider. At step 1002, any data and/or information input or entered by the user or individual can be transmitted to the central processing computer 10. In a preferred embodiment, the central processing computer 10 can provide and/or can transmit to the user communication device 20 any data and/or information needed or desired for allowing the user or individual to input or enter any data or information described herein as being input or entered by the user or individual at step 1002.

For example, the central processing computer 10 can provide the user or individual with class schedule(s) for classes, lessons, or seminars at his or her primary instruction provider at that time, or on that day, as well as any information regarding any class, lesson, or seminar plan, agenda, or syllabus, material to be covered or planned to be covered in, during, and/or for, each class, lesson, or seminar, the instructor or trainer for each class, lesson, or seminar, and/or any materials or techniques planned to be covered or taught in or during that class, lesson, or seminar. The central processing computer 10 can provide the user or individual with information regarding live classes, lessons, or seminars which are available at that time or on that day, as well as provide information regarding any recordings of any classes prior to that time, available at that time, or available on that day, along with any information about these recorded classes, lessons, or seminars. At step 1002, the user or individual can input or enter any data and/or information requesting to receive any number of live classes, lessons, or seminars, and/or any recorded classes, lessons, or seminars, from his or her primary instruction provider, or from any one or more of his or her secondary instruction providers, or any other Krav Maga schools or centers, from which he or she wants to receive classes, lessons, or seminars. At step 1002, in the case when multiple classes, lessons, or seminars are requested, the user or individual can also select any sequence or order for receiving same.

In a preferred embodiment, only a single class, lesson, or seminar, can be selected. In another embodiment, any number of classes, lessons, or seminars, can be selected.

At step 1003, the central processing computer 10 can receive and process any data and/or information which is input or entered by the user or individual at step 1002. In a preferred embodiment, the central processing computer 10 can verify that the user or individual is a student or member of the primary instruction provider or any secondary instruction providers or can verify that the user or individual is a registered user, student, or member, of the apparatus 100 of the present invention and/or of any instructional facilities, educational facilities, training facilities, gyms, health clubs, country clubs, fitness centers, wellness centers, athletic training centers or facilities, physical education schools or centers, martial arts schools, or exercise schools or centers, or schools, colleges, universities, trade schools, tutors, and/or instructors, registered with the apparatus 100 of the present invention.

In a preferred embodiment, the central processing computer 10 and, in particular, the database 10H of same can be a repository of any and/or all recorded classes, lessons, or seminars of each Krav Maga school or center registered with the apparatus 100.

In a preferred embodiment, the central processing computer 10 is capable of broadcasting, and/or receiving and storing, live broadcasts of classes and lessons broadcast by or transmitted by or from the instructional facility communication device(s) 30 of or associated with the primary instruction provider, any secondary instruction providers, and/or each Krav Maga school or center registered with the apparatus 100. In another preferred embodiment, the central processing computer 10 can also provide the user communication device 20 with a link or hyperlink to the instructional facility communication device(s) 30 associated with or used by the primary instruction provider, any secondary instruction providers, and/or each Krav Maga school or center registered with the apparatus 100 in order to facilitate a connection or communication link with and between the user communication device 20 and the respective instructional facility communication device(s) 30 associated with or used by the user's or individual's primary instruction provider, any secondary instruction providers, and/or each Krav Maga school or center or any other selected Krav Maga school or center. In this regard, a class, lesson, or seminar can be transmitted to the user communication device 20 from the central processing computer 10 and/or the class, lesson, or seminar can be transmitted to the user communication device 20 from the instructional facility communication device 30 of the primary instruction provider, any secondary instruction providers, and/or each Krav Maga school or center broadcasting or transmitting the class, lesson, or seminar pursuant to the user's or individual's request.

At step 1004, the central processing computer 10, or the instructional facility communication device(s) 30 associated with or used by the primary instruction provider, any secondary instruction providers, and/or each Krav Maga school or center from which a class, lesson, or seminar has been requested, can start the remote learning session and can transmit the live Krav Maga class, lesson, or seminar or the recorded Krav Maga class, lesson, or seminar, whichever is selected, to the user communication device 20, or to any other computer or communication device 20 being used by the user or individual, in order to allow the user or individual to view, attend, or participate in, the class or the lesson either being offered by or provided by the user's or the individual's the primary instruction provider, any secondary instruction providers, and/or each Krav Maga school or center or offered by or provided by any other Krav Maga school of center selected by the user or individual. In a preferred embodiment, the live and/or recorded class, lesson, or seminar can be transmitted to the user communication device 20, or any other computer or communication device 20 used by the user or individual, from or via the central processing computer 10 or from or via the respective instructional facility communication device 30 associated with or used by the user's or individual's the primary instruction provider, or any secondary instruction providers, and/or from or via the instructional facility communication device 30 associated with or used by any other selected Krav Maga school or center.

In a preferred embodiment, at step 1004, if a single class, lesson, or seminar is selected by the user or individual, that class, lesson, or seminar will be transmitted to the user's or individual's user communication device 20. If more than one class, lesson, or seminar is selected by the user or individual, each class, lesson, or seminar can be transmitted to the user's or individual's user communication device 20, one at a time, or simultaneously, so as to be viewed in split screen format via the display device 20E of the user's or individual's user communication device 20.

In a preferred embodiment, any selected live or recorded class(es) or lesson(s) can be transmitted to the user communication device 20, or any other computer or communication device 20 used by the user or individual, from or via the central processing computer 10 or from or via the instructional facility communication device 30 associated with or used by the user's or individual's the primary instruction provider or any secondary instruction providers, in any appropriate sequence selected by the user or individual. In a preferred embodiment, at step 1004, a live class, lesson, or seminar can be transmitted to the user communication device 20 so as to allow the user or individual to view, attend, or participate in, a live class, lesson, or seminar either at or with his or her the primary instruction provider or any secondary instruction providers. In another preferred embodiment, at step 1004, the user or individual can view a recorded class, lesson, or seminar provided by his or her primary instruction provider or any secondary instruction providers. In a preferred embodiment, at step 1004, the user or individual can be provided with one or more live broadcasts of classes, lessons, or seminars or with any one or more of recorded classes, lessons, or seminars provided or offered by his or her primary instruction provider or any secondary instruction providers.

At step 1004, the user or individual can view, attend, or participate in, any one of, or all of, any selected classes, lessons, or seminars. At any time during step 1004, the user or individual can terminate his or her remote learning session upon a conclusion of a class, lesson, or seminar, upon the conclusion of all classes, lessons, or seminars, or during any viewing, attending, or participation in, any class, lesson, or seminar, or at any time or for any reason. Once the remote learning session has been terminated, the operation of the apparatus 100 will proceed to step 1005.

At step 1005, the central processing computer 10 will record and store any data and/or information regarding the remote learning session by recording and storing any data and/or information regarding the user or individual, the time of the remote learning session, the duration of the remote learning session, the primary instruction provider and/or any secondary instruction providers from which any class(es) or lesson(s) were viewed, attended, or participated in, by the user or individual during the remote learning session, and/or the particular time(s)/and/or date, of each respective class, lesson, or seminar viewed, attended, or participated in, and/or any materials or techniques covered by same, by the user or individual, and/or the primary instruction provider and/or any secondary instruction providers providing or offering same, during the remote learning session.

At step 1006, the central processing computer 10 can store any of the data and/or information, described as being recorded and stored at step 1005, in the user's or individual's instructional record or educational record. Thereafter, the operation of the apparatus 100 will cease at step 1007.

In another preferred embodiment, in a case where the user communication device 20 is linked to or with any instructional facility communication device 30 during the session, the instructional facility communication device 30 can also record and store, in the user's or individual's instructional record or education record in the database 30H of same, any data and/or information, described herein as being recorded and stored by the central processing computer 10 at step 1005, regarding the user or individual, the time of the remote learning session, the duration of the remote learning session, and/or the class(es) or lesson(s) viewed, attended, or participated in, by the user or individual. Thereafter, the instructional facility communication device 30 can automatically transmit or upload any data and/or information recorded and stored by same to the central processing computer 10 for storage in the user's or individual's instructional record or education record stored in the database 10H.

Although described and illustrated as being utilizing in connection or in conjunction with providing Krav Maga instruction, it is to be understood that the apparatus 100 of the present invention and, in particular, the apparatus of FIGS. 10A and 10B, can be utilized in a same, a similar, and/or an analogous, manner in providing any of the herein-described and various types or kinds of exercise activities, fitness activities, work-out activities, strength and conditioning activities, any type or kinds or sports or athletic activities, aerobics activities, weight training activities, cross training activities, callisthenic activities, Pilates activities, Yoga activities, meditation activities, Tai Chi activities, boxing, wrestling, kickboxing, cheerleading, martial arts activities, including, but not limited to, Krav Maga (Israeli martial arts), Karate, Kung Fu, Judo, Jujitsu, Kick Boxing, Mixed Martial Arts, Muy Tai, Brazilian Jujitsu, Savate, and any other type or kind of martial arts, as well as any other type or kind of physical activities, exercise activities, fitness activities, or wellness activities, and/or in connection with and/or in conjunction with providing or offering of any types or kinds of instructional services and/or educational services in and for any types of kinds of academic subjects, classes, courses, diploma programs, degree programs, certificate programs, or continuing education programs, and/or any other informational, instructional, or educational, programs or activities, provided by or offered by any instructional and/or educational school, institution, facility, college, university, professional school continuing education institution, or any other learning institution or facility.

In another preferred embodiment, the apparatus 100 and method of the present invention can be utilized in order to allow a user or individual to view, attend, or participate in, a class, lesson, or seminar, with any number of friends, fellow students, or workout partners. In such a preferred embodiment, each of the user or individual and any and/or all of his or her friends, fellow students, or workout partners can each utilize a user communication device 20 and the video and/or audio recording device(s) 20J which can include a camera and/or a video recording device, and a microphone or an audio recording device, of same, and any appropriate video conferencing software and/or hardware, in order to engage in a video conference with each other during the class, lesson, or seminar. In a preferred embodiment, the video and/or audio information which is recorded and provided by each user communication device 20 can be provided, along with the video and/or audio of the class, the lesson, or the seminar, in a split screen format or in a multiple screen format on the display device of each user communication device 20 used by the user or individual and each friend, fellow student, or workout partner so that the user or individual, and each friend, fellow student, or workout partner can view, hear, and speak with, each other during the class, the lesson, or the seminar, in a split screen format or a multiple screen format while viewing, attending, or participating in, the class, lesson, or seminar. In this regard, the user or individual, and any number of friends, fellow students, or workout partners, can video conference with each other while viewing, attending, or participating in, a class, a lesson, or a seminar.

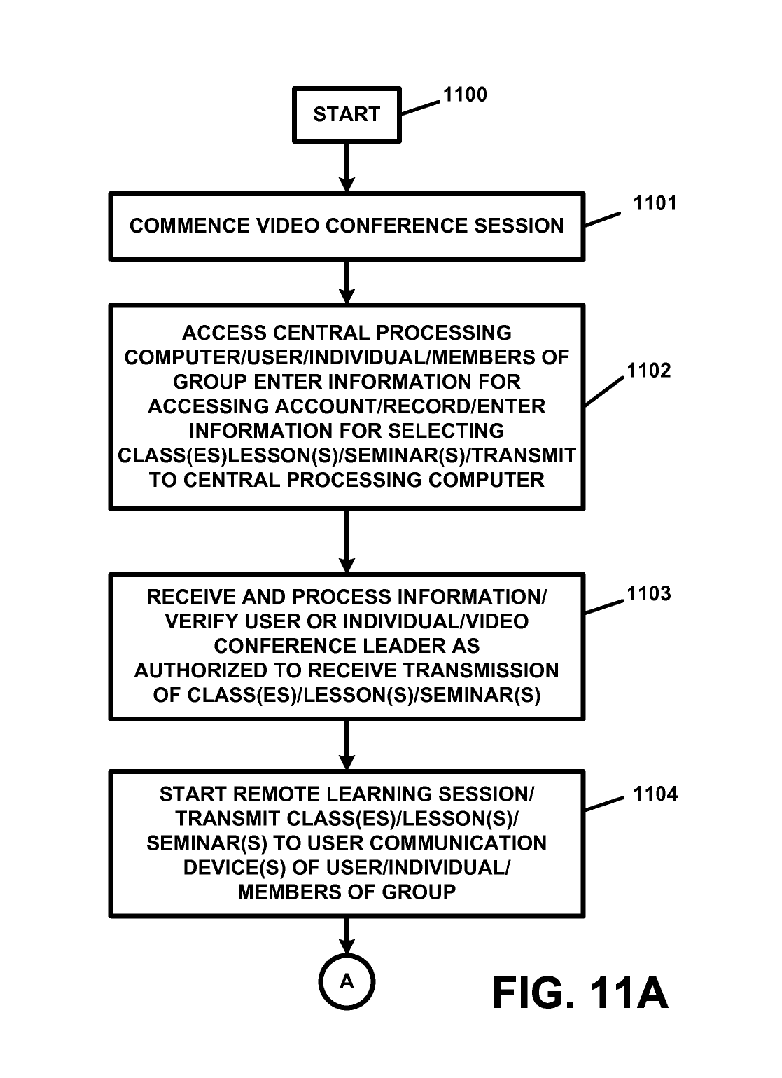

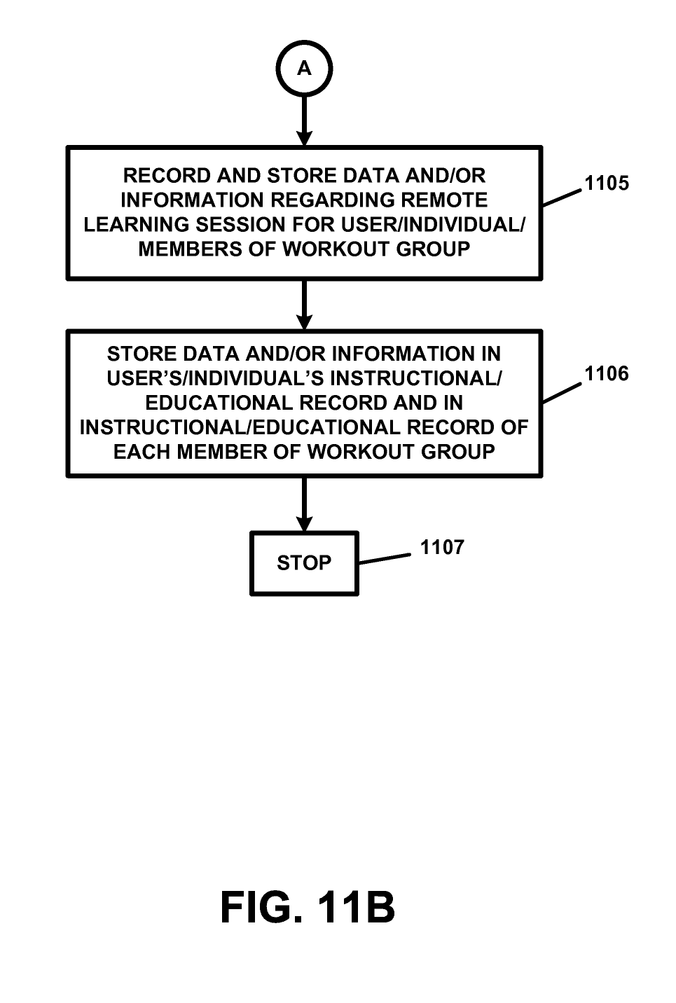

FIGS. 11A and 11B illustrate a preferred embodiment method for utilizing the apparatus 100 of the present invention, in flow diagram form. In a preferred embodiment, the operation of the apparatus 100 and method of the present invention can be described as being utilized by a user or individual who may be enrolled or registered with a martial arts school in order to study Krav Maga, and any number of his or her friends, fellow students, or workout partners, each of whom may or may not be so enrolled or registered, to remotely view, attend, or participate in a Krav Maga class, lesson, or seminar. Although described and illustrated as being utilized in connection with Krav Maga martial arts instruction, it is important to note that the embodiment of FIGS. 11A and 11B can be utilized in a same, a similar, and/or an analogous, manner in connection with and/or in conjunction with any of the herein-described and various types or kinds of exercise activities, fitness activities, work-out activities, strength and conditioning activities, any type or kinds or sports or athletic activities, aerobics activities, weight training activities, cross training activities, callisthenic activities, Pilates activities, Yoga activities, meditation activities, Tai Chi activities, boxing, wrestling, kickboxing, cheerleading, martial arts activities, including, but not limited to, Krav Maga (Israeli martial arts), Karate, Kung Fu, Judo, Jujitsu, Kick Boxing, Mixed Martial Arts, Muy Tai, Brazilian Jujitsu, Savate, and any other type or kind of martial arts, as well as any other type or kind of physical activities, exercise activities, fitness activities, or wellness activities, and/or in connection with and/or in conjunction with the providing or offering of any types or kinds of instructional services and/or educational services in and for any types of kinds of academic subjects, classes, courses, diploma programs, degree programs, certificate programs, or continuing education programs, and/or any other informational, instructional, or educational, programs or activities, provided by or offered by any instructional and/or educational school, institution, facility, college, university, professional school continuing education institution, or any other learning institution or facility.

With reference once again to FIGS. 11A and 11B, in the preferred embodiment, the user or individual can be a member of, a student of, or be enrolled in a Krav Maga school or center. In the preferred embodiment, the user or individual, as well as any of his or her friends, fellow students, or workout partners, can also have an instructional record or education record which reflects his or her or their being a user or member of, or as being registered, to use the apparatus 100 of the present invention. In a preferred embodiment, any information regarding the user's or individual's, or any of his or her friends, fellow students, or workout partners, viewing or attendance at classes, advancement through the program, belt or rank level, any other Krav Maga schools or centers where the user or individual, or any of his or her friends, fellow students, or workout partners, study Krav Maga either in-person or remotely, and/or any other data and/or information regarding the user or individual, or any of his or her friends, fellow students, or workout partners, can be stored in the respective user's or individual's, or any of his or her friend's, fellow student's, or workout partner's, instructional record or education record stored in the database 10H and in the database 30H of the instructional facility communication device 30 of or associated with the Krav Maga school or center in which the user or individual, or any of his or her friends, fellow students, or workout partners, has viewed, attended, or participated in, any classes, lessons, or seminars.

With reference to FIGS. 11A and 11B, the operation of the apparatus 100 commences at step 1100. At step 901, in a preferred embodiment, the user or individual and any and/or all of his or her friends, fellow students, or workout partners, can commence a video conference session so that they can join a video conference together, as a student group or workout group, by utilizing each of their respective user communication devices 20. Once in the video conference session, the user or individual, or any friend, fellow student, or workout partner, who is acting as the video conference leader, can access the central processing computer 10 for the student group or the workout group.

At step 1102, the user or individual or the video conference leader can input or enter any login information to gain access to the central processing computer 10, and/or to gain access to his or her account and/or to gain access to his or her instructional record or educational record. At step 1102, any member of the student group or workout group can also access his or he access to his or her instructional record or educational record. At step 1102, the user or individual or the video conference leader can also input or enter any data and/or information for identifying each user, individual, or member, of the study group or the workout group and any data and/or information needed for allowing the central processing computer 10 to identify each user, individual, or member, of the study group or the workout group, as well as any IP address or other information for identifying the user communication device 20 of or being used by each user, individual, or member, of the study group or the workout group. At step 1102, the user or individual or the video conference leader can also input or enter any data and/or information for selecting and/or for accessing the class, lesson, or seminar, offered by or provided by his or her Krav Maga school or center, or the user or individual or the video conference leader can also input or enter any data and/or information for selecting and/or accessing the class, lesson, or seminar, offered by or provided by any other Krav Maga school or center. At step 1102, any data and/or information input or entered by the user or individual o the video conference leader can be transmitted to the central processing computer 10. In a preferred embodiment, the central processing computer 10 can provide and/or can transmit to the user's or individual's or the video conference leader's user communication device 20 any data and/or information needed or desired for allowing the user or individual or video conference leader to input or enter any data or information described herein as being input or entered by the user or individual or video conference leader at step 1102.

For example, the central processing computer 10 can provide the user or individual or the video conference leader with class schedule(s) for classes, lessons, or seminars, at his or her Krav Maga school or center at that time, or on that day, as well as any information regarding any class, lesson, or seminar plan, agenda, or syllabus, material to be covered or planned to be covered in, during, and/or for, each class, lesson, or seminar, the instructor or trainer for each class, lesson, or seminar, and/or any materials or techniques planned to be covered or taught in or during that class, lesson, or seminar. The central processing computer 10 can provide the user or individual or the video conference leader with information regarding live classes, lessons, or seminars, which are available at that time or on that day, as well as provide information regarding any recordings of any classes prior to that time, available at that time, or available on that day, along with any information about these recorded classes, lessons, or seminars. At step 1102, the user or individual or the video conference leader can input or enter any data and/or information requesting to receive any number of live classes, lessons, or seminars, and/or any recorded classes, lessons, or seminars, from his or her Krav Maga school or center, or from any one or more of any other Krav Maga schools or centers in which he or she is a student or member, and/or from any other Krav Maga school(s) or center(s) from which he or she wants to receive classes, lessons, or seminars. At step 1102, in the case when multiple classes, lessons, or seminars are requested, the user or individual or the video conference leader can also select any sequence or order for receiving same. In a preferred embodiment, only a single class, lesson, or seminar, can be selected. In another embodiment, any number of classes, lessons, or seminars, can be selected.

At step 1103, the central processing computer 10 can receive and process any data and/or information which is input or entered by the user or individual or the video conference leader at step 1102. In a preferred embodiment, the central processing computer 10 can verify that the user or individual or video conference leader is a student or member of the Krav Maga school or center or can verify that the user or individual or video conference leader is a registered user, student, or member, of the apparatus 100 of the present invention and/or of any instructional facilities, educational facilities, training facilities, gyms, health clubs, country clubs, fitness centers, wellness centers, athletic training centers or facilities, physical education schools or centers, martial arts schools, or exercise schools or centers, or schools, colleges, universities, trade schools, tutors, and/or instructors, registered with the apparatus 100 of the present invention.

In a preferred embodiment, the central processing computer 10 and, in particular, the database 10H of same can be a repository of any and/or all recorded classes, lessons, or seminars of each Krav Maga school or center registered with the apparatus 100.

In a preferred embodiment, the central processing computer 10 is capable of broadcasting, and/or receiving and storing, live broadcasts of classes and lessons broadcast by or transmitted by or from the instructional facility communication device(s) 30 of or associated with each Krav Maga school or center registered with the apparatus 100. In another preferred embodiment, the central processing computer 10 can also provide each user communication device 20 used by each user, individual, or member, of the study group or the workout group with a link or hyperlink to the instructional facility communication device(s) 30 associated with or used by each Krav Maga school or center registered with the apparatus 100 in order to facilitate a connection or communication link with and between the user communication device 20 and the respective instructional facility communication device(s) 30 associated with or used by the user's or individual's or the video conference leader's Krav Maga school or center or any other selected Krav Maga school or center. In this regard, a class, lesson, or seminar, can be transmitted to the user communication device 20 from the central processing computer 10 and/or the class, lesson, or seminar can be transmitted to the user communication device 20 from the instructional facility communication device 30 of the Krav Maga school or center broadcasting or transmitting the class, lesson, or seminar.

At step 1104, the central processing computer 10, or the instructional facility communication device(s) 30 associated with or used by each the Krav Maga school or center from which the class, lesson, or seminar, is being provided or offered, can start the remote learning session and can transmit the live Krav Maga class, lesson, or seminar, or the recorded Krav Maga class, lesson, or seminar, whichever is selected, to the user communication device 20 of or being used by the user or individual and to the user communication device 20 of or used by each of the user's or individual's friends, fellow students, or workout partners, in or of the study group or the workout group.

At step 1104, the class, lesson, or seminar, can be transmitted to and provided to each user communication device 20 of or being used by the user or individual and each friend, fellow student, or workout partner in or of the study group or workout group. During step 1104, each user communication device 20 can also record and transmit video and/or audio information, and/or video conferencing information, which is obtained and/or recorded by the respective video and/or audio recording device(s) 20J of each respective communication device 20 of or being used by the user or individual and each friend, fellow student, or workout partner in or of the study group or workout group, to the communication device 20 of or being used by the user or individual and to each communication device 20 of each friend, fellow student, or workout partner, in or of the study group or workout group, in order to allow the students or members of the workout group to video conference with each other while viewing, attending, or participating in, the class, lesson, or seminar.

In a preferred embodiment, the user or the individual and any one or more of the friends, fellow students, or workout partners can position the video and/or audio recording device(s) 20J of his or her respective communication device 20 so that they can be seen and spoken to while the class, lesson, or seminar is being aired or viewed. In a preferred embodiment, the class, lesson, or seminar, and the video conferencing images, video, and/or audio of each of the user or individual and each friend, fellow student, or workout partner, can be provided in split screen format or multiple screen format on the display device 20E of each respective user communication device 20 so that each of the user or individual and each friend, fellow student, or workout partner, can view the class, lesson, or seminar, and each other during the class, lesson, or seminar. In this regard, the apparatus 100 of the present invention can be utilized in order to allow the user or individual to remotely view, attend, or participate in, a Krav Maga class with any number of friends, fellow students, or workout partners.

Once the class, lesson, or seminar, has been completed, the user or individual, at step 1104 can be provided with the opportunity to discuss the class, lesson, or seminar, or other participate in any other discussion prior to ending or ceasing the video conference session. Once the video conferencing session has been terminated, the operation of the apparatus 100 will proceed to step 1105.

At step 1105, the central processing computer 10 will record and store any and/or data and/or information, regarding the remote learning session which took place involving or via the video conference session, by recording and storing any data and/or information regarding the user or individual and/or any friend, fellow student, or workout partner, who participated in the video conference session, the time of the video conference session and the remote learning session, the duration of the video conference session and the remote learning session, the Krav Maga school or center from which the class, lesson, or seminar, was provided, the particular time(s)/and/or date, of the class, lesson, or seminar, and/or any materials or techniques covered by or during the class, lesson, or seminar.

At step 1106, the central processing computer 10 can store any of the data and/or information, described as being recorded and stored at step 1105, in the user's or individual's instructional record or educational record and/or in the instructional record or the educational record of each friend, fellow student, or workout partner, who participated in the video conference session. Thereafter, the operation of the apparatus 100 will cease at step 1107.

In another preferred embodiment, in a case where any or each user communication device 20 is linked to or with the an instructional facility communication device 30 during the video conferencing session, the instructional facility communication device 30 can also record and store, in the user's or individual's instructional record or education record or in the instructional record or the educational record of each friend, fellow student, or workout partner, who participated in the video conference session, in the database 30H of same, any data and/or information, described herein as being recorded and stored by the central processing computer 10 at step 1105. Thereafter, the respective instructional facility communication device 30 can automatically transmit or upload any data and/or information recorded and stored by same to the central processing computer 10 for storage in the user's or individual's instructional record or education record stored in the database 10H, or for storage in the instructional record or the educational record of each friend, fellow student, or workout partner, stored in the database 10H.

In another preferred embodiment, the apparatus 100 of the preferred embodiment of FIGS. 11A and 11B can also be utilized to allow the user or individual to participate in a remote personal training session with an instructor. In such a preferred embodiment, the instructor can utilize his or her own instructional facility communication device 30, and its associated video and/or audio recording device(s) 30J in order to engage in video conference in which the instructor can provide the user or the individual with a remotely provided private or personal Krav Maga class, lesson, or seminar. In such an embodiment, the instructor can utilize his or her, or the Krav Maga school's or center's, own instructional facility communication device 30 in order to provide video and audio instructional information to the user's or individual's user communication device 20 and can be provided with video conferencing information recorded by and provided from the user's or individual's user communication device 20.

During the remotely provided private or personal Krav Maga class, lesson, or training session, the instructor can demonstrate any techniques and/or movements to the user or individual, so as to provide instruction in and for same, and the instructor can watch and review the user's or individual's performance of same and/or performance of same and/or review the user's or individual's performance during the remotely provided private or personal Krav Maga class, lesson, or training session. During the remotely provided private or personal Krav Maga class, lesson, or training session, the instructor and the user or individual can also speak with each other and see each other via the video conference. In this regard, the apparatus 100 can be utilized to provide remote one-on-one personal training in Krav Maga. In this regard, the embodiment of FIGS. 11A and 11B can be utilized to allow the user or individual to utilize the apparatus 100 of the present invention in order to engage in private Krav Maga lessons or personal training sessions in Krav Maga.

In another preferred embodiment, the apparatus 100 of the preferred embodiment of FIGS. 11A and 11B can also be utilized to allow the user or individual, and any friend, fellow students, or workout partners, to participate in a remote personal group training session with an instructor. In such a preferred embodiment, the instructor can utilize his or her own instructional facility communication device 30, and its associated the video and/or audio recording device(s) 30J in order to engage in video conference in which the instructor can provide the user or the individual, and any friends, fellow students, or workout partners, with a remotely provided private group Krav Maga class, lesson, or seminar. In such an embodiment, the instructor can utilize his or her, or the Krav Maga school's or center's, own instructional facility communication device 30 in order to provide video and audio instructional information to the user's or individual's user communication device 20 and to each user communication device 20 of or used by each friend, fellow student, or workout partner, participating in the private group training session, and can be provided with video conferencing information recorded by and provided from the user's or individual's user communication device 20 as well as each user communication device used by each friend, fellow student, or workout partner. During the remotely provided private group Krav Maga class, lesson, or training session, the instructor can demonstrate any techniques and/or movements to the user or individual, and to the friends, fellow students, or workout partners, so as to provide instruction in and for same, and the instructor can watch and review the user's or individual's, and/or each friend's, fellow student's, or workout partner's, performance of same and/or performance of same and/or review the user's or individual's, and/or each friend's, fellow student's, or workout partner's, performance during the remotely provided private group Krav Maga class, lesson, or training session. During the remotely provided private group Krav Maga class, lesson, or training session, the instructor and the user or individual, and/or each friend, fellow student, or workout partner, can also speak with each other and see each other via the video conference. In this regard, the apparatus 100 can be utilized to provide remote private group training in Krav Maga. In this regard, the embodiment of FIGS. 11A and 11B can also be utilized to allow the user or individual, and any friend(s), fellow student(s), or workout partner(s), to utilize the apparatus 100 of the present invention in order to engage in private group Krav Maga lessons or private group training sessions in Krav Maga.

In another preferred embodiment, the embodiment of FIGS. 11A and 11B can be utilized in order to allow an instructor of the Krav Maga school of center, from which the class, lesson, or seminar is being provided, to monitor any number of users or individuals who might be viewing, attending, or participating in, the class, lesson, or seminar, and who have chosen to provide video of himself or herself participating remotely in the class, lesson, or seminar.

Although described and illustrated as being utilizing in connection or in conjunction with providing Krav Maga instruction, it is to be understood that the apparatus 100 of the present invention and, in particular, the apparatus of the various embodiments of FIGS. 11A and 11B described herein, can be utilized in a same, a similar, and/or an analogous, manner in providing any of the herein-described and various types or kinds of exercise activities, fitness activities, work-out activities, strength and conditioning activities, any type or kinds or sports or athletic activities, aerobics activities, weight training activities, cross training activities, callisthenic activities, Pilates activities, Yoga activities, meditation activities, Tai Chi activities, boxing, wrestling, kickboxing, cheerleading, martial arts activities, including, but not limited to, Krav Maga (Israeli martial arts), Karate, Kung Fu, Judo, Jujitsu, Kick Boxing, Mixed Martial Arts, Muy Tai, Brazilian Jujitsu, Savate, and any other type or kind of martial arts, as well as any other type or kind of physical activities, exercise activities, fitness activities, or wellness activities, and/or in connection with and/or in conjunction with providing or offering of any types or kinds of instructional services and/or educational services in and for any types of kinds of academic subjects, classes, courses, diploma programs, degree programs, certificate programs, or continuing education programs, and/or any other informational, instructional, or educational, programs or activities, provided by or offered by any instructional and/or educational school, institution, facility, college, university, professional school continuing education institution, or any other learning institution or facility.

In another preferred embodiment, the user or individual can record a video clip or a video recording of himself or herself performing any activity, technique, or movement, which can contain video information and audio information, with or using the video and/or audio recording device(s) 20J of a user communication device 20. Thereafter, the user of individual can transmit, or upload, the video clip or the video recording to the central processing computer 10 and/or to the instructional facility communication device 30 of or associated with the instructional facility or educational facility in which the user or individual is enrolled as a student or a member. Thereafter, any instructor of or with the instructional facility or educational facility can review the video clip or video recording and can provide any comments or notes regarding same to he user or individual.

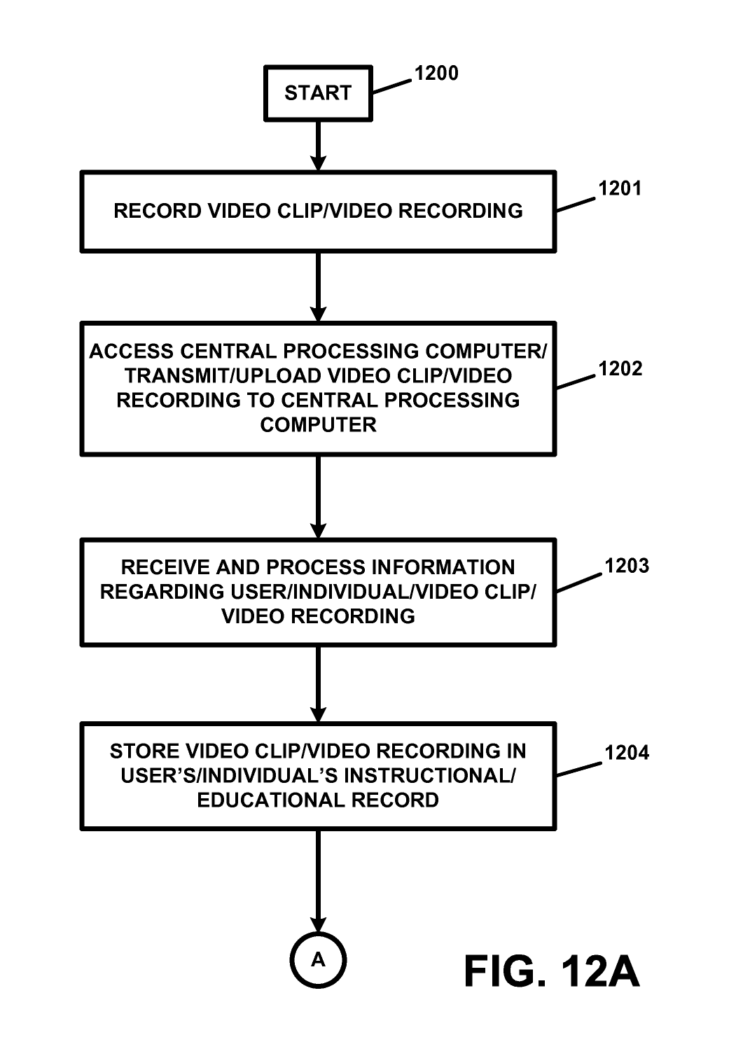

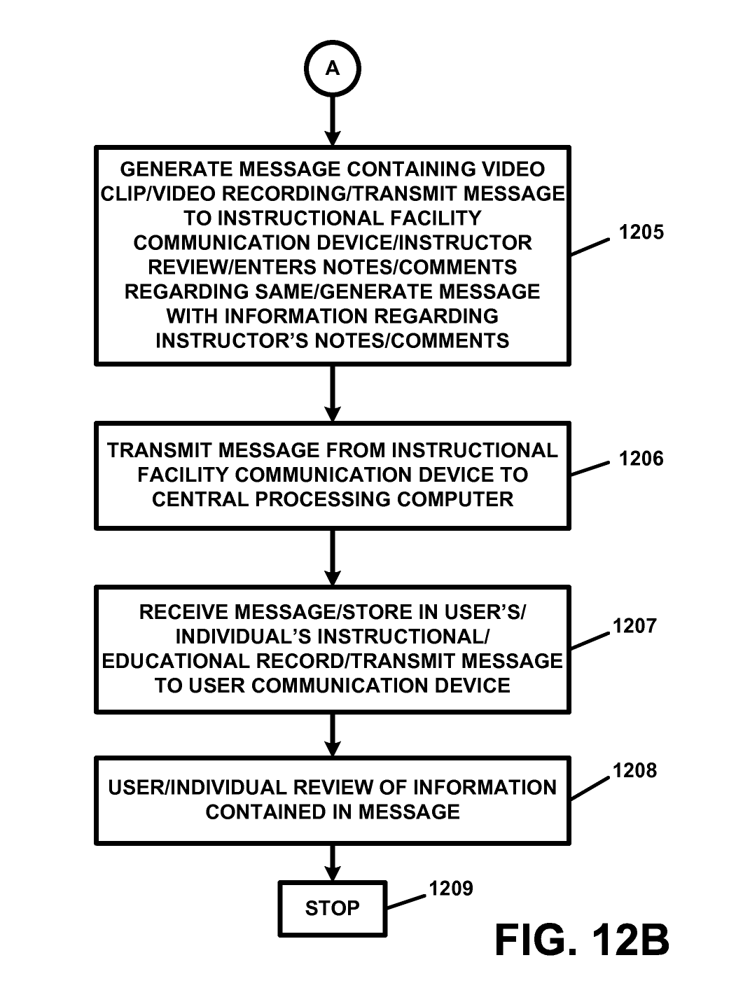

FIGS. 12A and 12B illustrate still another preferred embodiment method for utilizing the apparatus of the present invention, in flow diagram form. In a preferred embodiment, the operation of the apparatus 100 and method of the present invention can be described as being utilized by a user or individual who may be enrolled or registered with a martial arts school in order to study Krav Maga. Although described and illustrated as being utilized in connection with Krav Maga martial arts instruction, it is important to note that the embodiment of FIGS. 12A and 12B can be utilized in a same, a similar, and/or an analogous, manner in connection with and/or in conjunction with any of the herein-described and various types or kinds of exercise activities, fitness activities, work-out activities, strength and conditioning activities, any type or kinds or sports or athletic activities, aerobics activities, weight training activities, cross training activities, callisthenic activities, Pilates activities, Yoga activities, meditation activities, Tai Chi activities, boxing, wrestling, kickboxing, cheerleading, martial arts activities, including, but not limited to, Krav Maga (Israeli martial arts), Karate, Kung Fu, Judo, Jujitsu, Kick Boxing, Mixed Martial Arts, Muy Tai, Brazilian Jujitsu, Savate, and any other type or kind of martial arts, as well as any other type or kind of physical activities, exercise activities, fitness activities, or wellness activities, and/or in connection with and/or in conjunction with the providing or offering of any types or kinds of instructional services and/or educational services in and for any types of kinds of academic subjects, classes, courses, diploma programs, degree programs, certificate programs, or continuing education programs, and/or any other informational, instructional, or educational, programs or activities, provided by or offered by any instructional and/or educational school, institution, facility, college, university, professional school continuing education institution, or any other learning institution or facility.

With reference to FIGS. 12A and 12B, the operation of the apparatus 100 commences at step 1200. At step 1201, the user or individual can use the video and/or audio recording device(s) 20J of a user communication device 20 to record a video clip or a video recording of himself or herself performing a Krav Maga technique(s) or movement(s), or to record a video clip or a video recording of himself or herself participating in a Krav Maga class, lesson, or seminar, or any portion of same, or to record himself or herself performing a Krav Maga technique(s) or movement(s) during or for a Krav Maga belt test or rank advancement test. At step 1202, the user or individual can access the central processing computer 10 with or using the user communication device 20 and can enter information regarding his or her account and/or the Krav Maga school or center in which the user or individual is enrolled. At step 1202, the user or individual can transmit, or upload, the video clip or a video recording to the central processing computer 10. At step 1203, the central processing computer 10 can process any data and/or information regarding the user or individual as well as receive the video clip or the video recording.

At step 1204, the central processing computer 10 can store the video clip or video recording in the user's or individual's instructional record or educational record which is stored in the database 10H. At step 1205, the central processing computer 10 can generate and transmit a message, containing the video clip or video recording, to the instructional facility communication device 30 of or associated with the user's or individual's Krav Maga school or center.

Thereafter, an instructor at or with the user's or individual's Krav Maga school or center can utilize the instructional facility communication device 30 in order to review the video clip or video recording and in order to can make and/or enter any notes or comments, into the instructional facility communication device 30, regarding the user's or individual's performance or techniques or to make and/or enter, into the instructional facility communication device 30, any remarks, or provide feedback, regarding and/or for the user or individual and/or the user's or individual's performance as shown in the video clip or video recording. At step 1205, the instructional facility communication device 30 can generate a message containing information regarding any notes, comments, or observations, made by the instructor. In an preferred embodiment, the message can also contain a link or hyperlink to, of have attached thereto, a video clip or video recording illustrating, describing, and/or demonstrating a movement or a technique. At step 1206, the instructor can then transmit the message from the instructional facility communication device 30 to the central processing computer 10. At step 1206, the instructional facility communication device 30 can also store the video clip or video recording and the message in the in the user's or individual's instructional record or educational record which is stored in the database 30H.

At step 1207, the central processing computer 10 can receive the message and can store same in the user's or individual's instructional record or educational record. At step 1207, the central processing computer 10 can also transmit the message to the user or individual, to the user communication device 20, or to any other user communication device 20 of, associated with, or used by the user or individual. The message, which is transmitted to the user or individual, to the user communication device 20, or to any other user communication device 20 of, associated with, or used by, the user or individual, can be transmitted as or in an e-mail message, a text message, an SMS message, an MMS message, a pre-recorded telephone message, or as or in any electronic transmission. Thereafter, at step 1208, the user or individual can review the information contained in the message. Thereafter, the operation of the apparatus can cease at step 1209.

The embodiment of FIGS. 12A and 12B can be utilized in order to allow the user or individual to provide video recordings of himself or herself performing any Krav Maga techniques or movements, performing in or during a class or lesson or in or during any portion of same, or performing a test for a belt level or a ranking level in Krav Maga.

Although described and illustrated as being utilizing in connection or in conjunction with providing Krav Maga instruction, it is to be understood that the apparatus 100 of the present invention and, in particular, the apparatus of the various embodiments of FIGS. 12A and 12B described herein, can be utilized in a same, a similar, and/or an analogous, manner in and for any of the herein-described and various types or kinds of exercise activities, fitness activities, work-out activities, strength and conditioning activities, any type or kinds or sports or athletic activities, aerobics activities, weight training activities, cross training activities, callisthenic activities, Pilates activities, Yoga activities, meditation activities, Tai Chi activities, boxing, wrestling, kickboxing, cheerleading, martial arts activities, including, but not limited to, Krav Maga (Israeli martial arts), Karate, Kung Fu, Judo, Jujitsu, Kick Boxing, Mixed Martial Arts, Muy Tai, Brazilian Jujitsu, Savate, and any other type or kind of martial arts, as well as any other type or kind of physical activities, exercise activities, fitness activities, or wellness activities, and/or in connection with and/or in conjunction with providing or offering of any types or kinds of instructional services and/or educational services in and for any types of kinds of academic subjects, classes, courses, diploma programs, degree programs, certificate programs, or continuing education programs, and/or any other informational, instructional, or educational, programs or activities, provided by or offered by any instructional and/or educational school, institution, facility, college, university, professional school continuing education institution, or any other learning institution or facility.

In another preferred embodiment, the apparatus 100 of the present invention can be utilized in order to allow a user or individual to search for classes, lessons, seminars, or courses, from among those offered or provided by the various individuals, gyms, health clubs, country clubs, exercise facilities, fitness facilities, or fitness centers, or martial arts schools, or martial arts centers or academies, schools, colleges, universities, trade schools, training institutes or academies, continuing education facilities, or learning centers, who or which can utilize the apparatus 100 of the present invention in order to provide their respective instructional services and educational services to students or members.

In a preferred embodiment, it is envisioned that each individual, gym, health club, country club, exercise facility, fitness facility, or fitness center, or martial arts school, or martial arts center or academy, school, college, university, trade school, training institute or academy, continuing education facility, or learning center, who or which utilizes the apparatus 100 of the present invention, can post information regarding his, her, or its, respective instructional offerings, educational offerings, or academic offerings, class offerings, lesson offerings, seminar offerings, lecture offerings, activity offerings, course offerings, diploma program offerings, degree program offerings, certificate program offerings, or continuing education offerings, any description of same, information regarding any materials or subject matter to be covered by same, any agenda for same, any syllabus for same, any scheduling information for same, including but not limited to, the day, dates, and times of same, and/or any instructors or trainers of or for same, with the database 10H of the central processing computer 10. In a preferred embodiment, each individual, gym, health club, country club, exercise facility, fitness facility, or fitness center, or martial arts school, or martial arts center or academy, school, college, university, trade school, training institute or academy, continuing education facility, or learning center, can also store, in the database 30H of his, her, or its, respective instructional offerings, educational offerings, or academic offerings, class offerings, lesson offerings, seminar offerings, lecture offerings, activity offerings, course offerings, diploma program offerings, degree program offerings, certificate program offerings, or continuing education offerings, any description of same, information regarding any materials or subject matter to be covered by same, any agenda for same, any syllabus for same, any scheduling information for same, including but not limited to, the day, dates, and times of same, and/or any instructors or trainers of or for same.

In a preferred embodiment, it is also envisioned that the apparatus 100 can be utilized in a global setting such that the various individuals, gyms, health clubs, country clubs, exercise facilities, fitness facilities, or fitness centers, or martial arts schools, or martial arts centers or academies, schools, colleges, universities, trade schools, training institutes or academies, continuing education facilities, or learning centers, who or which can utilize the apparatus 100 of the present invention, can be located anywhere in the World.

In a preferred embodiment, the instructional facility communication device 30 of or associated with the respective individual, gym, health club, country club, exercise facility, fitness facility, or fitness center, or martial arts school, or martial arts center or academy, school, college, university, trade school, training institute or academy, continuing education facility, or learning center, can be programmed to automatically transmit any and/or all of the herein-described information regarding the respective instructional offerings, educational offerings, or academic offerings, class offerings, lesson offerings, seminar offerings, lecture offerings, activity offerings, course offerings, diploma program offerings, degree program offerings, certificate program offerings, or continuing education offerings, of same, to the central processing computer 10 for storage in the database 10H.

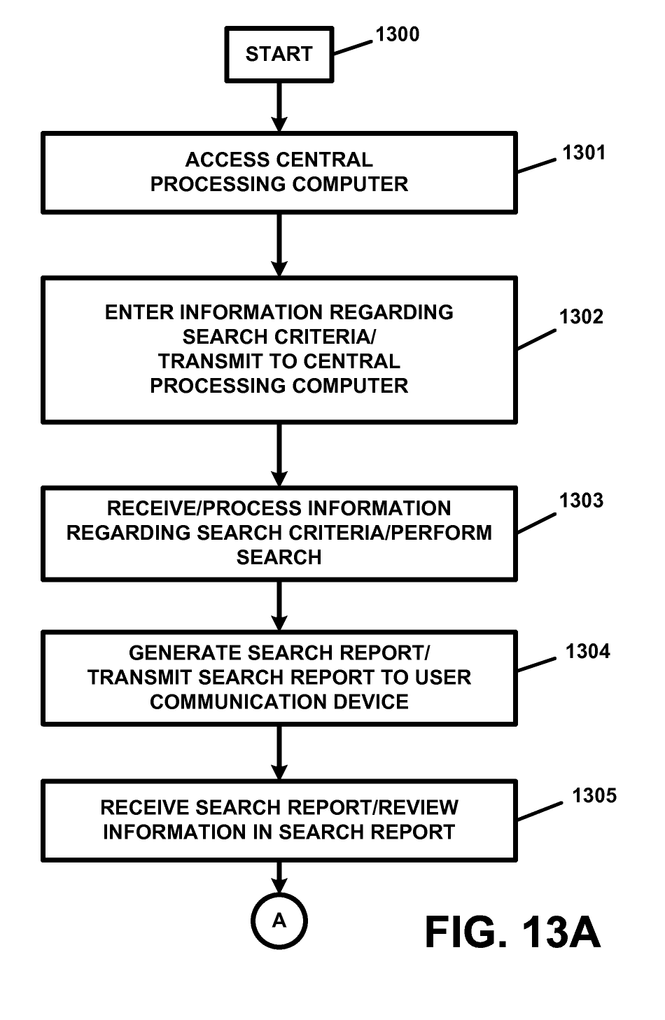

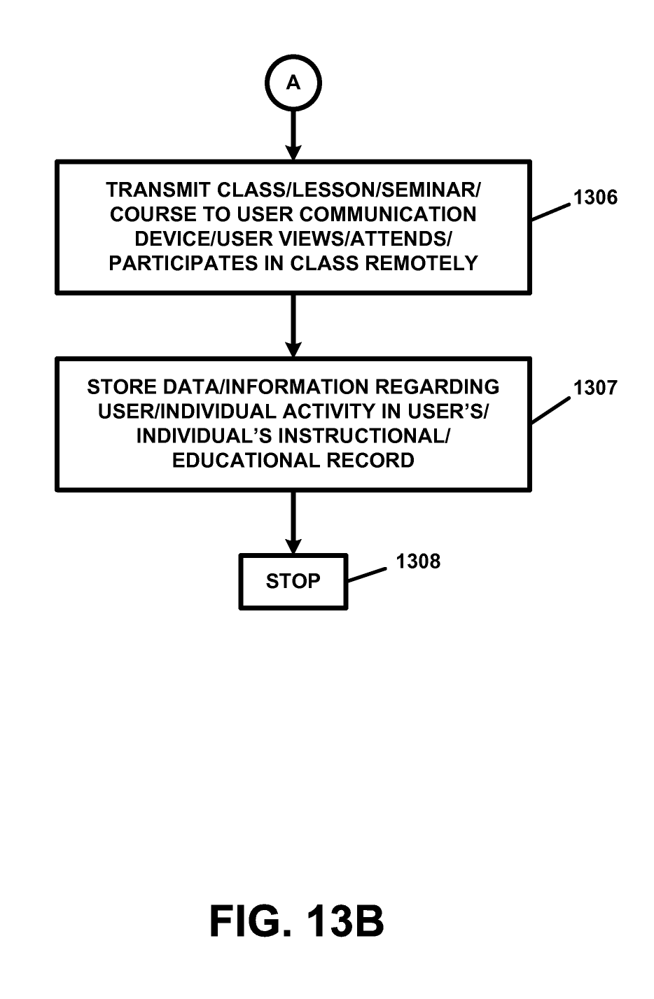

In a preferred embodiment, a user or individual can utilize the apparatus 100 of the present invention in order to search for and identify and/or locate classes, lessons, seminars, or courses which he or she can view or attend, or in which he or she can participate. FIGS. 13A and 13B illustrate a preferred embodiment method for utilizing the apparatus 100 of the present invention, in flow diagram form. The preferred embodiment of FIGS. 13A and 13B will be described and illustrated as being used by a user or individual in order to search for and/or to locate and/or to identify a Krav Maga class which might be taught in a particular city or country, which might have a recognized expertise for teaching certain techniques, which may be taught by a certain instructor or instructors, or which class or lesson might simply be offered at a particular time, or which might be in the process of starting when the user or individual is available to view, attend, or participate in same.

Although described and illustrated as being utilizing in connection or in conjunction with providing Krav Maga instruction, it is to be understood that the apparatus 100 of the present invention and, in particular, the apparatus of the various embodiments of FIGS. 13A and 13B described herein, can also be utilized in a same, a similar, and/or an analogous, manner in and for any of the herein-described and various types or kinds of exercise activities, fitness activities, work-out activities, strength and conditioning activities, any type or kinds or sports or athletic activities, aerobics activities, weight training activities, cross training activities, callisthenic activities, Pilates activities, Yoga activities, meditation activities, Tai Chi activities, boxing, wrestling, kickboxing, cheerleading, martial arts activities, including, but not limited to, Krav Maga (Israeli martial arts), Karate, Kung Fu, Judo, Jujitsu, Kick Boxing, Mixed Martial Arts, Muy Tai, Brazilian Jujitsu, Savate, and any other type or kind of martial arts, as well as any other type or kind of physical activities, exercise activities, fitness activities, or wellness activities, and/or in connection with and/or in conjunction with providing or offering of any types or kinds of instructional services and/or educational services in and for any types of kinds of academic subjects, classes, courses, diploma programs, degree programs, certificate programs, or continuing education programs, and/or any other informational, instructional, or educational, programs or activities, provided by or offered by any instructional and/or educational school, institution, facility, college, university, professional school continuing education institution, or any other learning institution or facility.

In another preferred embodiment, the user or individual can be an enrolled student in, or can be a member of, a Krav Maga school or center and might be interested in finding or identifying a class or lesson offered or provided by his or her Krav Maga school or center or any other Krav Maga school or center. The user or individual might also be away from home, or traveling in a different time zone and simply may want to remotely view, attend, or participate in, a soon to be provided or offered class or lesson.

With reference to FIGS. 13A and 13B, the operation of the apparatus 100 commences at step 1300. At step 1301, the user or individual can access the central processing computer 10 by utilizing his or her user communication device 20. At step 1302, the user or individual can input or enter any search criteria regarding any classes, lessons, seminars, or courses which he or she is interested in remotely viewing or attending and/or in participating in remotely. For example, the user or individual might be interested in finding a class which might be about to start, or which is offered on that day, or which might cover certain techniques, or which might be taught by a certain school or instructor. The search criteria can also include a request for live classes, lessons, seminars, or courses, and/or the search criteria can also include a request for recorded classes, lessons, seminars, or courses.

At step 1302, the user or individual can transmit the information regarding the search criteria from the user communication device 20 to the central processing computer 10. At step 1303, the central processing computer 10 can receive and process the information regarding the search criteria and perform a search of the various offerings stored in the database 10H in order to identify and/or locate classes, lessons, seminars, or courses which might meet the user′ or individual's search criteria.

At step 1304, the central processing computer 10 can generate a search report containing information regarding one or more classes, lessons, seminars, or courses which might meet or satisfy the user′ or individual's search criteria, and which can contain, for each identified class, lesson, seminar, or course, information regarding the time and date of same, the duration of same, the skill level of same, a link to same, or a hyperlink to same, the Krav Maga school or center or any other type or kind of school or center offering or providing same, the syllabus or same, the instructor(s) for same, the techniques to be covered by same, and/or any other information regarding the respective class, lesson, seminar, or course. At step 1304, the central processing computer 10 can also transmit the search report to the user's or individual's user communication device 20.

In a preferred embodiment, the search report can be transmitted to the user or individual, to the communication device 20, or to any other user communication device 20 of, associated with, or used by, the user or individual. In a preferred embodiment, the search report can be transmitted to the user or individual, to the communication device 20, or to any other user communication device 20 of, associated with, or used by, the user or individual, as or in an e-mail message, a text message, an SMS message, an MMS message, a pre-recorded telephone message, or as or in any electronic transmission. In a preferred embodiment, the search report can contain information regarding one or more live classes, lessons, seminars, or courses, or the search report can also contain information regarding one or more recorded classes, lessons, seminars, or courses.

At step 1305, the user communication device 20 can receive the search report. Thereafter, at step 1305, the user or individual can review the information contained in the search report and can select a class, a lesson, a seminar, or a course, contained therein to remotely view, attend, or participate in, by linking to same via the link, or via the hyperlink, corresponding to same in the search report. Thereafter, the operation of the apparatus 100 will proceed to step 1306. At step 1306, the selected class, lesson, seminar, or course, can be transmitted to the user communication device 20 of, associated with, or used by, the user or individual from or via the central processing computer 10 or from or via the instructional facility communication device 30 providing or offering the selected class, lesson, seminar, or course.

In a preferred embodiment, if the selected class, lesson, seminar, or course, is a live class, lesson, seminar, or course, it can be transmitted to the user communication device 20 directly from the instructional facility communication device 30 via, on, or over, the Internet, the World Wide Web, or any other communication network, or any combination of same, or the live class, lesson, seminar, or course, can be transmitted from the instructional facility communication device 30 to the user communication device 20 via or through the central processing computer 10 via, on, or over, the Internet, the World Wide Web, or any other communication network, or any combination of same. In a preferred embodiment, if the selected class, lesson, seminar, or course, is a recorded class, lesson, seminar, or course, it can be transmitted to the user communication device 20 directly from the instructional facility communication device 30 via, on, or over, the Internet, the World Wide Web, or any other communication network, or any combination of same, or the recorded class, lesson, seminar, or course, can be transmitted from the central processing computer 10, or from the instructional facility communication device 30, to the user communication device 20 via, on, or over, the Internet, the World Wide Web, or any other communication network, or any combination of same.

Thereafter, at step 1306, the user or individual can remotely view, attend, or participate in, the selected class, lesson, seminar, or course. Once the selected class, lesson, seminar, or course, has been completed or once the transmission of same has been otherwise terminated, the operation of the apparatus 100 will proceed to step 1307 and the central processing computer 10 can store in the database 10H, and/or the instructional facility communication device 30 can store in the database 30H, in the respective user's or individual's instructional record or educational record, any and/or all data and/or information regarding the user or individual having remotely viewed, attended, or participated in, the selected class, lesson, seminar, or course, in its entirety or partially, as well any information regarding the selected class, lesson, seminar, or course, which is described herein as being contained in the search report about the selected class, lesson, seminar, or course. In a preferred embodiment, the instructional facility communication device 30 can be programmed to automatically create an instructional record or an educational record for the user or individual if no such record exists for the user or individual and can be programmed to store the information described as being stored at step 1307 in the newly created record.

Thereafter, the operation of the apparatus 100 will cease at step 1308.

In a preferred embodiment, as well as in any and/or all of the embodiments described herein, each instructional facility communication device 30 can be programmed to automatically transmit and/or upload any instructional records, or educational records of any users or individuals, or any changes or updates to same, which are stored in the database 30H of same, to the central processing computer 10 for storage in the database 10H of same. In a preferred embodiment, as well as in any and/or all of the embodiments described herein, the central processing computer 10 can also be programmed to automatically transmit and/or upload any instructional records, or educational records of any users or individuals, or any changes or updates to same, which are stored in the database 10H of same, to each instructional facility communication device 30 associated with each individual, gym, health club, country club, exercise facility, fitness facility, or fitness center, or martial arts school, or martial arts center or academy, school, college, university, trade school, training institute or academy, continuing education facility, or learning center, of or with whom or of or with which the user or individual is a student, enrolled with, or a member. In this regard, in a preferred embodiment, any instructional record(s) or education record(s) of any user or individual can be automatically updated in the central processing computer 10 and in every instructional facility communication device 30 every time a change or update is made to any user's or individual's instructional record(s) or education record(s) by the central processing computer 10 or by any instructional facility communication device 30.

In a preferred embodiment, the instructional facility communication device 30 of or associated with the respective individual, gym, health club, country club, exercise facility, fitness facility, or fitness center, or martial arts school, or martial arts center or academy, school, college, university, trade school, training institute or academy, continuing education facility, or learning center, can be programmed to automatically transmit any and/or all of the herein-described information regarding the respective instructional offerings, educational offerings, or academic offerings, class offerings, lesson offerings, seminar offerings, lecture offerings, activity offerings, course offerings, diploma program offerings, degree program offerings, certificate program offerings, or continuing education offerings, and/or any and/or all of the herein-described information regarding any classes, lessons, seminars, or courses, offered or provided by same, to the central processing computer 10 for storage in the database 10H.

Although described and illustrated as being utilizing in connection or in conjunction with providing Krav Maga instruction, it is to be understood that the apparatus 100 of the present invention and, in particular, the apparatus of the various embodiments of FIGS. 13A and 13B described herein, can be utilized in a same, a similar, and/or an analogous, manner in and for any of the herein-described and various types or kinds of exercise activities, fitness activities, work-out activities, strength and conditioning activities, any type or kinds or sports or athletic activities, aerobics activities, weight training activities, cross training activities, callisthenic activities, Pilates activities, Yoga activities, meditation activities, Tai Chi activities, boxing, wrestling, kickboxing, cheerleading, martial arts activities, including, but not limited to, Krav Maga (Israeli martial arts), Karate, Kung Fu, Judo, Jujitsu, Kick Boxing, Mixed Martial Arts, Muy Tai, Brazilian Jujitsu, Savate, and any other type or kind of martial arts, as well as any other type or kind of physical activities, exercise activities, fitness activities, or wellness activities, and/or in connection with and/or in conjunction with providing or offering of any types or kinds of instructional services and/or educational services in and for any types of kinds of academic subjects, classes, courses, diploma programs, degree programs, certificate programs, or continuing education programs, and/or any other informational, instructional, or educational, programs or activities, provided by or offered by any instructional and/or educational school, institution, facility, college, university, professional school continuing education institution, or any other learning institution or facility.

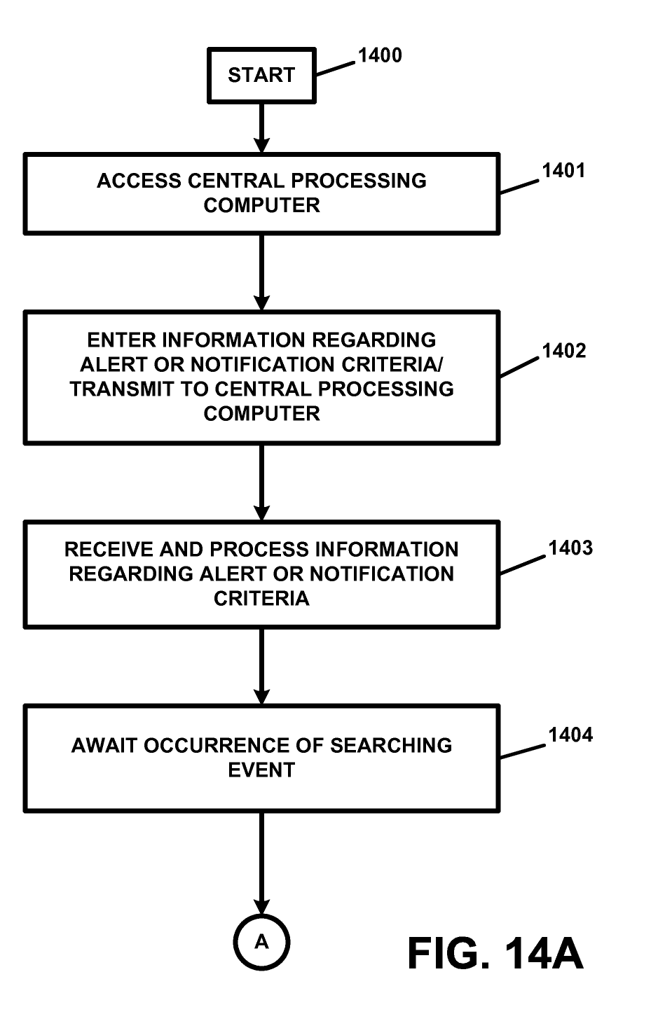

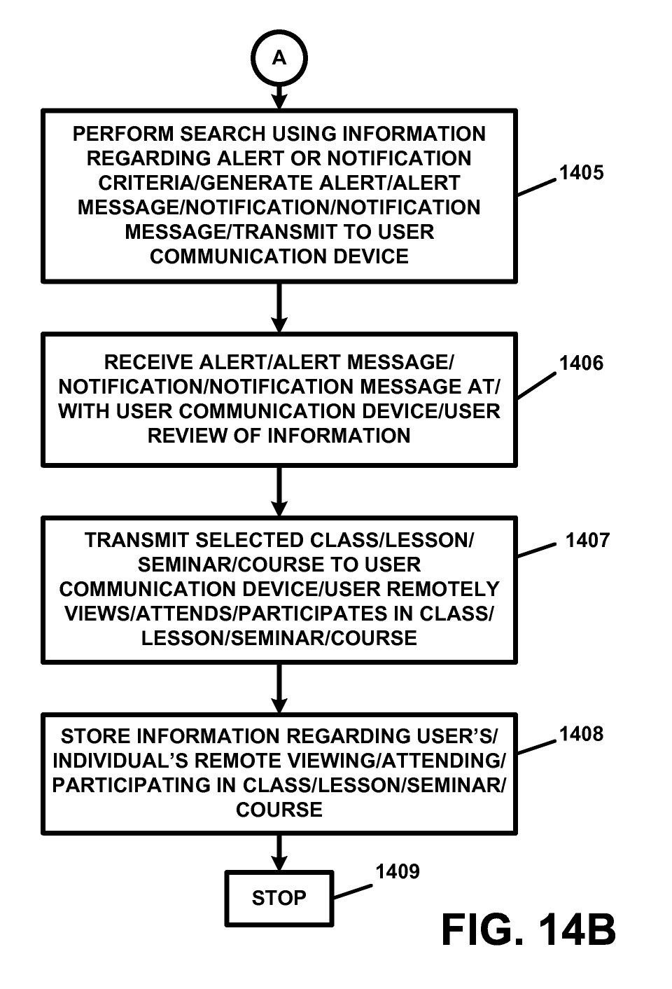

In another preferred embodiment, the apparatus 100 can be utilized to generate and transmits alerts, alert messages, notifications, or notification messages, containing information regarding an availability, an offering, or a providing, or any class(es), lesson(s), seminar(s), or course(s), for which the user or individual has requested to be notified. In a preferred embodiment, a user or individual can utilize the apparatus 100 of the present invention in order to request to be provided with an alert, an alert message, a notification, or a notification message, regarding an availability, an offering, or a providing, or any class(es), lesson(s), seminar(s), or course(s). FIGS. 14A and 14B illustrate a preferred embodiment method for utilizing the apparatus 100 of the present invention, in flow diagram form. The preferred embodiment of FIGS. 14A and 14B will be described and illustrated as being used by a user or individual in order to request to be provided with an alert, an alert message, a notification, or a notification message, regarding an availability, an offering, or a providing, or any class(es), lesson(s), seminar(s), or course(s), in Krav Maga. For example, the user or individual can request to be provided with an alert, an alert message, a notification, or a notification message regarding a Krav Maga class which might be taught in a particular city or country, which might have a recognized expertise for teaching certain techniques, which may be taught by a certain instructor or instructors, or a class. Lesson, seminar, or course, which might simply be offered at a particular time, or which might be offered or provided at a specific time.

Although described and illustrated as being utilizing in connection or in conjunction with providing Krav Maga instruction, it is to be understood that the apparatus 100 of the present invention and, in particular, the apparatus 100 can also be utilized in a same, a similar, and/or an analogous, manner in and for any of the herein-described and various types or kinds of exercise activities, fitness activities, work-out activities, strength and conditioning activities, any type or kinds or sports or athletic activities, aerobics activities, weight training activities, cross training activities, callisthenic activities, Pilates activities, Yoga activities, meditation activities, Tai Chi activities, boxing, wrestling, kickboxing, cheerleading, martial arts activities, including, but not limited to, Krav Maga (Israeli martial arts), Karate, Kung Fu, Judo, Jujitsu, Kick Boxing, Mixed Martial Arts, Muy Tai, Brazilian Jujitsu, Savate, and any other type or kind of martial arts, as well as any other type or kind of physical activities, exercise activities, fitness activities, or wellness activities, and/or in connection with and/or in conjunction with providing or offering of any types or kinds of instructional services and/or educational services in and for any types of kinds of academic subjects, classes, courses, diploma programs, degree programs, certificate programs, or continuing education programs, and/or any other informational, instructional, or educational, programs or activities, provided by or offered by any instructional and/or educational school, institution, facility, college, university, professional school continuing education institution, or any other learning institution or facility.

In another preferred embodiment, the user or individual can be an enrolled student in, or can be a member of, a Krav Maga school or center and might be interested in finding or identifying a class or lesson offered or provided by his or her Krav Maga school or center or any other Krav Maga school or center. The user or individual might also be away from home, or traveling in a different time zone and simply may want to be notified regarding a soon to be provided or offered class, lesson, seminar, or course, which might be available or which may become available for him or her to remotely view or attend, or in which the user or individual can participate.

With reference to FIGS. 14A and 14B, the operation of the apparatus 100 commences at step 1400. At step 1401, the user or individual can access the central processing computer 10 by utilizing his or her user communication device 20. At step 1402, the user or individual can input or enter information regarding any alert or notification criteria regarding any classes, lessons, seminars, or courses, about which he or she is interested in being alerted or notified. For example, the user or individual might be interested in being alerted about or notified about a class which might be about to start, or which is offered on that day, or which might cover certain techniques, or which might be taught by a certain school or instructor. The alert or notification criteria can also include a request to be alerted about or notified about live classes, lessons, seminars, or courses, and/or the alert or notification criteria can also include a request to be alerted about or notified about recorded classes, lessons, seminars, or courses.

At step 1402, the user or individual can transmit the information regarding the alert or notification criteria from the user communication device 20 to the central processing computer 10. At step 1403, the central processing computer 10 can receive and process the information regarding the alert or notification criteria. At step 1404, the central processing computer 10 can await the occurrence of any searching event which can give rise to the central processing computer 10 searching or checking the contents the database 10H, and in particular any updates to same, to identify any class(es), lesson(s), seminar(s), or course(s), offered or provided by any of the herein-described individuals, gyms, health clubs, country clubs, exercise facilities, fitness facilities, or fitness centers, or martial arts schools, or martial arts centers or academies, schools, colleges, universities, trade schools, training institutes or academies, continuing education facilities, or learning centers, which meet the alert or notification criteria.

In a preferred embodiment, each instructional facility communication device 30 can be programmed to transmit or upload, the to the central processing computer 10, for storage in the database 10H, any and/or all information regarding, or changes to information regarding, any and/or all classes, lessons, seminars, or courses, offered or provided by each respective individual, gym, health club, country club, exercise facility, fitness facility, or fitness center, or martial arts school, or martial arts center or academy, school, college, university, trade school, training institute or academy, continuing education facility, or learning center.

In a preferred embodiment, the searching event can be any occurrence of any update to the contents of the database 10H of the central processing computer 10, such as any update by any individual, gym, health club, country club, exercise facility, fitness facility, or fitness center, or martial arts school, or martial arts center or academy, school, college, university, trade school, training institute or academy, continuing education facility, or learning center, of or regarding any offering of or regarding any new or different classes, lessons, seminars, or courses, or any a changes to any classes, lessons, seminars, or courses, or any changes in syllabus, agenda, techniques, instructors, or schedules, or time(s), of or regarding any classes, lessons, seminars, or courses, or any other offered by any individual, gym, health club, country club, exercise facility, fitness facility, or fitness center, or martial arts school, or martial arts center or academy, school, college, university, trade school, training institute or academy, continuing education facility, or learning center. In a preferred embodiment, the searching event can also be any other or occurrence which can give rise to any change in the data and/or information stored in the database 10H which can give rise to the possibility that a change or an update in the database 10H might contain information for which the user or individual might wanted to be alerted or notified.

Upon any detected occurrence of any searching event, the operation of the apparatus 100 will proceed to step 1405. At step 1405, the central processing computer 10 can search the database 10H using the information regarding the alert or notification criteria and, if the alert or notification criteria has been met, the central processing computer 10 can generate an alert, an alert message, a notification, or a notification message, containing information regarding any class(es), lesson(s), seminar(s), or course(s), which satisfy the alert or notification criteria. In a preferred embodiment, the alert, an alert message, a notification, or a notification message, can contain information regarding one or more classes, lessons, seminars, or courses which might meet or satisfy the user′ or individual's alert or notification criteria, and can contain, for each identified class, lesson, seminar, or course, information regarding the time and date of same, the duration of same, the skill level of same, a link to same, or a hyperlink to same, the Krav Maga school or center or any other type or kind of school or center offering or providing same, the syllabus or same, the instructor(s) for same, the techniques to be covered by same, and/or any other information regarding the respective class, lesson, seminar, or course.

At step 1405, the central processing computer 10 can also transmit the alert, the alert message, the notification, or the notification message, to the user's or individual's user communication device 20. In a preferred embodiment, the alert, the alert message, the notification, or the notification message, can be transmitted to the user or individual, to the communication device 20, or to any other user communication device 20 of, associated with, or used by, the user or individual. In a preferred embodiment, the alert, the alert message, the notification, or the notification message, can be transmitted to the user or individual, to the communication device 20, or to any other user communication device 20 of, associated with, or used by, the user or individual, as or in an e-mail message, a text message, an SMS message, an MMS message, a pre-recorded telephone message, or as or in any electronic transmission. In a preferred embodiment, the alert, the alert message, the notification, or the notification message, can contain information regarding one or more live classes, lessons, seminars, or courses, or the search report can also contain information regarding one or more recorded classes, lessons, seminars, or courses.

At step 1406, the user communication device 20 can receive the alert, the alert message, the notification, or the notification message. Thereafter, at step 1406, the user or individual can review the information contained in the alert, the alert message, the notification, or the notification message, and can select a class, a lesson, a seminar, or a course, contained therein to remotely view, attend, or participate in, by linking to same via the link, or via the hyperlink, corresponding to same in the alert, the alert message, the notification, or the notification message. Thereafter, the operation of the apparatus 100 will proceed to step 1407. At step 1407, the selected class, lesson, seminar, or course, can be transmitted to the user communication device 20 of, associated with, or used by, the user or individual from or via the central processing computer 10 or from or via the instructional facility communication device 30 providing or offering the selected class, lesson, seminar, or course.

In a preferred embodiment, if the selected class, lesson, seminar, or course, is a live class, lesson, seminar, or course, it can be transmitted to the user communication device 20 directly from the instructional facility communication device 30 via, on, or over, the Internet, the World Wide Web, or any other communication network, or any combination of same, or the live class, lesson, seminar, or course, can be transmitted from the instructional facility communication device 30 to the user communication device 20 via or through the central processing computer 10 via, on, or over, the Internet, the World Wide Web, or any other communication network, or any combination of same. In a preferred embodiment, if the selected class, lesson, seminar, or course, is a recorded class, lesson, seminar, or course, it can be transmitted to the user communication device 20 directly from the instructional facility communication device 30 via, on, or over, the Internet, the World Wide Web, or any other communication network, or any combination of same, or the recorded class, lesson, seminar, or course, can be transmitted from the central processing computer 10, or from the instructional facility communication device 30, to the user communication device 20 via, on, or over, the Internet, the World Wide Web, or any other communication network, or any combination of same.

Thereafter, at step 1407, the user or individual can remotely view, attend, or participate in, the selected class, lesson, seminar, or course. Once the selected class, lesson, seminar, or course, has been completed or once the transmission of same has been otherwise terminated, the operation of the apparatus 100 will proceed to step 1408 and the central processing computer 10 can store in the database 10H, and/or the instructional facility communication device 30 can store in the database 30H, in the respective user's or individual's instructional record or educational record, any and/or all data and/or information regarding the user or individual having remotely viewed, attended, or participated in, the selected class, lesson, seminar, or course, in its entirety or partially, as well any information regarding the selected class, lesson, seminar, or course, which is described herein as being contained in the search report about the selected class, lesson, seminar, or course. In a preferred embodiment, the instructional facility communication device 30 can be programmed to automatically create an instructional record or an educational record for the user or individual if no such record exists for the user or individual and can be programmed to store the information described as being stored at step 1408 in the newly created record.

Thereafter, the operation of the apparatus 100 will cease at step 1409.

In a preferred embodiment, as well as in any and/or all of the embodiments described herein, each instructional facility communication device 30 can be programmed to automatically transmit and/or upload any instructional records, or educational records of any users or individuals, or any changes or updates to same, which are stored in the database 30H of same, to the central processing computer 10 for storage in the database 10H of same. In a preferred embodiment, as well as in any and/or all of the embodiments described herein, the central processing computer 10 can also be programmed to automatically transmit and/or upload any instructional records, or educational records of any users or individuals, or any changes or updates to same, which are stored in the database 10H of same, to each instructional facility communication device 30 associated with each individual, gym, health club, country club, exercise facility, fitness facility, or fitness center, or martial arts school, or martial arts center or academy, school, college, university, trade school, training institute or academy, continuing education facility, or learning center, of or with whom or of or with which the user or individual is a student, enrolled with, or a member. In this regard, in a preferred embodiment, any instructional record(s) or education record(s) of any user or individual can be automatically updated in the central processing computer 10 and in every instructional facility communication device 30 every time a change or update is made to any user's or individual's instructional record(s) or education record(s) by the central processing computer 10 or by any instructional facility communication device 30.

In a preferred embodiment, the instructional facility communication device 30 of or associated with the respective individual, gym, health club, country club, exercise facility, fitness facility, or fitness center, or martial arts school, or martial arts center or academy, school, college, university, trade school, training institute or academy, continuing education facility, or learning center, can be programmed to automatically transmit any and/or all of the herein-described information regarding the respective instructional offerings, educational offerings, or academic offerings, class offerings, lesson offerings, seminar offerings, lecture offerings, activity offerings, course offerings, diploma program offerings, degree program offerings, certificate program offerings, or continuing education offerings, and/or any and/or all of the herein-described information regarding any classes, lessons, seminars, or courses, offered or provided by same, to the central processing computer 10 for storage in the database 10H.

Although described and illustrated as being utilizing in connection or in conjunction with providing Krav Maga instruction, it is to be understood that the apparatus 100 of the present invention and, in particular, the apparatus of the various embodiments of FIGS. 14A and 14B described herein, can be utilized in a same, a similar, and/or an analogous, manner in and for any of the herein-described and various types or kinds of exercise activities, fitness activities, work-out activities, strength and conditioning activities, any type or kinds or sports or athletic activities, aerobics activities, weight training activities, cross training activities, callisthenic activities, Pilates activities, Yoga activities, meditation activities, Tai Chi activities, boxing, wrestling, kickboxing, cheerleading, martial arts activities, including, but not limited to, Krav Maga (Israeli martial arts), Karate, Kung Fu, Judo, Jujitsu, Kick Boxing, Mixed Martial Arts, Muy Tai, Brazilian Jujitsu, Savate, and any other type or kind of martial arts, as well as any other type or kind of physical activities, exercise activities, fitness activities, or wellness activities, and/or in connection with and/or in conjunction with providing or offering of any types or kinds of instructional services and/or educational services in and for any types of kinds of academic subjects, classes, courses, diploma programs, degree programs, certificate programs, or continuing education programs, and/or any other informational, instructional, or educational, programs or activities, provided by or offered by any instructional and/or educational school, institution, facility, college, university, professional school continuing education institution, or any other learning institution or facility.

In another preferred embodiment, the apparatus 100 and method of the present invention can be utilized in order to establish and maintain a comprehensive instructional and educational record (hereinafter “instructional/educational record”) for users or individuals. In a preferred embodiment, the instructional/educational record can include any and/or all data and/or information regarding any and/or all of the a user's or individual's instructional and/or educational and/or academic activities and/or history, including, but not limited to, a user's or individual's education, pre-school education and instruction, grammar school and/or grade school education and/or instruction, middle school education or instruction, high school education and/or instruction, trade school education and/or instruction, college or university education and/or instruction, graduate school education and/or instruction, professional school education and/or instruction, continuing education and/or instruction, and/or any other educational and/or instructional institution or school, in, at, or with, which, the user or individual has taken, had, or completed, and/or any classes or courses taken, had, and/or completed, at, in, during, with, and/or regarding same, as well as any and/or all transcripts of any and/or all instructional activities or education activities at these schools or institutions, as well as any and/or all records regarding an individual's or a user's exercise and/or fitness activities, and/or any exercise or fitness classes taken or participated in, gym or fitness club or facility membership(s), any and/or all records regarding an individual's or a user's training in any martial arts, sports, or athletics, and/or any school, training center, or training academy, membership(s), and/or any other information regarding the individual's or the user's instructional, educational, fitness, exercise, martial arts, sports, or athletics or any other physical, activities.

The instructional/education records, and any instructional records accounts and/or educational records accounts associated therewith can also be utilized to maintain records of a user's or individual's instructional, educational, fitness, exercise, martial arts, sports, or athletics or any other physical, activities throughout the individual's or the user's lifetime or for any period or periods during the individual's or the user's lifetime. In this regard, the instructional/educational records, and any instructional records accounts and/or educational records accounts associated therewith, can contain an instructional, educational, and/or academic, component as well as can contain a fitness, exercise, martial arts, sports, or athletics or any other physical, activities, component. In a preferred embodiment, once created or established, the instructional/education record is maintained centrally, such as in and/or on the central processing computer 10, and/or can also be maintained on the “Cloud” or in any other Internet and/or World Wide Web based storage platform.

In a preferred embodiment, the instructional/educational record can also contain, as a component thereof, any and/or all transcripts containing information regarding the user's or individual's instructional, educational, fitness, exercise, martial arts, sports, or athletics or any other physical, activities, including data and/or information regarding any and/or all schools, colleges, universities, trade schools, training institutes or academies, continuing education facilities, or learning centers, attended, as well any individuals, gyms, health clubs, country clubs, exercise facilities, fitness facilities, or fitness centers, or martial arts schools, or martial arts centers or academies, or any other institutions or facilities which the user individual has been a student or member.

In a preferred embodiment, the transcript can contain or include, for each school, college, university, trade school, training institute or academy, continuing education facility, or learning center, attended, as well any individual, gym, health club, country club, exercise facility, fitness facility, or fitness center, or martial arts school, or martial arts center or academy, or any other institution or facility, the user or individual has been a student, has been enrolled, or has been a member, information regarding dates or attendance or membership, courses taken, classes, lessons, or seminars taken or attended, grades earned, diplomas earned, degrees earning, continuing education credits earned, advancement or progression through a program, and/or any other information regarding the user's or individual's enrollment, attendance, and/or involvement, with the respective school, college, university, trade school, training institute or academy, continuing education facility, or learning center, attended, as well any individual, gym, health club, country club, exercise facility, fitness facility, or fitness center, or martial arts school, or martial arts center or academy, or any other institution or facility. In a preferred embodiment, any transcript can also include information regarding any standardized tests or examinations taken by the user or individual and any results or grades regarding same of same as well as any licensing tests or examinations taken by the user or individual and any results or grades regarding same of same, as well any licenses held by the user or individual and the status of same.

In a preferred embodiment, the transcript or transcripts contained in the instructional/educational record, in the preferred embodiment, can be a multimedia transcript which can contain text information, photographs, video clips, video recordings, video information, audio clips, audio recordings, and/or audio information, of, for, or regarding, the user or individual. In this regard, any transcript can contain and/or can include a photograph or photographs or a video clip or a video recording of the user or individual during his or her lifetime, throughout his or her educational career, during or throughout the user's or individual's involvement or participation in any activities, including, but not limited to, fitness, exercise, martial arts, sports, or athletics, or any other physical, activities, of any testing, accomplishments, performances, or any other events, activities, or happenings, during or throughout the user's or individual's instructional or educational career which are deemed to be important or noteworthy enough to be recorded and stored along with any instructional records or educational records of and for the user or individual.

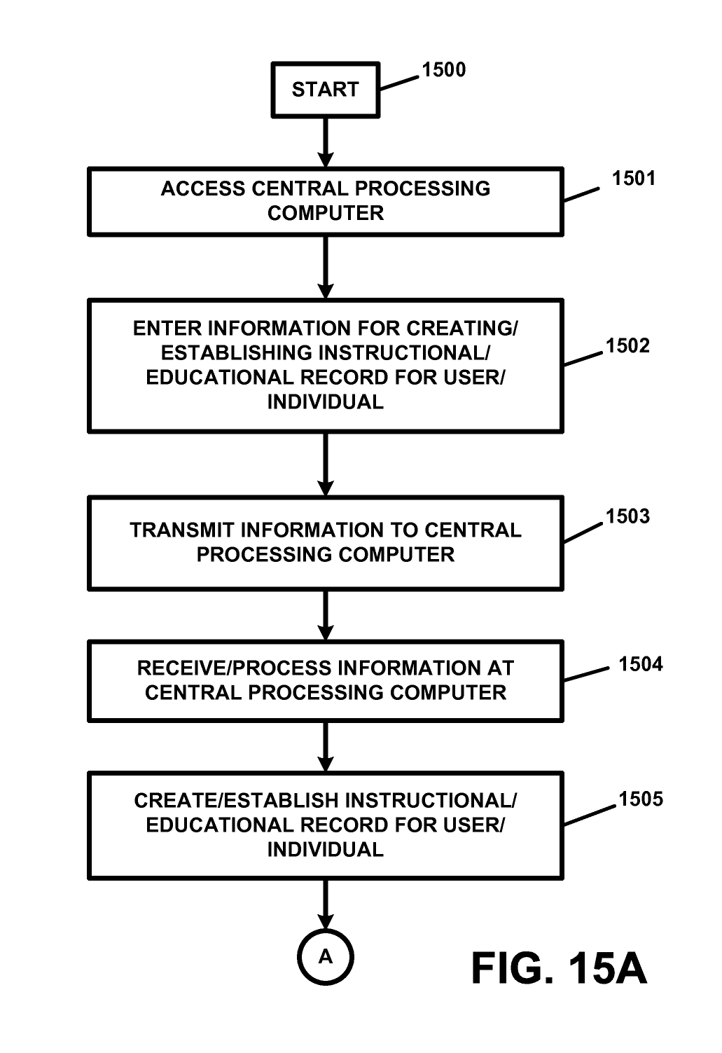

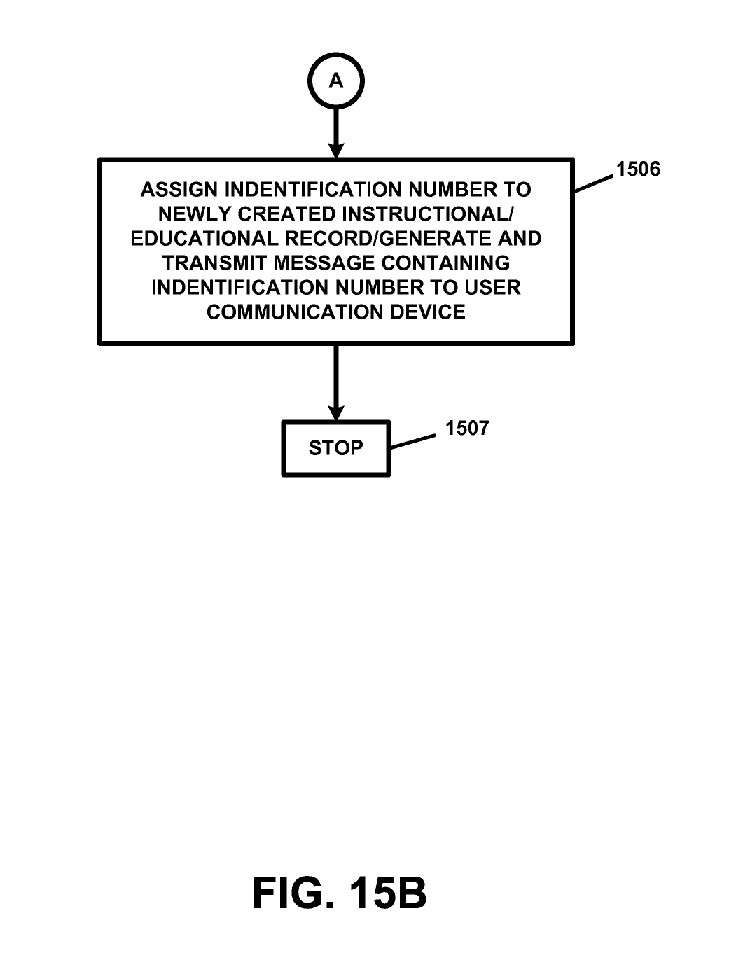

FIGS. 15A and 15B illustrate yet another preferred embodiment method for utilizing the apparatus 100 of the present invention, in flow diagram form. With reference to FIGS. 15A and 15B, the operation of the apparatus 100 can commence at step 1500. At step 1501, the user or individual, a parent of the user of individual, or any other authorized person, can access the central processing computer 10 using a user communication device 20. At step 1502, the user or individual, a parent of the user of individual, or any other authorized person, can request to create or establish an instructional/educational record for the user or individual.

At step 1502, the user or individual, a parent of the user of individual, or any other authorized person, can input or enter, into the user communication device, any data and/or information regarding the user or individual, including, but not limited to, name, address, and/or telephone number, and/or any other data and/or information which can also include a social security number or any number or identifier which can be used to identify the user or individual. If the user or individual is a student, is enrolled as a student, or is a member of any school, college, university, trade school, training institute or academy, continuing education facility, or learning center, or any individual, gym, health club, country club, exercise facility, fitness facility, or fitness center, or martial arts school, or martial arts center or academy, or any other institution or facility, then the name and/or any identifier for same, can also be input or entered into the user communication device 10.

At step 1503, any data and/or information input or entered into the user communication device 20 at step 1502 can be transmitted to the central processing computer 10. At step 1504, the central processing computer 10 can receive and process any data and/or information which was transmitted from the user communication device 20 at step 1503. At step 1505, the central processing computer 10 can create or establish an instructional/educational record for the user or individual. In a preferred embodiment, the instructional/educational record can be a comprehensive record which can be utilized to receive, store, and maintain, any instruction records and/or educational records for the user or individual. At step 1506, the central processing computer can assign an instructional/educational record identification number to the newly created or established instructional/educational record of and for the user or individual. At step 1506, the central processing computer 10 can transmit a message containing the instructional/educational record identification number to the user communication device 20 of, associated with, or being utilized by, the user or individual, a parent of the user of individual, or any other authorized person, who created or established the instructional/educational record.

Thereafter, any time the user or individual enrolls or registers as a student, or joins as a member, any school, college, university, trade school, training institute or academy, continuing education facility, or learning center, or any individual, gym, health club, country club, exercise facility, fitness facility, or fitness center, or martial arts school, or martial arts center or academy, or any other institution or facility, he or she, or a parent of he or she, or any authorized person, can provide the user's or individual's instructional/educational record identification number to that school, college, university, trade school, training institute or academy, continuing education facility, or learning center, or any individual, gym, health club, country club, exercise facility, fitness facility, or fitness center, or martial arts school, or martial arts center or academy, or any other institution or facility.

The user's or individual's instructional/educational record identification number can be stored in the instructional record or educational record which is maintained by that school, college, university, trade school, training institute or academy, continuing education facility, or learning center, or any individual, gym, health club, country club, exercise facility, fitness facility, or fitness center, or martial arts school, or martial arts center or academy, or any other institution or facility, in the database 10H of its respective instructional facility communication device 30.

In instances in when the user or individual is already a student of, enrolled as a student of, or a member of, a school, college, university, trade school, training institute or academy, continuing education facility, or learning center, or any individual, gym, health club, country club, exercise facility, fitness facility, or fitness center, or martial arts school, or martial arts center or academy, or any other institution or facility, the user's or individual's instructional/educational record identification number provided to that school, college, university, trade school, training institute or academy, continuing education facility, or learning center, or any individual, gym, health club, country club, exercise facility, fitness facility, or fitness center, or martial arts school, or martial arts center or academy, or any other institution or facility, so that the user's or individual's instructional record or education record maintained in the database 10H of its respective instructional facility communication device 30 for that school, college, university, trade school, training institute or academy, continuing education facility, or learning center, or any individual, gym, health club, country club, exercise facility, fitness facility, or fitness center, or martial arts school, or martial arts center or academy, or any other institution or facility, can be updated to include the user's or individual's instructional record or education record.

In a preferred embodiment, each and every instructional facility communication device 30 which is utilized in connection with the apparatus 100 of the present invention can be programmed to automatically transmit any changes or updates, in any instructional record or educational record which it maintains for any respective user or individual, to the central processing computer 10 so that the central processing computer 10 can update that portion of the respective user's or individual's instructional/educational record, which pertains to the user's or individuals activities at that particular school, college, university, trade school, training institute or academy, continuing education facility, or learning center, or any individual, gym, health club, country club, exercise facility, fitness facility, or fitness center, or martial arts school, or martial arts center or academy, or any other institution or facility, to accurately reflect the state and status of the user's or individual's instructional record or educational record maintained by that school, college, university, trade school, training institute or academy, continuing education facility, or learning center, or any individual, gym, health club, country club, exercise facility, fitness facility, or fitness center, or martial arts school, or martial arts center or academy, or any other institution or facility. In this manner, the user's or individual's instructional/educational record can accurately reflect the state and/or status of all of the user's or individual's instructional records or educational records which were or are currently being maintained by each and every school, college, university, trade school, training institute or academy, continuing education facility, or learning center, or any individual, gym, health club, country club, exercise facility, fitness facility, or fitness center, or martial arts school, or martial arts center or academy, or any other institution or facility, in or at which the user or individual has been a student, has been enrolled as a student, has been a member, is currently a student, is currently enrolled as a student, or is a member.

In a preferred embodiment, any updates to the user's or individual's instructional record or educational record at any school, college, university, trade school, training institute or academy, continuing education facility, or learning center, or any individual, gym, health club, country club, exercise facility, fitness facility, or fitness center, or martial arts school, or martial arts center or academy, or any other institution or facility, can include any type or kind of information regarding attendance, dates and/or times of attendance, or any classes, lessons, seminars, or courses, taken or attended, instructors had, and/or grades earned or received, as well as any multimedia data and/or information, including, but, not limited to, photographs, video clips, video recordings, audio clips, or audio recording, of the user or the individual or of any of the user's or individual's activities, projects, performances, testing, work, or accomplishments, at the that school, college, university, trade school, training institute or academy, continuing education facility, or learning center, or any individual, gym, health club, country club, exercise facility, fitness facility, or fitness center, or martial arts school, or martial arts center or academy, or any other institution or facility. In this regard, any transcripts and/or an instructional record or education record of or for the user or individual at or with that school, college, university, trade school, training institute or academy, continuing education facility, or learning center, or any individual, gym, health club, country club, exercise facility, fitness facility, or fitness center, or martial arts school, or martial arts center or academy, or any other institution or facility, can be a multimedia transcript or a multimedia instructional record or education record.

In this regard, the apparatus 100 of the present invention can be utilized to store and maintain a comprehensive instructional/educational record for or on behalf of a user or individual.

With reference once again to FIGS. 15A and 15B, after central processing computer 10 transmits the message containing the instructional/educational record identification number to the user communication device 20 of, associated with, or being utilized by, the user or individual, a parent of the user of individual, or any other authorized person, who created or established the instructional/educational record, the operation of the apparatus 100 will cease at step 1507.

In another preferred embodiment, the apparatus 100 and method of the present invention can be utilized to simply any application process to or with any school, college, university, trade school, training institute or academy, continuing education facility, or learning center, to which the user or individual is applying or has applied which requires that transcripts for the user or individual be submitted from each prior or current school, college, university, trade school, training institute or academy, continuing education facility, or learning center, which user or individual has attended or is currently attending. By utilizing the apparatus 100 of the present invention, the user or individual, or a person handling the application process for the user or individual, need only supply the school, college, university, trade school, training institute or academy, continuing education facility, or learning center, with the user's or individual's instructional/educational record identification number.

Thereafter, the school, college, university, trade school, training institute or academy, continuing education facility, or learning center, can access the central processing computer 10, access the user's or individual's instructional/educational record, or any portion of same to which its access may be limited, and obtain any needed instructional, educational, or academic, transcripts, of or regarding the user or individual, and/or obtain any other relevant or pertinent information regarding any information contained in the user's or individual's instructional/educational record or any information regarding any record of activities with or pertaining to any school, college, university, trade school, training institute or academy, continuing education facility, or learning center, or any individual, gym, health club, country club, exercise facility, fitness facility, or fitness center, or martial arts school, or martial arts center or academy, or any other institution or facility, in or at which the user or individual has been a student, has been enrolled as a student, has been a member, is currently a student, is currently enrolled as a student, or is currently a member, which information might be pertinent or relevant to the user's or individual's application.

In a preferred embodiment, the user or individual, a parent of the user or individual, or any authorized person, can, at any time, and for any reason, place limitations or restrictions on the ability of any person, individual, or entity, to access his or her instructional/educational record or any portions of same, so as to safeguard same.

In another preferred embodiment, the central processing computer 10 can generate an alert, an alert message, a notification, or a notification message, each time any person or entity, or any school, college, university, trade school, training institute or academy, continuing education facility, or learning center, or any individual, gym, health club, country club, exercise facility, fitness facility, or fitness center, or martial arts school, or martial arts center or academy, or any other institution or facility, attempts to access or accesses his or her instructional/educational record.

The central processing computer 10 can automatically generate an alert, an alert message, a notification, or a notification message, containing information regarding the name of the person or entity, or of the school, college, university, trade school, training institute or academy, continuing education facility, or learning center, or any individual, gym, health club, country club, exercise facility, fitness facility, or fitness center, or martial arts school, or martial arts center or academy, or any other institution or facility, which has attempted to access, or which has accessed, the user's or individual's instructional/educational record, the date ad/or time of same, and any information regarding any reason or purpose for same. Thereafter, the central processing computer 10 can transmit the alert, the alert message, the notification, or the notification message, to the user or individual, to the communication device 20, or to any other user communication device 20 of, associated with, or used by, the user or individual, the parent of the user or individual, or any authorized person, as or in an e-mail message, a text message, an SMS message, an MMS message, a pre-recorded telephone message, or as or in any electronic transmission. In this manner, the user or individual, any parent of the user or individual, or any authorized person, can be notified and kept informed regarding any access or attempted access to the user's or individual's instructional/educational record.

In another preferred embodiment, the apparatus 100 of the present invention can be utilized to provide an electronic healthcare record for a user or individual which can contain or include, or which can be linked to or with the user's or individual's instructional/educational record or the user's or the individual's comprehensive instructional/educational record. In this regard, any pertinent or relevant data and/or information contained or included in the user's or individual's instructional/educational record or the user's or the individual's comprehensive instructional/educational record can be accessed, obtained, and/or utilized, by an authorized healthcare provider in providing healthcare services for the user or individual, in making or arriving at a diagnosis for the user or individual, in prescribing treatments for the user or individual, in prescribing or monitoring rehabilitation or therapies for the user or individual, in prescribing a drug, a medication, a therapy, a test, or a procedure, in prescribing or monitoring treatments or treatment plans for the user or individual, in monitoring exercise or fitness programs for the user or individual, and/or in pre-authorizing or clearing the user or individual to engage in certain physical activities, exercise and/or fitness programs, or any other activities, and/or in performing or engaging in any other activity or activities pursuant to providing healthcare or healthcare-related services for the user or individual.

In the preferred embodiment, the user's or individual's electronic healthcare record, file, or history, with is stored in the database 40H of the healthcare records computer 40, can be linked to or with, or can contain, in a portion or same, a copy of the user's or individual's instructional/educational record, or any portion of same to which access is allowed to a healthcare provider, and which can be stored in the database 10H of the central processing computer 10 and/or in the database 50H of the instructional/educational records computer 50.

In a preferred embodiment, the user's or individual's instructional/educational record, or any portion of same, to which access rights or privileges have or may be granted to an authorized healthcare provider of the user or individual, can be accessed via the user's or individual's healthcare record. Thereafter, any information contained in the individual's instructional/educational record, or any portion of same, can be utilized by an authorized healthcare provided in providing a service or services to or for the user or individual.

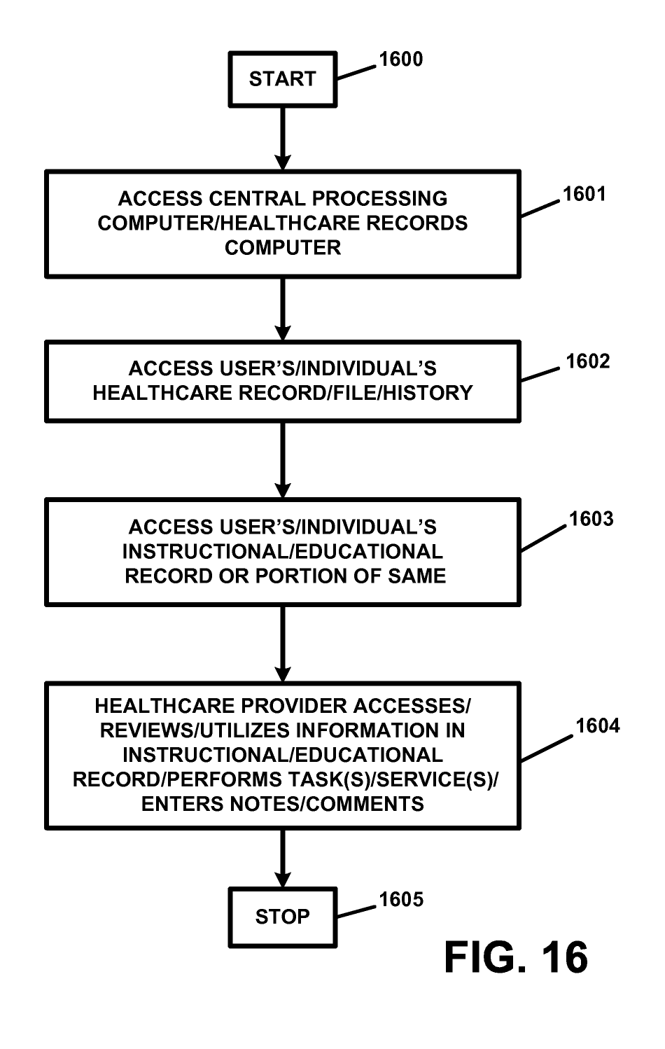

FIG. 16 illustrates still another preferred embodiment method for utilizing the apparatus of the present invention, in flow diagram form. With reference one again to FIG. 16, the operation of the apparatus 100 commences at step 1600. At step 1601, a healthcare provider of the user or individual can utilize his or her, or its, user communication device 20 to access the central processing computer 10 and, thereafter, the healthcare records computer 40. At step 1602, the healthcare provider can access the user's or individual's healthcare record, file, or history. At step 1603, the healthcare provider can access the user's or individual's instructional/educational record, or any portion of same to which access is allowed to a healthcare provider.

At step 1604, the healthcare provider can access and/or obtain and review any data and/or information contained in the user's or individual's instructional/educational record, or any portion of same to which access is allowed to a healthcare provider, which can, for example, include any data and/or information regarding any of the user's or individual's physical activities, exercise activities or routines, fitness activities or routines, workout activities or routines, martial arts training or routines, or any other information regarding any of the types or kinds of activities the user or individual engages in at any of the herein-described gyms, health clubs, country clubs, exercise facilities, fitness facilities, or fitness centers, or martial arts schools, or martial arts centers or academies, or any other institutions or facilities, in or at which the user or individual is a student, is enrolled as a student, or is a member.

At step 1604, the healthcare provider can utilize any of the information contained in the user's or individual's instructional/educational record, or any portion of same to which access is allowed to a healthcare provider, as well as any data and/or information regarding any of the user's or individual's physical activities, exercise activities or routines, fitness activities or routines, workout activities or routines, martial arts training or routines, or any other information regarding any of the types or kinds of activities the user or individual engages in at any of the herein-described gyms, health clubs, country clubs, exercise facilities, fitness facilities, or fitness centers, or martial arts schools, or martial arts centers or academies, or any other institutions or facilities, in order to perform any healthcare evaluation or healthcare service for or on behalf the user or individual.

As and for an example, the healthcare provider can, at step 1604, utilize any of the information contained in the user's or individual's instructional/educational record, or any portion of same to which access is allowed to a healthcare provider, as well as any data and/or information regarding any of the user's or individual's physical activities, exercise activities or routines, fitness activities or routines, workout activities or routines, martial arts training or routines, or any other information regarding any of the types or kinds of activities the user or individual engages in at any of the herein-described gyms, health clubs, country clubs, exercise facilities, fitness facilities, or fitness centers, or martial arts schools, or martial arts centers or academies, or any other institutions or facilities, in order to obtain any information regarding the user or individual which can or may be useful to the healthcare provide, which can or may be useful to better understand the user or individual or any needs of the user or individual, which can or may be needed or useful for the healthcare provider in making an evaluation of or for the user or individual, or which can or may be needed or useful in monitoring the user or individual, or which can or may be needed or useful for the healthcare provided in make or arrive at a diagnosis for the user or individual, to prescribe a treatment or a treatment plan for the user or individual, to prescribe a drug, a medication, a therapy, a test, or a procedure, to prescribe or monitor rehabilitation or therapies for the user or individual, to prescribe or monitor treatments or treatment plans for the user or individual, to monitor exercise or fitness programs for the user or individual, and/or to evaluate or pre-authorize or clear the user or individual to engage in certain physical activities, exercise and/or fitness programs, or any other activities, and/or to perform or engage in any other activity or activities. In a preferred embodiment, the healthcare provider can also access and view an exercise class, a fitness class, or a martial arts class, for or in which the user or individual seeks the healthcare provider's advice or permission to participate.

At step 1604, the healthcare provider can also utilize any data and/or information contained in the user's or individual's instructional/educational record, or any portion of same to which access is allowed to a healthcare provider, to also obtain a better understanding of the user or individual, a better understanding of the types or kind of activities in which the user or individual engages, of for any other purposes for studying or evaluating the user or individual for the purpose of providing healthcare services or healthcare-related services for the user or individual.

Once the healthcare provider has completed accessing and/or utilizing any data and/or information contained in the user's or individual's instructional/educational record, or any portion of same to which access is allowed to a healthcare provider, the healthcare provider can, at step 1604, also enter any notes or comments in the user's or individual's healthcare record, file, or history, and/or in the user's or individual's instructional/educational record, or any portion of same to which access is allowed to a healthcare provider. At step 1604, any notes or comments entered by the healthcare provider can be stored in each of the user's or individual's healthcare record, file, or history, and/or in the user's or individual's instructional/educational record. Thereafter, the operation of the apparatus 100 will cease at step 1605.

In another preferred embodiment, the apparatus 100 of the present invention can be utilized to allow a user or individual, who is enrolled in a course at a school, college, university, trade school, training institute or academy, continuing education facility, or learning center, to fulfill course attendance requirements or any other course requirements, by remotely viewing, attending, or participating in one or more classes, lectures, or seminars, offered or provided by another school, college, university, trade school, training institute or academy, continuing education facility, or learning center, or any number of other schools, colleges, universities, trade schools, training institutes or academies, continuing education facilities, or learning centers.

In a preferred embodiment, it is envisioned that a school, college, university, trade school, training institute or academy, continuing education facility, or learning center, can post information regarding a course on or via its instructional facility communication device 30, which can also be, or which can serve as, or be linked with its server computer, its host computer, or any computer associated with its website. In a preferred embodiment, the information regarding the course can include a course syllabus and/or agenda, and a list of classes, lectures, or seminars, which comprise the course syllabus, agenda, or teaching plan.

For each class, lecture, or seminar, which can be attended either in-person and/or in a classroom, or remotely via the Internet and/or the World Wide Web or any other communication network, or any combination of same, the school, college, university, trade school, training institute or academy, continuing education facility, or learning center, can provide the scheduled date(s) and/or time(s) of, the instructor of or for, the subject matter or material to be covered by or in, and/or any other information regarding the class, lecture, or seminar, and/or any information regarding any class or classes, lecture or lectures, or seminar or seminars, offered by any other school or schools, college or colleges, university or universities, trade school or trade schools, training institute or academy or training institutes or academies, continuing education facility or facilities, or learning center or learning centers, which is or are recognized by the school, college, university, trade school, training institute or academy, continuing education facility, or learning center, as being or having the subject matter or other equivalent of any class, lecture, or seminar, of or associated with its course in which the user or individual is, or will be, enrolled.

It is envisioned that, by allowing its students to view, attend, or participate in, classes, lectures, or seminars, offered by other schools, colleges, universities, trade schools, training institutes or academies, continuing education facilities, or learning centers, instead of, or in addition to the classes, lectures, or seminars, provided by it, the school, college, university, trade school, training institute or academy, continuing education facility, or learning center, can provide its students with a more diversified learning experience. In this manner, an user or individual can remotely view, attend, or participate in, classes, lectures, or seminars, from any other, or from any number of schools, colleges, universities, trade schools, training institutes or academies, continuing education facilities, or learning centers, instead of, or in addition to, attending any classes, lectures, or seminars, of a course offered or provided by his or her respective school, college, university, trade school, training institute or academy, continuing education facility, or learning center.

In a preferred embodiment, the central processing computer 10 and, in particular, the database 10H of same, can, for each course offered by any of the schools, colleges, universities, trade schools, training institutes or academies, continuing education facilities, or learning centers, which utilize the apparatus 100 of the present invention, store and/or contain or include data and/or information regarding a listing of all classes, lectures, or seminars, for that course, as well as a listing or listings of any and/or all classes, lectures, or seminars, offered by other schools, colleges, universities, trade schools, training institutes or academies, continuing education facilities, or learning centers, which offer or provide the same or equivalent subject matter, or which cover the same or equivalent materials, as any class or classes, any lecture or lectures, or any seminar or seminars, of the courses offered by the schools, colleges, universities, trade schools, training institutes or academies, continuing education facilities, or learning centers.

In a preferred embodiment, the instructional facility communication device 30 and, in particular, the database 30H of same, for each course offered by the school, college, university, trade school, training institute or academy, continuing education facility, or learning center, which utilizes the apparatus 100 of the present invention, can store and/or contain or include data and/or information regarding a listing of all classes, lectures, or seminars, for that course, as well as a listing or listings of any and/or all classes, lectures, or seminars, offered by other schools, colleges, universities, trade schools, training institutes or academies, continuing education facilities, or learning centers, which offer or provide the same or equivalent subject matter, or which cover the same or equivalent materials, as any class or classes, any lecture or lectures, or any seminar or seminars, of the courses offered by the school, college, university, trade school, training institute or academy, continuing education facility, or learning center.

In a preferred embodiment, the schools, colleges, universities, trade schools, training institutes or academies, continuing education facilities, or learning centers, can approve or and/or agree beforehand regarding any similarity or equivalence of the subject matter or materials presented or covered by any of the respective classes, lectures, or seminars.

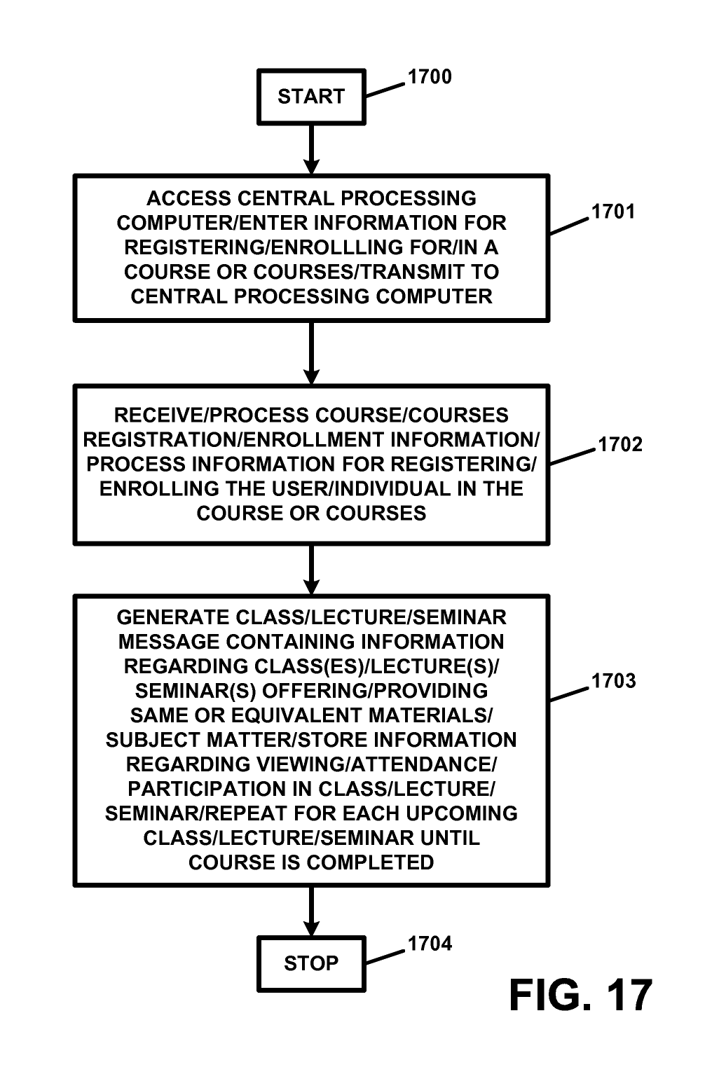

FIG. 17 illustrates yet another preferred embodiment method for utilizing the apparatus 100 of the present invention, in flow diagram form. With reference to FIG. 17, the operation of the apparatus 100 commences at step 1700. At step 1701, a user or individual, who is enrolled in, or who is about to enroll in, a course with a school, college, university, trade school, training institute or academy, continuing education facility, or learning center (hereinafter referred to as “school”), can access the central processing computer 10 via his or her or any user communication device 20 and can register for a course or any number of courses by entering information regarding himself or herself and the course or courses in or for which he or she is registering, into the user communication device 20, and by transmitting the information to the central processing computer 10.

At step 1702, the central processing computer 20 can receive and process the information received from the user communication device 20 and can process any information for registering the user or individual in the course or courses. Thereafter, the operation of the apparatus 10 will proceed to step 1703. At step 1703, during and for the duration of the course, during and for the duration of the semester, or during and for the duration of the course term, and until the course, the semester, or the course term, comes to an end, the central processing computer 10 will, for each course in which the user or individual is registered, process information stored in its database 10H for or regarding the subject matter or materials covered in each upcoming scheduled class, lecture, or seminar, and, prior to the occurrence of the upcoming class, lecture, or seminar, generate a class, lecture, or seminar, message.

In a preferred embodiment, the class, lecture, or seminar, message, can contain information regarding the upcoming class, lecture, or seminar, the scheduled date, day, and time, of same, or the availability of a recording of same, a link or a hyperlink to or for same, the instructor of or for same, the materials or subject matter to be covered by same, and/or any other information regarding same. In the preferred embodiment, the class, lecture, or seminar, message, will also contain information regarding any class or classes, lecture or lectures, or seminar or seminars, offered by any other schools, colleges, universities, trade schools, training institutes or academies, continuing education facilities, or learning centers, which are recognized by the user's or individual's school as offering or providing the same or equivalent subject matter or materials, or covering the same or equivalent subject matter as the upcoming class, lecture, or seminar, of the course in which the user or individual is registered.

For each class, lecture, or seminar, identified as being offered by another school, college, university, trade school, training institute or academy, continuing education facility, or learning center, the class, lecture, or seminar, message, will contain information regarding that upcoming class, lecture, or seminar, the scheduled date, day, and time, of same, or the availability of a recording of same, a link or a hyperlink to same, the instructor of or for same, the materials or subject matter to be covered by same, and/or any other information regarding same.

At step 1703, the central processing computer 10 can transmit the class, lecture, or seminar, message to any user communication device 20 of, associated, with, or used by, the user or individual. In a preferred embodiment, the class, lecture, or seminar, message can be transmitted to the user communication device as or in an e-mail message, a text message, an SMS message, an MMS message, a pre-recorded telephone message, or as or in any electronic transmission. At step 1703, the user or individual can thereafter attend the upcoming class, lecture, or seminar, offered or provided by his or her school in-person, in the classroom, and/or can remotely view, attend, or participate in, the class, the lecture, or the seminar, offered or provided by his or her school via the Internet and/or the World Wide Web, and/or any other communication network, or any combination of same, and/or the user or individual can remotely view, attend, or participate in, any class, lecture, or seminar, or any number or classes, lectures, or seminars, which are offered or provided by any other school or schools, college or colleges, university or universities, trade school or trade schools, training institute or academy or training institutes or academies, continuing education facility or continuing education facilities, or learning center or learning centers, which offer, provide, or cover, the same or the equivalent subject matter or materials. In this regard, the user or individual can attend the upcoming class, lecture, or seminar offered or provided by his or her school, remotely view, attend or participate in, same, or remotely view, attend, or participate in, any one or more classes, lectures, or seminars, offered or provided by any other schools, colleges, universities, trade schools, training institutes or academies, continuing education facilities, or learning centers.

The user or individual can also attend the upcoming class, lecture, or seminar offered or provided by his or her school, and/or remotely view, attend or participate in, same, and/or remotely view, attend, or participate in, any one or more classes, lectures, or seminars, offered or provided by any other schools, colleges, universities, trade schools, training institutes or academies, continuing education facilities, or learning centers. In this regard, the user or individual can remotely view, attend, or participate in, any one or more classes, lectures, or seminars, offered or provided by any other schools, colleges, universities, trade schools, training institutes or academies, continuing education facilities, or learning centers, instead of attending or remotely viewing, attending, or participating in, the upcoming class, lecture, or seminar, offered or provided by his or her school, or in addition to attending or remotely viewing, attending, or participating in, the upcoming class, lecture, or seminar, offered or provided by his or her school, so as to complement or supplement his or her learning experience.

In a preferred embodiment, the central processing computer 10, at step 1703, can also record and store, in the user's or individual's instructional/educational record, any information regarding any class or classes, lecture or lectures, or seminar or seminars, attended or remotely viewed, attended, or participated in, by the user or individual along with the respective school, college, university, trade school, training institute or academy, continuing education facility, or learning center, which offered or provided each such class, lecture, or seminar.

Thereafter, the above process, described as being performed by the central processing computer 10 at step 1703 can be repeated for each upcoming class, lecture, or seminar, offered or provided by the user′ or the individual's school for the course until the course term or the semester or term ends. The above process, described as being performed by the central processing computer 10 at step 1703 can also be performed and/or repeated for each course in which the user or individual is enrolled or registered.

Once all courses in the which the user or individual is enrolled or registered end, then the operation of the apparatus 100 will cease at step 1704.

In another preferred embodiment, the functionally described herein as being performed by the central processing computer 10 in the preferred embodiment of FIG. 17 can also be performed by the instructional facility communication device 30 of or associated with the at school, college, university, trade school, training institute or academy, continuing education facility, or learning center, in which or with which the user or individual is enrolled or registered as a student.

In the manner provided herein, the apparatus 100 of the present invention can provide for diversity in instruction by allowing the user or individual to remotely view, attend, or participate in, classes, lectures, or seminars, offered or provided by another school, college, university, trade school, training institute or academy, continuing education facility, or learning center, or by other schools, colleges, universities, trade schools, training institutes or academies, continuing education facilities, or learning centers.

In another preferred embodiment, the apparatus 100 of the present invention can also be utilized to allow a user or individual, who is enrolled in a school, college, university, trade school, training institute or academy, continuing education facility, or learning center, to fulfill requirements for a diploma, a degree, or a certificate, or to complete any other formal program, by enroll in, or to register for, a course or courses which are offered by one or more other schools, colleges, universities, trade schools, training institutes or academies, continuing education facilities, or learning centers. The user or individual can then engage in studies in and for that course or courses remotely, in a distance learning environment, with that other school, college, university, trade school, training institute or academy, continuing education facility, or learning center, and receive credit, or transfer credits, for such studies from his or her school, college, university, trade school, training institute or academy, continuing education facility, or learning center (hereinafter “school”).

In a preferred embodiment, it is envisioned that a school, college, university, trade school, training institute or academy, continuing education facility, or learning center, can post, on its instructional facility communication device 30, which can also be, or which can serve as, or be linked with its server computer, its host computer, or any computer associated with its website, information regarding its various diploma programs, degree programs, certificate programs, or any other formal education programs, as well as any courses which are required for satisfying same. It is also envisioned that the a school, college, university, trade school, training institute or academy, continuing education facility, or learning center, can also post, a course or courses which are offered by other schools, colleges, universities, trade schools, training institutes or academies, continuing education facilities, or learning centers, which the user's or individual's school will accept for credit for or towards, or as transfer credit for or towards a diploma, a degree, or a certificate, or any other formal program. In a preferred embodiment, the user's or individual's school can agree beforehand to accept a course or any number of courses, for credit, or for transfer credit, towards a diploma, a degree, or a certificate, or any other formal program, with the user's or individual's school, regardless of whether or not the course or courses offered or provided by the other schools, colleges, universities, trade schools, training institutes or academies, continuing education facilities, or learning centers, are the same as, or similar to or in, and/or cover, the subject matter or materials covered by any course or courses offered or provided by the user's or individual's school.

In a preferred embodiment, any data and/or information regarding and course or courses for which the user's or individual's school will accept credit or transfer credit can be stored in the database 10H of the central processing computer 10 and/or in the database 30H of the instructional facility communication device 30 of or associated with the user's or individual's school.

For each course for which the user's or individual's school will accept credit or transfer credit, the data and/or information stored in the database 10H of the central processing computer 10 and/or in the database 30H of the instructional facility computer 30, can include information regarding a name and description of the course, the school, college, university, trade school, training institute or academy, continuing education facility, or learning center, offering or providing same, the number of credits which the user′ or individual's school will accept or accept as transfer credits, the data and/or times or other scheduling information, information regarding the instructor or instructor or of for same, whether the course can be attended in-person or in a classroom and/or whether the course can be remotely viewed, attended or participated in, the diploma, degree, certificate, or continuing education, program in which the course can be applied ad/or used to satisfy, and/or any other information regarding the course.

When the user or individual is in the process of registering for a course or courses at or with his or her school, he or she can be obtain, access, or be provided with the courses which are offered or provided by other schools, colleges, universities, trade schools, training institutes or academies, continuing education facilities, or learning centers, and for which credit or transfer credit is available, and can register or enroll in any one or more of these courses.

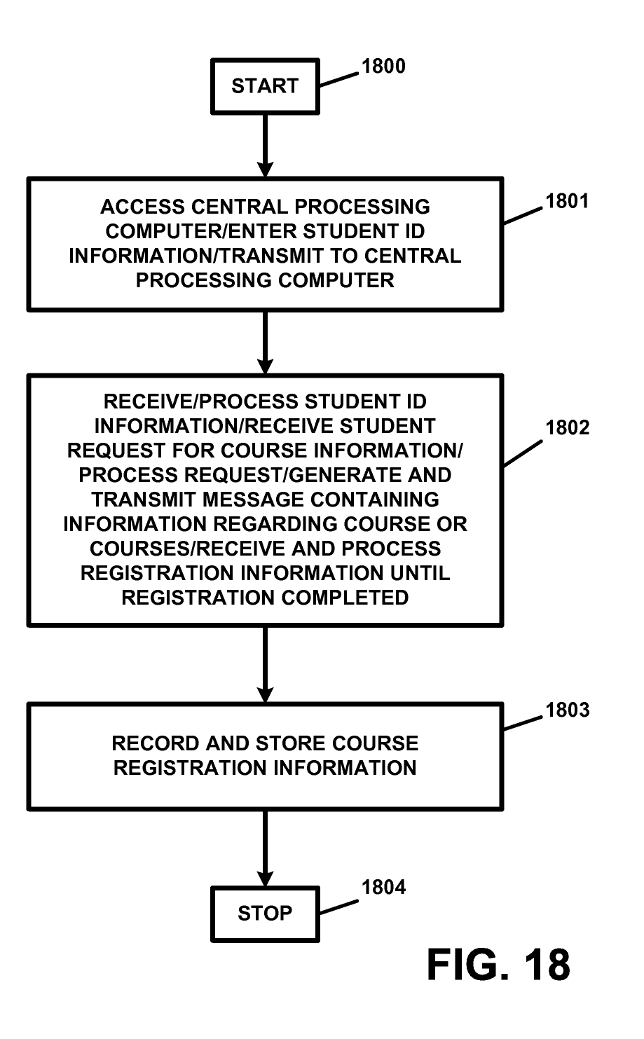

FIG. 18 illustrates yet another preferred embodiment method for utilizing the apparatus 100 of the present invention, in flow diagram form. With reference to FIG. 18, the operation of the apparatus 100 commences at step 1800. At step 1801, a user or individual who is either enrolled in, or who is about to enroll in, a school, college, university, trade school, training institute or academy, continuing education facility, or learning center (hereinafter referred to as “school”), who desires to enroll in, or to register for, a course or for any number of courses, can access the central processing computer 10 via his or her or any other user communication device 20. At step 1801, the user or individual can enter any necessary student identification information and transmit same to the central processing computer 10.

At step 1802, the central processing computer 20 can receive and process any student identification information of or for the user or individual. At step 1802, the user or individual can enter, into the user communication device 20, any information regarding a request for information regarding a course or courses in or for which he or she desires to enroll or register, and can transmit same to the central processing computer 10. At step 1802, the central processing computer 10 can receive and process the request for information and transmit a message to the user communication device 10 of, associated with, or used by, the user or individual. In a preferred embodiment, the message can contain information regarding any course or courses offered or provided by the user's or individual's school, as well as any course or courses offered or provided by any other school, college, university, trade school, training institute or academy, continuing education facility, or learning center, or offered or provided by any other schools, colleges, universities, trade schools, training institutes or academies, continuing education facilities, or learning centers, for which the user's or individual's school has agreed to accept credit or transfer credits.

At step 1802, the user or individual can enroll in, or register for, any course or any number of courses identified in the message and the central processing computer 10 can process any information for enrolling or registering the user or individual in the selected course or courses. Thereafter, step 1802 can be repeated by the user or individual until the user or individual has enrolled in, or has registered for, all of his or her needed or desired courses.

Thereafter, the central processing computer 10 can, at step 1803, record and store, in the user's or individual's instructional/education record, which is stored in the database 10H of the central processing computer 10, any information regarding the course or courses in which the user or individual has enrolled or for which the user or individual has registered, and/or the central processing computer 10 can transmit the information, regarding the course or courses in which the user or individual has enrolled or for which the user or individual has registered, to the instructional facility communication device 30 of or associated with the user's or individual's school for storage in the database 30H of same.

In a preferred embodiment, any course in which the user or individual has enrolled or for which the user or individual has registered, can be a course which can be attended in-person or in classroom, and/or the course can be remotely viewed, attended, or participated in, by the user or individual via, on, or over, the Internet and/or the World Wide Web and/or any other communication network, or any combination of same.

Once step 1803 has been completed, the operation of the apparatus 100 will cease at step 1804.

In the above-described manner, the apparatus 100 of the present invention can be utilized by user or individual who is enrolled in one school, college, university, trade school, training institute or academy, continuing education facility, or learning center, to enroll in, or to register for, a course or any number of courses, which can be offered or provided by any other school, college, university, trade school, training institute or academy, continuing education facility, or learning center, or any other schools, colleges, universities, trade schools, training institutes or academies, continuing education facilities, or learning centers, and for which the user's or individual's school has agreed to accept credit or transfer credits which can be applied towards any diploma, degree, certificate, or continuing education, program.

In another preferred embodiment, the functionally described herein as being performed by the central processing computer 10 in the preferred embodiment of FIG. 18 can also be performed by the instructional facility communication device 30 of or associated with the at school, college, university, trade school, training institute or academy, continuing education facility, or learning center, in which or with which the user or individual is enrolled or registered as a student.

In the manner provided herein, the apparatus 100 of the present invention can provide for diversity in instruction by allowing the user or individual to remotely view, attend, or participate in, a course or any number of courses offered or provided by another school, college, university, trade school, training institute or academy, continuing education facility, or learning center, or by other schools, colleges, universities, trade schools, training institutes or academies, continuing education facilities, or learning centers, when working towards earning or receiving a diploma, a degree, or a certificate, or when or during performing continuing education studies.

In any and/or all of the embodiments described herein, if any single class, lesson, or seminar, is selected by the user or individual, that class, lesson, or seminar, can or will be transmitted to the user's or individual's user communication device 20. If more than one class, lesson, or seminar, is selected by the user or individual, then each class, lesson, or seminar, can or will be transmitted to the user's or individual's user communication device 20, one at a time, or simultaneously, so as to be viewed in split screen format, or a multiple screen format, via the display device 20E of the user's or individual's user communication device 20.

In any and/or all of the embodiments described herein, any user or individual can access the healthcare records computer 40, in order to access, obtain information from, and/or to make any changes to, or to update, his or her healthcare record, file, or history, or to provide authorization to allow a third party, such as any healthcare provider, fitness instructor, personal trainer, or other individual or entity to access, obtain information from, or to update, same.

In any and/or all of the embodiments described herein, any user or individual can access the instructional/educational records computer 50, in order to access, obtain information from, and/or to make any changes to, or to update, his or her instructional record or educational record, or to provide authorization to allow a third party, such as any healthcare provider, fitness instructor, personal trainer, or other individual or entity to access, obtain information from, or to update, same.

In any and/or all of the embodiments described herein, any user or individual can access the media computer(s) 60, in order to obtain information from same regarding any topic of interest to the user or individual, including, but not limited to healthcare news or newsletters, fitness news or newsletters, exercise news or newsletters, wellness news or newsletters, nutritional news or newsletters, and/or any news, newsletters, or information which may be of interest to the user or individual. In a preferred embodiment, the apparatus 100 of the present invention can also be utilized to automatically disseminate any news, newsletters, or any other information, to any users, individuals, instructional facilities, educational facility, healthcare professionals, fitness professionals and/or hobbyists, exercise professionals and/or hobbyists, martial arts professionals and/or hobbyists, instructors or teachers of any kind or type, or any other individual, person, business, or entity, who or which utilizes the apparatus 100 and method of the present invention.

In any and/or all of the embodiments described herein, any user or individual can access any social networking computer(s) 70 in order to join social networks, to join support groups, to join on-line clubs or groups, to join workout groups, to find workout partners, or for any other reason or reasons.

As noted herein, in any and/or all of the preferred embodiments described herein, any of the processing routines, functions, and/or functionality, described herein as being performed by or with the central processing computer 10 can also be performed by or with the instructional facility communication device 30. In this regard, the instructional facility communication device 30 can be programmed to perform all of processing routines, functions, and/or functionality, which is described herein as being performed by or with the central processing computer 10 in any and/or all of the embodiments described herein.

As also noted herein, in any and/or all of the preferred embodiments described herein, any of the processing routines, functions, and/or functionality, described herein as being performed by or with the instructional facility communication device 30 can also be performed by or with central processing computer 10. In this regard, the central processing computer 10 can be programmed to perform all of processing routines, functions, and/or functionality, which is described herein as being performed by or with the instructional facility communication device 30 in any and/or all of the embodiments described herein.

In any and/or all of the embodiments described herein, any signals, messages, reports, alerts, alert messages, notifications, notifications messages, or any other communications or communication transmissions, described herein as being transmitted from one device, computer, or communication device, to another, can be, or can be included in, or can be attached to, an e-mail message, an instant messaging message, as SMS messaging message, or an MMS messaging message, or as, included in, or attached to, an electronic transmission, electronic data interchange, or electronic data transmission, or any other data or information transmission. In any and/or all of the embodiments described herein, any signals, messages, reports, alerts, alert messages, notifications, notifications messages, or any other communications or communication transmissions, described herein as being transmitted from one device, computer, or communication device, to another, can be, or can be included in, a telephone call, a pre-recorded telephone message, or a facsimile transmission.

While the present invention has been described and illustrated in various preferred and alternate embodiments, such descriptions are merely illustrative of the present invention and are not to be construed to be limitations thereof. In this regard, the present invention encompasses all modifications, variations, and/or alternate, embodiments, with the scope of the present invention being limited only by the claims which follow.

What is claimed is:

1. A computer-implemented method, comprising:
processing, with or using a processor or with or using a computer, information for establishing or providing a video conference between a user and a fellow student or a work-out partner;
processing, with or using the processor or with or using the computer, information for providing a video transmission of a class, a lesson, or a seminar, to a first communication device associated with or used by the user and to a second communication device, wherein the second communication device is associated with or used by the fellow student or the work-out partner;
transmitting, with or from a transmitter or with or from the computer, the class, the lesson, or the seminar, to the first communication device and to the second communication device, wherein the class, the lesson, or the seminar, is transmitted to the first communication device and to the second communication device during the video conference; and
storing, in a memory device or in a database, information regarding the user's viewing, attending, or participation in, the class, the lesson, or the seminar, in an instructional record of or associated with the user or in an educational record of or associated with the user.

2. The computer-implemented method of claim 1, further comprising:
storing, in the memory device or in the database, information regarding the fellow student's or the work-out partner's viewing, attending, or participation in, the class, the lesson, or the seminar, in an instructional record of or associated with the fellow student or the work-out partner or in an educational record of or associated with the fellow student or the work-out partner.

3. The computer-implemented method of claim 1, further comprising:
processing information for allowing an instructor to participate in the video conference.

4. The computer-implemented method of claim 1, further comprising:
receiving, with a receiver or with the computer and during the transmission of the class, the lesson, or the seminar or during the video conference, a video clip or a video recording containing a video recording of the user.

5. The computer-implemented method of claim 4, further comprising:
transmitting the video clip or the video recording to a third communication device, wherein the third communication device is associated with or used by an instructor associated with the class, the lesson, or the seminar.

6. The computer-implemented method of claim 1, wherein the user is a student, or a member, of a first school, a first club, or a first training facility, and further wherein the class, the lesson, or the seminar, is offered by or provided by the first school, the first club, or the first training facility, or is offered by or provided by a second school, a second club, or a second training facility.

7. The computer-implemented method of claim 6, wherein the class, the lesson, or the seminar, is offered by or provided by the first school, the first club, or the first training facility.

8. The computer-implemented method of claim 6, wherein the class, the lesson, or the seminar, is offered by or provided by the second school, the second club, or the second training facility.

9. The computer-implemented method claim 1, further comprising:
processing, with or using the processor or with or using the computer, information for including an instructor in the video conference.

10. The computer-implemented method of claim 1, further comprising;
receiving, with a receiver or with the computer, a video recording containing information regarding the user, wherein the video recording is transmitted to the receiver or the computer after the class, the lesson, or the seminar, has ended or after the video conference has ended.

11. The computer-implemented method of claim 10, further comprising:
generating a message in response to a receiving of the video clip, wherein the message contains an instructor's notes or comments regarding the user or the video recording; and
storing information regarding the message or contained in the message in an instructional record or an educational record of the user, wherein the message contains an instructor's notes or comments regarding the user or the video recording.

12. The computer-implemented method claim 10, further comprising:
generating a message in response to a receiving of the video clip, wherein the message contains an instructor's notes or comments regarding the user or the video recording; and
transmitting the message to the first communication device or to a third communication device, wherein the third communication device is associated with or used by the user.

13. The computer-implemented method of claim 1, further comprising:
receiving, with a receiver, the processor, or the computer, a request to be notified regarding an occurrence or a happening of the class, the lesson, or the seminar, or a request to be notified regarding an occurrence or a happening of a second class, a second lesson, or second seminar.

14. The computer-implemented method of claim 1, further comprising:
generating a message containing information regarding the class, the lesson, or the seminar; and
transmitting the message to the first communication device or to a third communication device, wherein the third communication device is associated with or used by the user, wherein the message is transmitted prior to a scheduled start or broadcast, of the class, the lesson, or the seminar.

15. The computer-implemented method of claim 1, further comprising:
receiving, with a receiver, the processor, or the computer, a search request, wherein the search request contains information regarding a search for information regarding one or more classes, lessons, or seminars.

16. A computer-implemented method, comprising:
storing, in database or in a memory device, information regarding an upcoming class offered or provided by a first school for a course offered or provided by the first school;
storing, in the database or in the memory device, information regarding an upcoming class offered or provided by a second school;
processing, with or using a processor or with or using a computer, information regarding the upcoming class offered or provided by the first school;
generating, with the processor or with the computer, an upcoming class notification message containing information regarding the upcoming class offered or provided by the first school and information regarding the upcoming class offered or provided by the second school; and
transmitting, from a transmitter or from the computer, the notification message to a communication device associated with or used by a user.

17. The computer-implemented method of claim 16, wherein the notification message contains a link or a hyperlink to the upcoming class offered or provided by the first school and contains a link or a hyperlink to the upcoming class offered or provided by the second school.

18. A computer-implemented method comprising:
storing, in database or in a memory device, information regarding a first course offered or provided by a first school;
storing, in the database or in the memory device, information regarding a second course offered or provided by a second school for which the first school agrees to accept credit or transfer credit for or towards a diploma program, a degree program, a certificate program, or a continuing education program, offered by the first school;
receiving, with a receiver, a request from a user for information regarding a course for which the user can enroll in, or register for, as a student of the first school;
processing, with a processor or with a computer, information contained in the request;
generating, with a processor or with a computer, a message in response to the request, wherein the message contains information regarding the first course and information regarding the second course, wherein the user can register for the second course and receive credit of transfer credit for or towards the diploma program, the degree program, the certificate program, or the continuing education program, offered by the first school; and
transmitting, from a transmitter or from the computer, the message to a communication device associated with or used by the user.
